(19) United States
(12) Patent Application Publication
(10) Pub. No.: US 2016/0055704 A1
(43) Pub. Date: Feb. 25, 2016

(54) GAMING MACHINE

(71) Applicants: UNIVERSAL ENTERTAINMENT CORPORATION, TOKYO (JP); ARUZE GAMING AMERICA, INC., Las Vegas, NV (US)

(72) Inventors: Kenta KITAMURA, Tokyo (JP); Hiroki SAITO, Tokyo (JP); Kazunori OTSUKA, Tokyo (JP)

(21) Appl. No.: 14/829,874

(22) Filed: Aug. 19, 2015

(30) Foreign Application Priority Data
Aug. 22, 2014 (JP) 2014169289

(51) Int. Cl. G07F 17/32; G07F 17/34

(52) U.S. Cl. CPC G07F 17/3213; G07F 17/34

(57) ABSTRACT

The gaming machine includes a display device for displaying a game result by rearranging a plurality of symbols and a memory holding a color determination table for determining colors for symbol areas and a winning pattern identification table for identifying a winning pattern based on the colors of the symbol areas, and performs the processing of (1-1) determining colors for symbol areas of a specific kind of symbols in the plurality of symbols by lottery processing with reference to the color determination table held in the memory; (1-2) setting the colors determined in the processing of (1-1) for the symbol areas of the specific kind of symbols; and (1-3) identifying a winning pattern with reference to the winning pattern identification table based on the specific kind of symbols in the colors set in the processing of (1-2).

### CROSS-REFERENCE TO RELATED APPLICATIONS

This application claims the benefit of Japanese Patent Application No. 2014-169289 filed on Aug. 22, 2014, which application is incorporated herein by reference in its entirety.

### FIELD OF THE INVENTION

The present invention relates to a gaming machine that rearranges symbols.

### BACKGROUND ART

Traditional slot machines have been known that mechanically drive substantial reels with motors to rearrange symbols (for example, refer to US Patent Application Publication No. 2013/0228774).

In such a slot machine, a plurality of symbols are physically disposed on the reels. Since the reels are real, it is extremely difficult to change the designs or sizes of the symbols with progress of the games. Accordingly, the kinds and the numbers of symbols allowed to be disposed on the reels are unchangeable.

### BRIEF SUMMARY OF THE INVENTION

As mentioned above, the kinds and the numbers of symbols allowed to be disposed on the substantial reels are fixed. For this reason, winning patterns and kinds of payout are so limited, as well as the kinds of symbols disposed on the reels.

The present invention has been accomplished in view of the foregoing problems and an object of the present invention is to provide a gaming machine that can substantially increase the kinds of symbols so that the kinds of winning patterns and the kinds of payout can be increased even though the gaming machine is equipped with real reels.

A gaming machine according to an embodiment is a gaming machine controlled to determine a color for a symbol or a color for a background of the symbol at random from two or more colors and to determine an amount of payout differently depending on the determined color. The gaming machine comprises:

a symbol display device for rearranging a plurality of symbols;

a memory holding a plurality of color determination tables among which probabilities of determining the two or more colors for the symbol or the background of the symbol are different;

and

a controller for determining a color for the symbol or a color for the background of the symbol at random using one of the plurality of color determination tables held in the memory.

That is to say, the gaming machine according to the embodiment has a plurality of color determination tables. Among the plurality of color determination tables, probabilities of determining the color for a symbol or the color for the background of the symbol are different. Furthermore, the amount of payout depends on the determined color. Specifying the probabilities of determining the color as appropriate enables specifying the amounts of payout; the benefit for the player can be conditioned by both of determining the colors and determining the symbols.

In the gaming machine according to the embodiment, the plurality of color determination tables held in the memory can include a color determination table in which the probabilities of determining the two or more colors are specified to select a specific color and a color determination table in which the probabilities of determining the two or more colors are specified to select any of the two or more colors.

The plurality of color determination tables are three kinds of color determination tables. The first kind of color determination table is for selecting a specific color. If the first kind of color determination table is selected, the specific color is selected. The second kind of color determination tables are for selecting one of the two or more colors excluding the specific color. If a second kind of color determination table is selected, a color excluding the specific color is selected. The third kind of color determination tables are for selecting any of the two or more colors. If a third kind of color determination table is selected, any color could be selected.

Providing these three kinds of color determination tables enables conditioning the likelihood of determination depending on the color, which enables conditioning the amount of payout depending on the color.

In the gaming machine according to the embodiment,

the memory can further hold a table for determining a color determination table, which is for determining one of the plurality of color determination tables at random;

the table for determining a color determination table can specify a probability of drawing the color determination table specified to select any of the two or more colors as higher than a probability of drawing the color determination table specified to select the specific color; and

the controller can determine a color determination table to be used at random based on the table for determining a color determination table.

The probability of drawing the color determination table specified to select any of the two or more colors is specified as higher than the probability of drawing the color determination table specified to select the specific color. Accordingly, the color determination table specified to select any of the two or more colors is more likely to be selected, which generates possibilities that not only the specific color but also any other color may be selected. Accordingly, the amount of payout associated with the specific color can be balanced with the amounts of payout associated with the other colors.

In the gaming machine according to the embodiment,

the plurality of color determination tables can include the color determination table specified to select the specific color, at least one color determination table specified to select a color different from the specific color, and color determination tables specified to select any of the two or more colors;

among the color determination tables specified to select the specific color, the at least one color determination table specified to select a color different from the specific color, and the color determination tables specified to select any of the two or more colors, the color determination tables specified to select any of the two or more colors can be more than the color determination tables specified to select a specific color; and

among the color determination tables specified to select any of the two or more colors, probabilities of selecting different colors can be specified to be different.

Among the color determination tables specified to select any of the two or more colors, probabilities of selecting different colors are specified to be different, which generates possibilities of selecting different colors. The amounts of payout associated with different colors can be balanced.

A gaming machine according to another embodiment comprises:

a symbol display device for displaying a game result by rearranging a plurality of symbols;

a memory holding a color determination table for determining colors for symbols or colors for backgrounds of the symbols and a winning pattern identification table for identifying a winning pattern based on the colors of the symbols or the colors of the background of the symbols; and

a controller programmed to perform the following processing of (5-1) to (5-3):

(5-1) determining colors for a specific kind of symbols of the plurality of symbols or colors for backgrounds of the specific kind of symbols by lottery processing with reference to the color determination table held in the memory;

(5-2) individually setting the colors determined in the processing of (5-1) to the specific kind of symbols or the backgrounds of the specific kind of symbols; and

(5-3) identifying a winning pattern with reference to the winning pattern identification table based on the specific kind of symbols to which or to the background of which the colors are set individually in the processing of (5-2).

Identifying a winning pattern is not performed merely after symbol lottery processing but is performed after determining the colors of the symbols or the background of the symbols. Accordingly, even if symbols having the same appearance are rearranged, assigning different colors to the symbols or the backgrounds of the symbols leads the symbols to be treated as different kinds of symbols, achieving more diverse winning patterns.

In the gaming machine according to the embodiment,

the controller can be programmed to perform the processing of (5-1) before performing the lottery processing to rearrange the plurality of symbols.

Since the colors for a specific kind of symbols or backgrounds of the specific kind of symbols are determined before the lottery processing to rearrange the plurality of symbols, presentation effects based on the determined colors can be performed, so that the player can feel expectation for some winning patterns.

A gaming machine according to a still another embodiment comprises:

a symbol display device including a display area in which a game result is displayed, the game result being obtained by rearranging a plurality of symbols disposed on a plurality of reels driven by motors;

a light device for illuminating symbols or backgrounds of the symbols with light in specified colors;

a memory holding a color determination table for determining colors for the light to illuminate the symbols or the backgrounds of the symbols and a winning pattern identification table for identifying a winning pattern based on the colors of the light to illuminate the symbols or the backgrounds of the symbols; and

a controller programmed to perform the following processing of (7-1) to (7-3):

(7-1) determining colors for light to illuminate a specific kind of symbols of the plurality of symbols or backgrounds of the specific kind of symbols by lottery processing with reference to the color determination table held in the memory;

(7-2) setting the colors determined in the processing of (7-1) to individually illuminate the specific kind of symbols or the backgrounds of the specific kind of symbols; and

(7-3) identifying a winning pattern with reference to the winning pattern identification table based on the specific kind of symbols which are individually illuminated or the backgrounds of which are individually illuminated with light in the colors set in the processing of (7-2).

The number and the kinds of the symbols disposed on a so-called mech reel are limited by the size of the mech reel. For this reason, it is difficult to dispose many kinds of symbols on a mech reel and winning patterns could be monotonous. Illuminating rearranged symbols in different colors diversifies the winning patterns and increases the kinds of payout, achieving a gaming machine that keeps the player from being bored.

In the gaming machine according to the embodiment,

the memory can hold a plurality of color determination tables for determining colors to be specified from a plurality of colors and a table for determining a color determination table from the plurality of color determination tables;

each of the plurality of color determination tables can specify probabilities of drawing the plurality of colors;

the table for determining a color determination table can specify probabilities of drawing the plurality of color determination tables; and

the processing of (7-1) can include the following processing of (8-1) and (8-2):

(8-1) determining a color determination table from the plurality of color determination tables by lottery processing with reference to the table for determining a color determination table when the specific kind of symbols appear in the display area; and

(8-2) determining colors to be specified from the plurality of colors by lottery processing with reference to the color determination table determined by the processing of (8-1).

Instead of determining illumination colors directly, a color determination table is first determined with reference to the table for determining a color determination table and then illumination colors are determined with reference to the color determination table. Having various color determination tables enables the likelihood of determination of illumination colors to be different depending on the game result. Changing the tendency of the colors to be selected depending on the game result can enhance the player's expectation.

A gaming machine according to yet another embodiment comprises:

a symbol display device having a display area in which a game result is displayed, the game result being obtained by rearranging a plurality of symbols disposed on a plurality of reels driven by motors;

a backlight for illuminating symbols from behind the symbols;

a front light for illuminating the plurality of reels from front of the reels;

a memory holding a plurality of illumination color determination tables for determining illumination colors for the symbols and a table for determining an illumination color determination table from the plurality of illumination color determination tables; and

a controller programmed to perform the following processing of (9-1) and (9-2):

(9-1) determining an illumination color determination table from the plurality of illumination color determination tables by lottery processing with reference to the table for determining an illumination color determination table in a case where a predetermined number or more of a specific kind of symbols are to appear in the display area; and

(9-2) controlling the front light to emit light in a pure color upon start of spinning of the plurality of reels in a case where the illumination color determination table determined in the processing of (9-1) specifies the pure color.

When an illumination color determination table specifying a pure color is selected, the front light emits light in the pure color. The light in the pure color makes the player expect a high payout. Depending on the color of the pure color, the player can expect a high or low payout.

In the gaming machine according to the embodiment,

the controller can be programmed to further perform the following processing of (10-1):

(10-1) controlling the backlight to illuminate the specific kind of symbols by emitting light in the pure color synchronously with spinning motion of the specific kind of symbols caused by spinning of the plurality of reels.

The specific kind of symbols are illuminated in a pure color synchronously with the motion of the symbols. Accordingly, the player can feel expectation for a high payout.

Even in a gaming machine equipped with real reels, the kinds of symbols can be increased so that the kinds of winning patterns and the kinds of payouts can be increased.

These and other aspects, features and advantages of the present invention will become readily apparent to those having ordinary skill in the art upon a reading of the following detailed description of the invention in view of the drawings and claims.

### BRIEF DESCRIPTION OF THE DRAWINGS

The nature and mode of operation of the present invention will now be more fully described in the following detailed description of the invention taken with the accompanying drawing figures, in which:

FIGS. 1A and 1B are views for illustrating a general configuration of a gaming machine;

FIG. 2 is an elevation view of a slot machine;

FIG. 3 is a perspective view of the slot machine;

FIG. 4 is a perspective view of a control panel;

FIG. 5 is a block diagram of a circuitry of the slot machine;

FIG. 6 is a block diagram of a circuitry of the slot machine;

FIG. 7 is a block diagram of a circuitry of an AP-X motherboard;

FIG. 8A is a perspective view of a front light and FIG. 8B is a perspective view of a backlight;

FIG. 9 is a diagram of a general configuration of gaming machines;

FIG. 10 is a block diagram of the game system;

FIG. 11 is a block diagram of a PTS system;

FIG. 12 is a diagram for illustrating state transitions in the gaming machine;

FIG. 13 is a view of an example of a payline definition table;

FIG. 14 is a view of an example of a payout table;

FIG. 15 is a view of a configuration of reel strips;

FIG. 16 is a view of a configuration of reel strips;

FIG. 17 is a flowchart of main control processing in the gaming machine;

FIG. 18 is a flowchart of coin-insertion/start check processing;

FIG. 19 is a flowchart of symbol lottery processing;

FIG. 20 is a flowchart of symbol display control processing;

FIG. 21 is a flowchart of payout determination processing;

FIG. 22 is a flowchart of free game mode processing;

FIG. 23 is a flowchart of number-of-games determination processing;

FIG. 24 is a flowchart of effect initiation processing;

FIG. 25 is a flowchart of color table determination processing;

FIG. 26 is a flowchart of emission color determination processing;

FIGS. 27A and 27B provide examples of color table determination tables;

FIGS. 28A to 28I provide examples of color tables;

FIG. 29 is a table listing the relations between maximum numbers for unit games in a free game mode and weights;

FIGS. 30A to 30D provide drawings for illustrating an example of a process to determine a color table;

FIG. 31 is a drawing for illustrating an example of a roulette game;

FIGS. 32A to 32C are tables for illustrating outlines of predictive/li-zhi effects;

FIGS. 33A to 33G are drawings for illustrating examples of symbol matrices;

FIGS. 34A to 34F are drawings for illustrating examples of symbol matrices; and

FIGS. 35A to 35F are drawings for illustrating examples of symbol matrices.

### DESCRIPTION OF EMBODIMENTS

### Overview of Gaming Machine in Embodiment

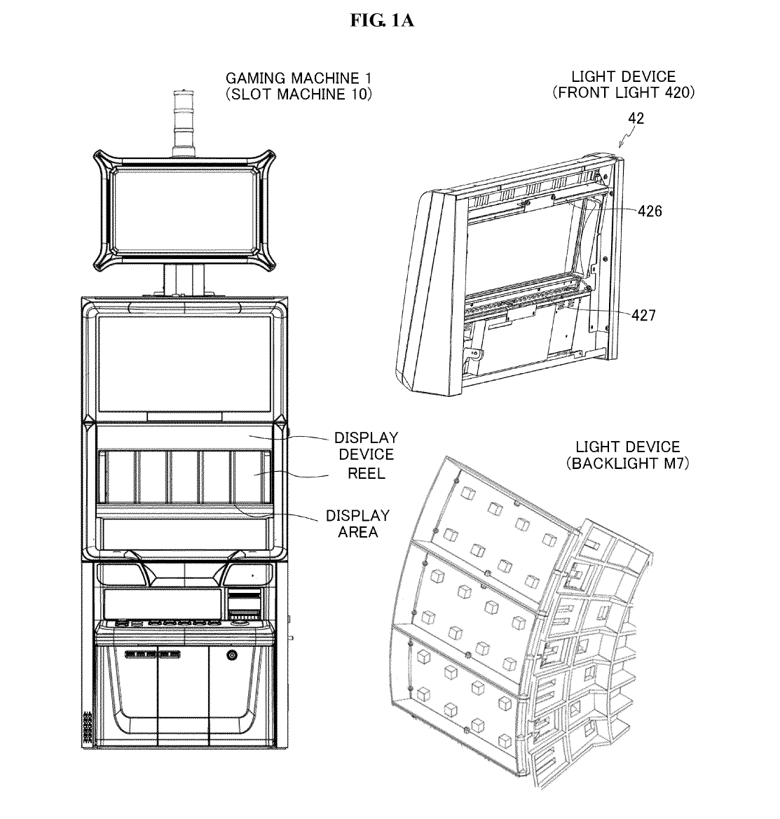

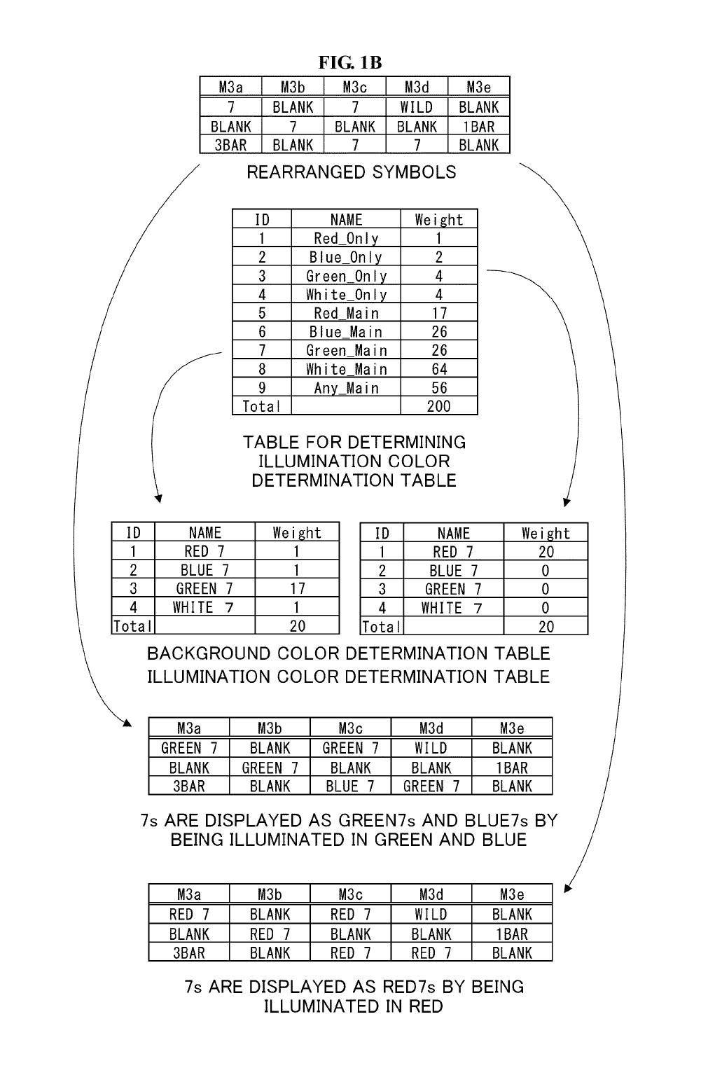

FIGS. 1A and 1B are views for illustrating a general configuration of a gaming machine in the present embodiment.

The gaming machine in the present embodiment is a gaming machine (e.g., a gaming machine 1 to be described later) controlled to determine a color for a symbol or a color for a background of the symbol at random from two or more colors and to determine an amount of payout differently depending on the determined color. The gaming machine comprises:

a symbol display device (e.g., mech reels M3a to M3e to be described later) for rearranging a plurality of symbols;

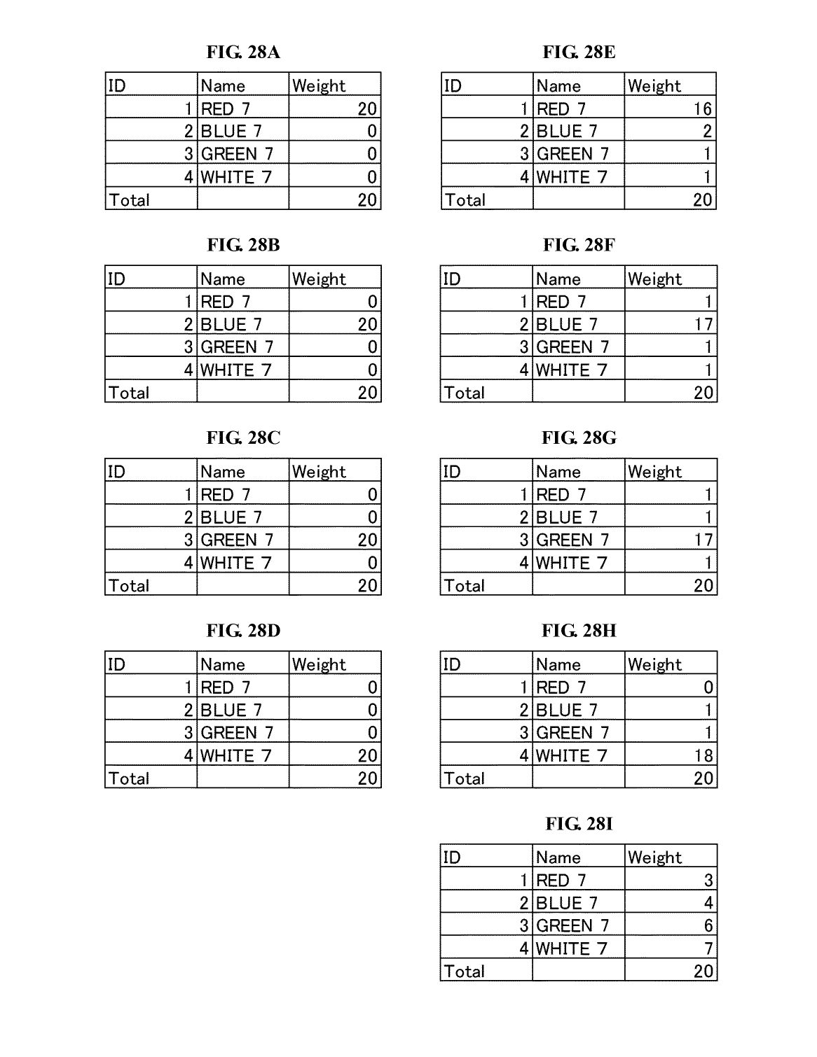

a memory (e.g., an auxiliary storage device 220 or a main RAM 210 to be described later) holding a plurality of color determination tables (e.g., color tables in FIGS. 28A to 28I to be described later) among which probabilities of determining the two or more colors for the symbol or the background of the symbol are different; and

a controller (e.g., a main CPU 200 to be described later) for determining a color for the symbol or a color for the background of the symbol at random using one of the plurality of color determination tables held in the memory (e.g., step S2617 in FIG. 26 to be described later).

That is to say, the gaming machine according to the present embodiment has a plurality of color determination tables. Among the plurality of color determination tables, probabilities of determining the color for a symbol or the color for the background of the symbol are different. Furthermore, the amount of payout is different depending on the determined color. Specifying the probabilities of determining the color as appropriate allows specifying the amounts of payout; the benefit for the player can be conditioned by both of determining the colors and determining the symbols.

In the gaming machine in the present embodiment, the plurality of color determination tables held in the memory includes a color determination table (e.g., FIG. 28A to be described later) in which the probabilities of determining the two or more colors are specified to select a specific color, a color determination table (e.g., FIGS. 28B, 28C, and 28D to be described later) in which the probabilities of determining the two or more colors are specified to select one of the two or more colors excluding the specific color, and a color determination table (e.g., FIGS. 28E to 28I to be described later) in which the probabilities of determining the two or more colors are specified to select any of the two or more colors.

The plurality of color determination tables are three kinds of color determination tables. The first kind of color determination table is for selecting a specific color. If the first kind of color determination table is selected, the specific color is selected. The second kind of color determination tables are for selecting one of the two or more colors excluding the specific color. If a second kind of color determination table is selected, a color excluding the specific color is selected. The third kind of color determination tables are for selecting any of the two or more colors. If a third kind of color determination table is selected, any color could be selected.

Providing these three kinds of color determination tables enables conditioning the likelihood of determination depending on the color, which enables conditioning the amount of payout depending on the color.

In the gaming machine in the present embodiment,

the memory further holds a table for determining a color determination table, which is for determining one of the plurality of color determination tables at random;

the table for determining a color determination table specifies a probability of drawing the color determination table specified to select any of the two or more colors (e.g., FIGS. 28E to 28I to be described later) as higher than a probability of drawing the color determination table specified to select the specific color (e.g., FIG. 28A to be described later); and

the controller determines a color determination table to be used at random based on the table for determining a color determination table.

The probability of drawing the color determination table specified to select any of the two or more colors is specified as higher than the probability of drawing the color determination table specified to select the specific color. Accordingly, the color determination table specified to select any of the two or more colors is more likely to be selected, which generates possibilities that not only a specific color but also any other color may be selected. Accordingly, the amount of payout associated with a specific color can be balanced with the amounts of payout associated with the other colors.

In the gaming machine in the present embodiment,

the plurality of color determination tables include the color determination table specified to select the specific color, at least one color determination table specified to select a color different from the specific color, and color determination tables specified to select any of the two or more colors;

among the color determination table specified to select the specific color, the at least one color determination table specified to select a color different from the specific color, and the color determination tables specified to select any of the two or more colors, the color determination tables specified to select any of the two or more colors are more than the other color determination tables; and

among the color determination tables specified to select any of the two or more colors (e.g., FIGS. 28E to 28I to be described later), probabilities of selecting different colors are specified to be different.

Among the color determination tables specified to select any of the two or more colors, probabilities of selecting different colors are specified to be different, which generates possibilities of selecting different colors. The amounts of payout associated with different colors can be balanced.

A gaming machine (e.g., a gaming machine 1 to be described later) in the present embodiment comprises:

a symbol display device (e.g., a lower display unit 141 to be described later) for displaying a game result by rearranging a plurality of symbols;

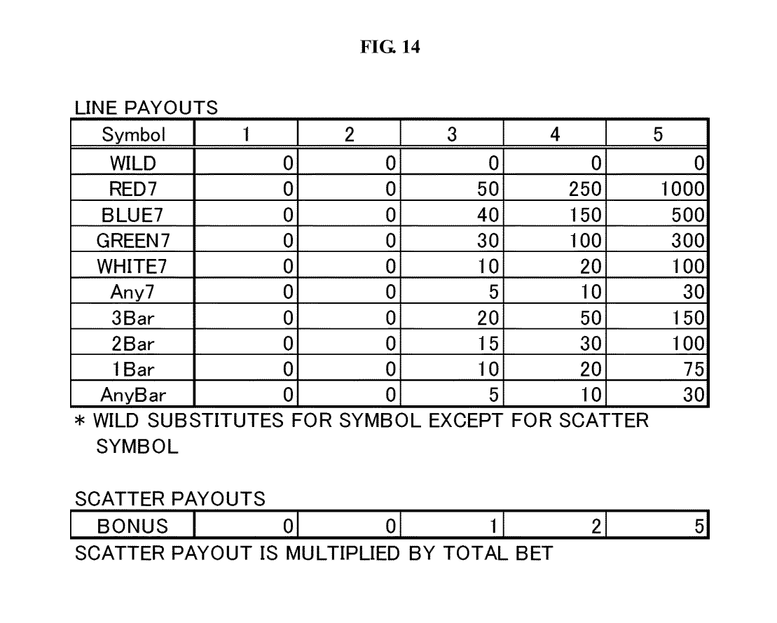

a memory (e.g., an auxiliary storage device 220 or a main RAM 210 to be described later) holding a color determination table (e.g., a color table in FIGS. 28A to 28I to be described later) for determining colors for symbols or colors for backgrounds of the symbols (e.g., an emission color to be described later) and a winning pattern identification table (e.g., a payout table in FIG. 14 to be described later) for identifying a winning pattern based on the colors of the symbols or the colors of the background of the symbols; and

a controller (e.g., a main CPU 200 to be described later) programmed to perform the following processing of (5-1) to (5-3):

(5-1) determining colors for a specific kind of symbols of the plurality of symbols or colors for backgrounds of the specific kind of symbols by lottery processing with reference to the color determination table held in the memory (e.g., step S2617 in FIG. 26 to be described later);

(5-2) individually setting the colors determined in the processing of (5-1) to the specific kind of symbols or the backgrounds of the specific kind of symbols (e.g., step S2017 in FIG. 20 to be described later); and

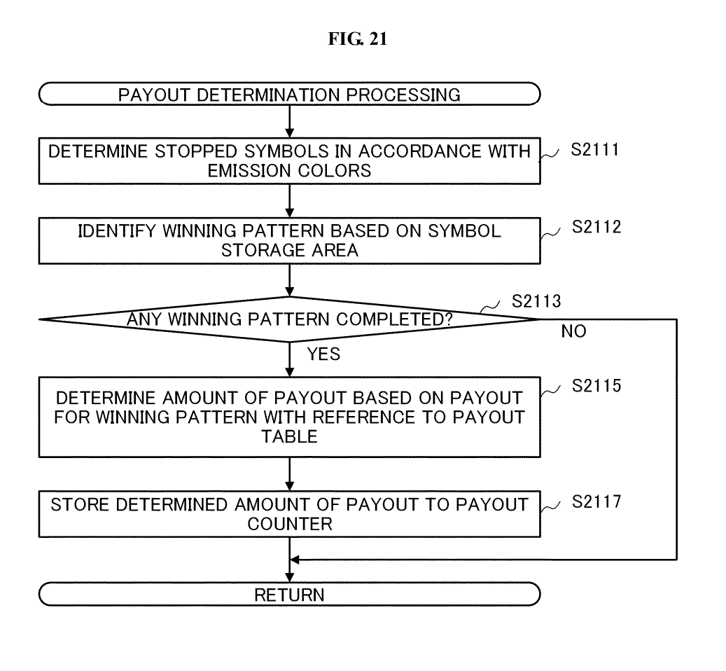

(5-3) identifying a winning pattern with reference to the winning pattern identification table based on the specific kind of symbols to which or to the background of which the colors are set individually in the processing of (5-2) (e.g., payout determination processing in FIG. 21 to be described later).

The foregoing configuration determines colors of a specific kind of symbols or colors of the backgrounds of the specific kind of symbols with reference to a color determination table, changes the color for each of the specific kind of symbols or the backgrounds of the specific kind of symbols, and identifying whether any winning pattern is completed based on the colors after the change.

That is to say, the gaming machine in the present embodiment can change colors of a specific kind of symbols or backgrounds of the specific kind of symbols individually and does not change colors of the entire reel strips.

The language “the colors of symbols or the colors of the backgrounds of the symbols” implies application to video reels as well as mech reels. The gaming machine in the present embodiment changes colors of a specific kind of symbols or the backgrounds of the specific kind of symbols individually and identifies a winning pattern based on the colors after the change.

In this configuration, identifying a winning pattern is not performed merely after symbol lottery processing but is performed after determining the colors of the rearranged symbols or the background of the rearranged symbols. Accordingly, even if symbols having the same appearance are rearranged, assigning different colors to the symbols or the backgrounds of the symbols leads the symbols to be treated as different kinds of symbols, achieving more diverse winning patterns.

A gaming machine (e.g., a gaming machine 1 to be described later) in the present embodiment comprises:

a symbol display device (e.g., a lower display unit 141 to be described later) including a display area (e.g., a symbol display area 141d to be described later) in which a game result is displayed, the game result being obtained by rearranging a plurality of symbols disposed on a plurality of reels (e.g., mech reels M3a to M3e to be described later) driven by motors;

a light device (e.g., backlights M7 to be described later) for illuminating symbols or backgrounds of the symbols with light in specified colors (e.g., emission colors to be described later);

a memory (e.g., an auxiliary storage device 220 or a main RAM 210 to be described later) holding a color determination table (e.g., a color table in FIGS. 28A to 28I to be described later) for determining colors for the light to illuminate the symbols or the backgrounds of the symbols and a winning pattern identification table (e.g., a payout table in FIG. 14 to be described later) for identifying a winning pattern based on the colors of the light to illuminate the symbols or the backgrounds of the symbols; and

a controller (e.g., a main CPU 200 to be described later) programmed to perform the following processing of (7-1) to (7-3):

(7-1) determining colors for light to illuminate a specific kind of symbols of the plurality of symbols or backgrounds of the specific kind of symbols by lottery processing with reference to the color determination table held in the memory (e.g., step S2617 in FIG. 26 to be described later);

(7-2) setting the colors determined in the processing of (7-1) to individually illuminate the specific kind of symbols or the backgrounds of the specific kind of symbols (e.g., step S2017 in FIG. 20 to be described later); and

(7-3) identifying a winning pattern with reference to the winning pattern identification table based on the specific kind of symbols which are individually illuminated or the backgrounds of which are individually illuminated with light in the colors set in the processing of (7-2) (e.g., payout determination processing in FIG. 21 to be described later).

Symbols are disposed on each of a plurality of reels to be driven by motors. In other words, the symbols are disposed on so-called mech reels. A plurality of symbols are rearranged in the display area. The symbols rearranged in the display area represent a game result.

The gaming machine in the present embodiment can separately select colors for individual symbols. The symbols are illuminated by the light device. The gaming machine in the present embodiment can control the light device to individually illuminate the symbols.

The number and the kinds of the symbols disposed on a so-called mech reel are limited by the size of the mech reel. For this reason, it is difficult to dispose many kinds of symbols on a mech reel and winning patterns could be monotonous. Illuminating rearranged symbols in different colors diversifies winning patterns and increases the kinds of payout, achieving a gaming machine that keeps the player from being bored.

In the gaming machine in the present embodiment,

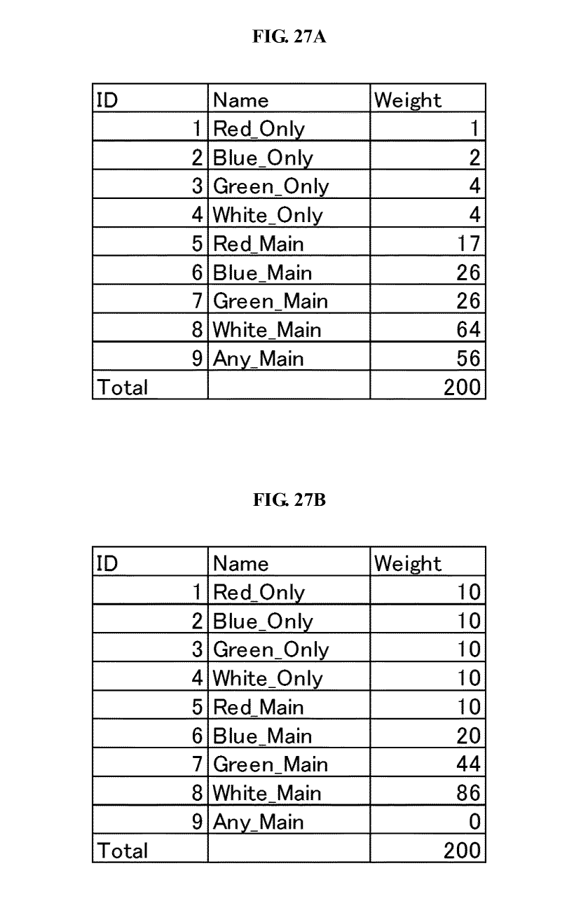

the memory holds a plurality of color determination tables (e.g., color tables in FIGS. 28A to 28I to be described later) for determining colors to be specified from a plurality of colors and a table for determining a color determination table (e.g., color table determination tables in FIGS. 27A and 27B to be described later) from the plurality of color determination tables;

each of the plurality of color determination tables specifies probabilities of drawing the plurality of colors;

the table for determining a color determination table specifies probabilities of drawing the plurality of color determination tables; and

the processing of (7-1) includes the following processing of (8-1) and (8-2):

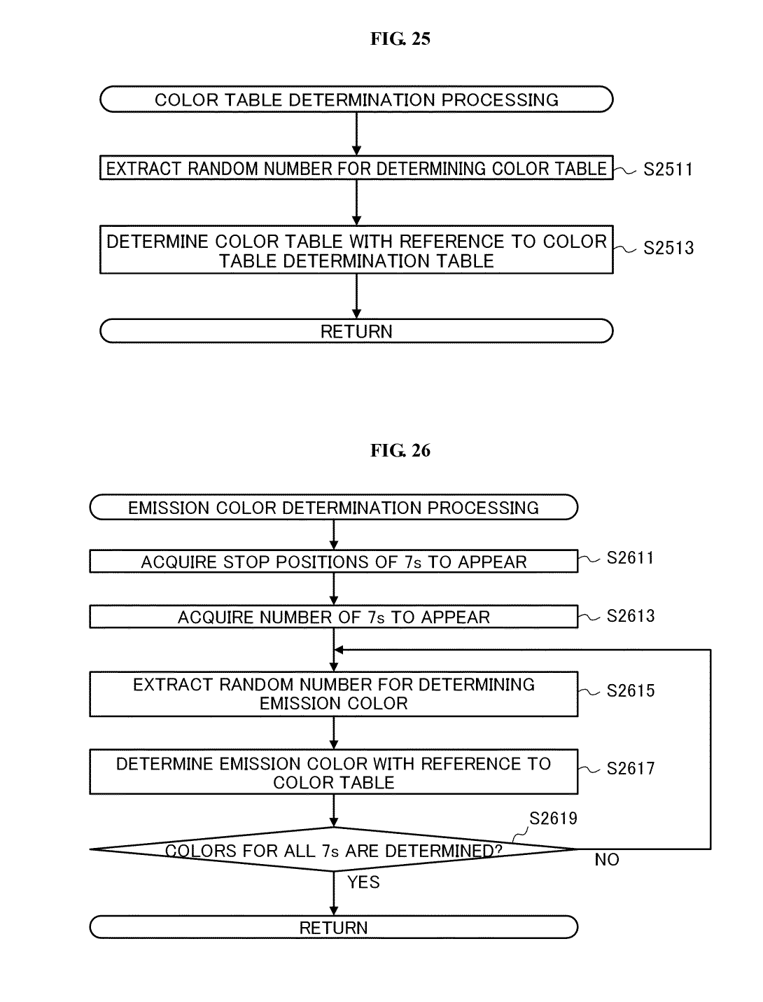

(8-1) determining a color determination table from the plurality of color determination tables by lottery processing with reference to the table for determining a color determination table when the specific kind of symbols appear in the display area (e.g., color table determination processing in FIG. 25 to be described later); and

(8-2) determining colors to be specified from the plurality of colors by lottery processing with reference to the color determination table determined by the processing of (8-1) (e.g., steps S2615 and S2617 in FIG. 26 to be described later).

Instead of determining illumination colors directly, a color determination table is first determined with reference to the table for determining a color determination table and then illumination colors are determined with reference to the color determination table. Having various color determination tables enables the likelihood of determination of illumination colors to be different depending on the game result. Changing the tendency of the colors to be selected depending on the game result can enhance the player's expectation.

It is preferable that the gaming machine have game modes of base game mode and bonus game mode (e.g., free game mode) that could be advantageous over the base game mode. In the case of employing this configuration, it is preferable that the gaming machine have a table for the base game mode and a table for the bonus game mode for the table for determining a color determination table, so that the gaming machine can determine a color determination table to determine an illumination color with reference to the table for base game mode during the base game mode and the gaming machine can determine a color determination table to determine an illumination color with reference to the table for bonus game mode during the bonus game mode.

This approach provides different color selections for the base game mode and the bonus game mode, so that winning patterns can be defined differently between the two game modes. Even if the same color selections are provided for the base game mode and the bonus game mode, the likelihood of selecting the colors can be specified differently, so that likelihood of completing winning patterns can be defined differently.

An example is illustrated in FIGS. 1A and 1B. Symbol lottery processing determines symbols to be rearranged in the display. As illustrated in FIGS. 1A and 1B, symbol lottery processing determines to show a 7, a BLANK, and a 3BAR on the top row, the middle row, and the bottom row of the reel M3a, a BLANK, a 7, and a BLANK on the top row, the middle row, and the bottom row of the reel M3b, a 7, a BLANK, and a 7 on the top row, the middle row, and the bottom row of the reel M3c, a WILD, a BLANK, and a 7 on the top row, the middle row, and the bottom row of the reel M3d, and a BLANK, a 1BAR, and a BLANK on the top row, the middle row, and the bottom row of the reel M3e.

In this example, 7s appear at five positions: the top row of the reel M3a, the middle row of the reel M3b, the top and the bottom rows of the reel M3c, and the bottom row of the reel M3d. In the phase where the symbol lottery processing is finished, the illumination colors of these 7s are not determined.

If the color determination table Green Main (ID=7) is subsequently determined by lottery processing with reference to the table for determining a color determination table, illumination colors are determined by lottery processing using the color determination table Green Main. As illustrated in FIGS. 1A and 1B, the color determination table Green Main defines the weight of RED 7 as 1, the weight of BLUE 7 as 1, the weight of GREEN 7 as 17, and the weight of WHITE 7 as 1. The probability of selecting GREEN 7 is high and the probabilities of selecting RED 7, BLUE 7, and WHITE 7 are low.

The illumination colors are determined using this color determination table Green Main. As illustrated in FIGS. 1A and 1B, the determination results in a GREEN7, a BLANK, a 3BAR for the top row, the middle row, and the bottom row of the reel M3a; a BLANK, a GREEN7, and a BLANK for the top row, the middle row, and the bottom row of the reel M3b; a GREEN7, a BLANK, and a BLUE7 for the top row, the middle row, and the bottom row of the reel M3c; a WILD, a BLANK, and a GREEN7 for the top row, the middle row, and the bottom row of the reel M3d; and a BLANK, a 1BAR, and a BLANK for the top row, the middle row, and the bottom row of the reel M3e. Illumination colors are thus determined for all the five 7s.

Determination of illumination colors allows identification of a winning pattern (e.g., FIG. 14) to determine a payout.

For another example, if the color determination table Red Only (ID=1) is determined by lottery processing with reference to the table for determining a color determination table, illumination colors are determined by lottery processing using the color determination table Red Only. As illustrated in FIGS. 1A and 1B, the color determination table Red Only defines the weight of RED 7 as 20, the weight of BLUE 7 as 0, the weight of GREEN 7 as 0, and the weight of WHITE 7 as 0. According to the color determination table, only RED 7 is selected.

The illumination colors are determined using this color determination table Red Only. As illustrated in FIGS. 1A and 1B, the determination results in a RED7, a BLANK, a 3BAR for the top row, the middle row, and the bottom row of the reel M3a; a BLANK, a RED7, and a BLANK for the top row, the middle row, and the bottom row of the reel M3b; a RED7, a BLANK, and a RED7 for the top row, the middle row, and the bottom row of the reel M3c; a WILD, a BLANK, and a RED7 for the top row, the middle row, and the bottom row of the reel M3d; and a BLANK, a 1BAR, and a BLANK for the top row, the middle row, and the bottom row of the reel M3e. In this case, all the illumination colors for the five 7s are red.

This determination of illumination colors allows identification of a winning pattern (e.g., FIG. 14) to determine a payout.

A gaming machine (e.g., a gaming machine 1 to be described later) in the present embodiment comprises:

a symbol display device (e.g., a lower display unit 141 to be described later) having a display area (e.g., a symbol display area 141d to be described later) in which a game result is displayed, the game result being obtained by rearranging a plurality of symbols disposed on a plurality of reels (e.g., mech reels M3a to M3e to be described later) driven by motors;

a backlight (e.g., backlights M7 to be described later) for illuminating symbols from behind the symbols;

a front light (e.g., a front light 420 to be described later) for illuminating the plurality of reels from front of the reels;

a memory (e.g., an auxiliary storage device 220 or a main RAM 210 to be described later) holding a plurality of illumination color determination tables (e.g., color tables in FIGS. 28A to 28I to be described later) for determining illumination colors for the symbols and a table for determining an illumination color determination table (e.g., a color table determination table in FIGS. 27A and 27B to be described later) from the plurality of illumination color determination tables; and

a controller (e.g., a main CPU 200 to be described later) programmed to perform the following processing of (9-1) and (9-2):

(9-1) determining an illumination color determination table from the plurality of illumination color determination tables by lottery processing with reference to the table for determining an illumination color determination table in a case where a predetermined number or more of a specific kind of symbols are to appear in the display area (e.g., color table determination processing in FIG. 25 to be described later); and

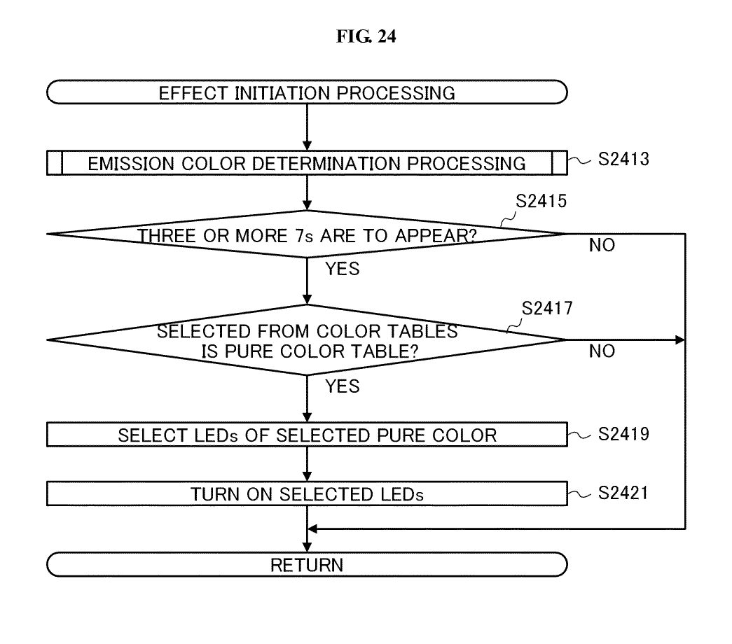

(9-2) controlling the front light to emit light in a pure color upon start of spinning of the plurality of reels in a case where the illumination color determination table determined in the processing of (9-1) specifies the pure color (e.g., effect initiation processing in FIG. 24 to be described later).

When an illumination color determination table specifying a pure color is selected, the front light emits light in the pure color. The light in the pure color makes the player expect a high payout. Depending on the color of the pure color, the player can expect a high or low payout.

In the present embodiment, a pure color means a specific single color. For example, the pure color may be red, blue, green, or white, which can be recognized by the player as a single color. Particularly, it is preferable that the pure color have the highest saturation in the hue. The pure color can be a primary color. The requirement for a pure color is satisfied if the player can recognize the color for illuminating a symbol as a color different from the other pure colors.

In the gaming machine in the present embodiment,

the controller is programmed to further perform the following processing of (10-1):

(10-1) controlling the backlight to illuminate the specific kind of symbols by emitting light in the pure color synchronously with spinning motion of the specific kind of symbols caused by spinning of the plurality of reels.

The specific kind of symbols are illuminated in a pure color synchronously with the motion of the symbols. Accordingly, the player can expect a high payout.

A gaming machine (e.g., a gaming machine 1 to be described later) in the present embodiment comprises:

a display device (e.g., a lower display unit 141 to be described later) having a display area (e.g., a symbol display area 141d to be described later) in which a game result is displayed, the game result being obtained by rearranging a plurality of symbols disposed on a plurality of reels (e.g., mech reels M3a to M3e to be described later) driven by motors;

a backlight (e.g., backlights M7 to be described later) for illuminating the plurality of reels at individual stop positions of symbols from behind the plurality of reels;

a controller (e.g., a main CPU 200 to be described later) programmed to perform the following processing of (X-1) to (X-5); and

a memory (e.g., an auxiliary storage device 220 or a main RAM 210 to be described later) holding a plurality of illumination color determination tables (e.g., color tables in FIGS. 28A to 28I to be described later) for determining illumination colors (e.g., emission colors to be described later) for the symbols and a table for determining an illumination color determination table (e.g., a color table determination table in FIGS. 27A and 27B to be described later) from the plurality of illumination color determination tables.

The processing of (X-1) to (X-5) are as follows:

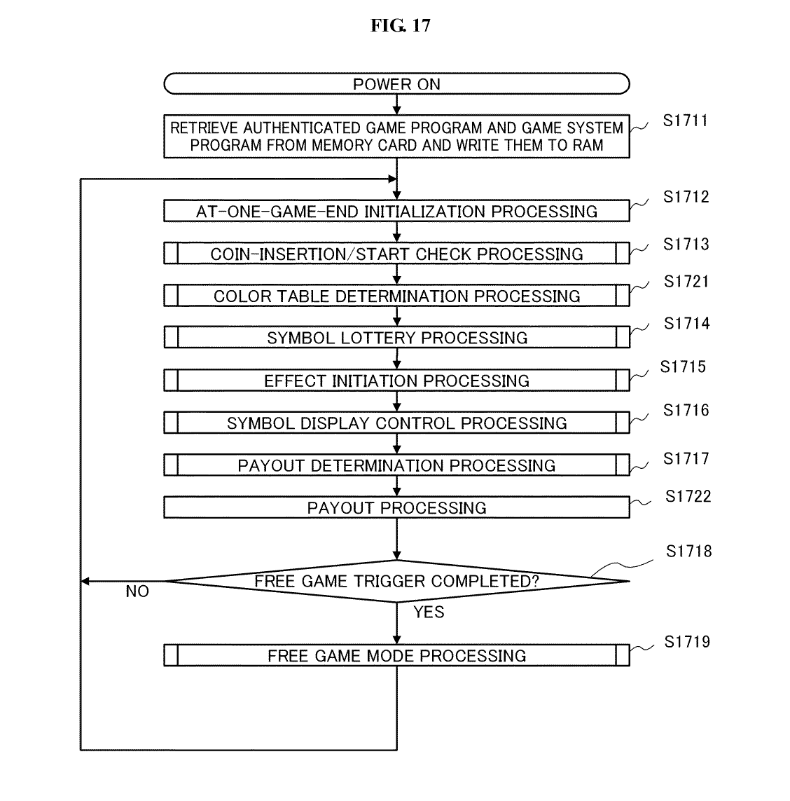

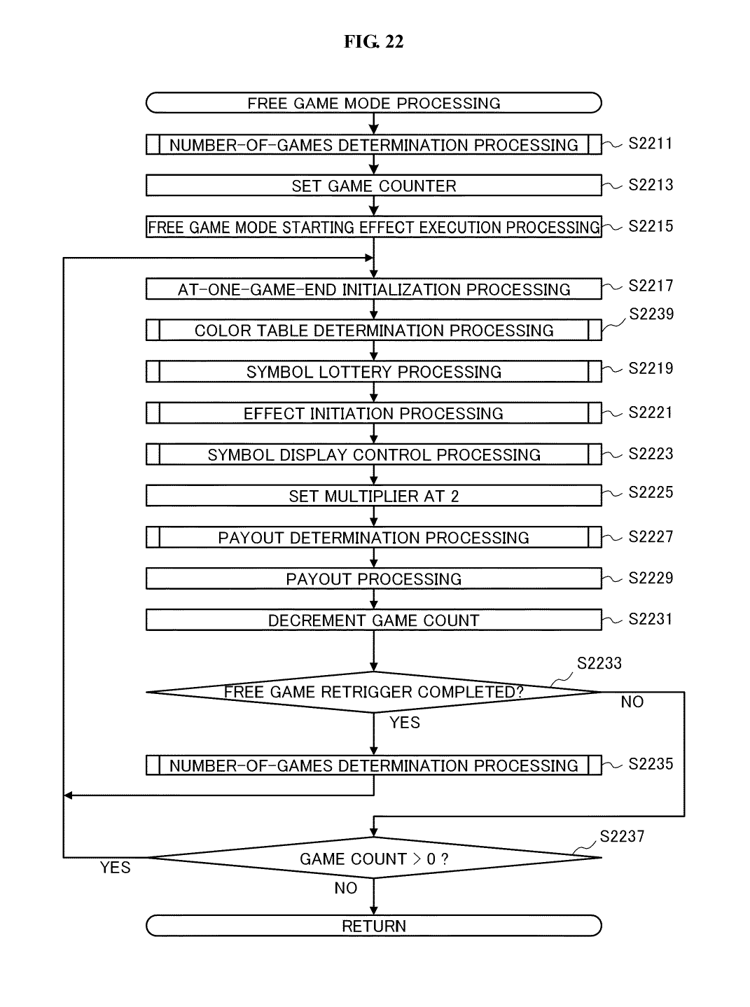

(X-1) determining an illumination color determination table from the plurality of illumination color determination tables by lottery processing with reference to the table for determining an illumination color determination table (e.g., step S1721 in FIG. 17, step S2239 in FIG. 22 (color table determination processing in FIG. 25) to be described later);

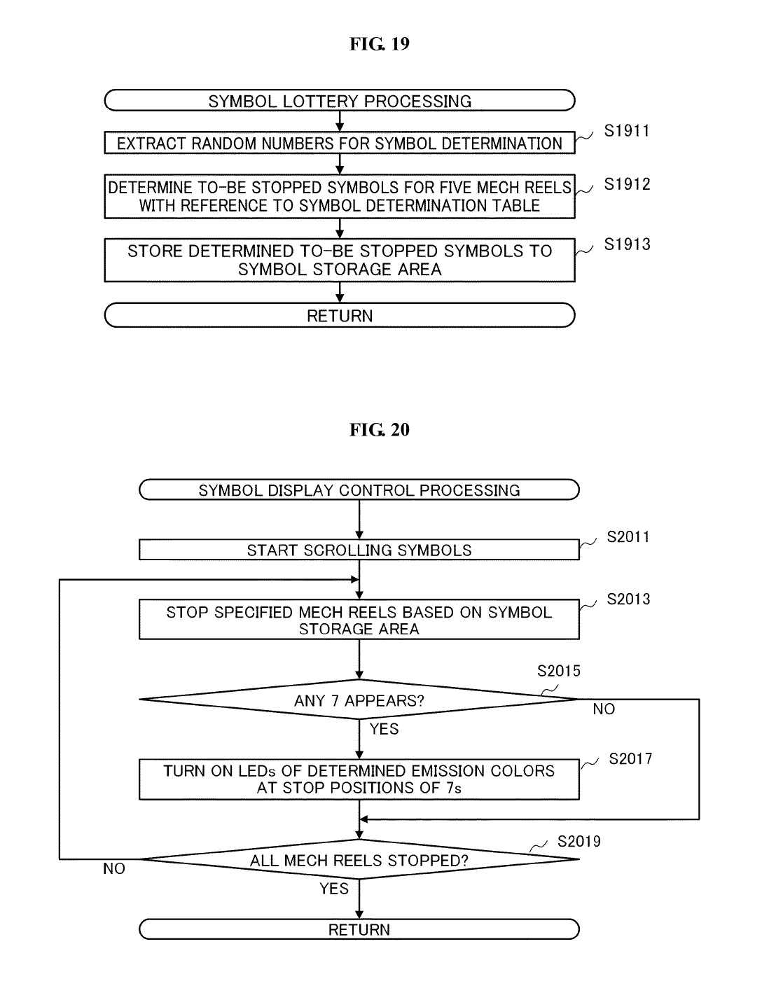

(X-2) determining symbols to be rearranged on the display device (e.g., symbol lottery processing in FIG. 19 to be described later);

(X-3) determining an illumination color from a plurality of illumination colors by lottery processing with reference to the illumination color determination table determined in the processing of (X-1) (e.g., steps S2615 and S2617 in FIG. 26 to be described later);

(X-4) in a case where a plurality of symbols of a specific kind are to appear in the display area, performing the processing of (X-3) for each of the plurality of symbols of the specific kind to determine an illumination color for each of the plurality of symbols of the specific kind (e.g., step S2619 in FIG. 26 to be described later); and

(X-5) determining an amount of payout in accordance with the illumination color determined in the processing of (X-3) (e.g., payout determination processing in FIG. 21 to be described later).

Since the kinds of symbols are not determined only through the symbol lottery processing, the payout is not determined and can be determined after the illumination colors of the symbols appearing in the display area are determined. Even if symbols having the same appearance are rearranged, assigning different colors leads the symbols to be treated as different kinds of symbols, achieving more diverse winning patterns.

The number of the symbols disposed on a mech reel is limited by the size or the shape of the mech reel. For this reason, it is difficult to dispose many kinds of symbols on a mech reel and patterns of the rearranged symbols could be monotonous. Winning patterns could also be monotonous, so that providing various payouts could also be difficult. Providing more variations of rearranged symbol patterns and providing more variations of winning patterns enable providing a gaming machine that keeps the player from being bored.

A gaming machine (e.g., a gaming machine 1 to be described later) in the present embodiment comprises:

a display device (e.g., a lower display unit 141 to be described later) having a display area (e.g., a symbol display area 141d to be described later) in which a game result is displayed, the game result being obtained by rearranging a plurality of symbols disposed on a plurality of reels (e.g., mech reels M3a to M3e to be described later) driven by motors;

a backlight (e.g., backlights M7 to be described later) for illuminating the plurality of reels at individual stop positions of symbols from behind the plurality of reels;

a front light (e.g., a front light 420 to be described later) for illuminating the plurality of reels from front of the plurality of reels;

a controller (e.g., a main CPU 200 to be described later) programmed to perform the following processing of (Y-1) to (Y-5); and

a memory (e.g., an auxiliary storage device 220 or a main RAM 210 to be described later) holding a plurality of illumination color determination tables (e.g., color tables in FIGS. 28A to 28I to be described later) for determining a plurality of illumination colors to be emitted from the backlight, a table for determining an illumination color determination table (e.g., a color table determination table in FIGS. 27A and 27B to be described later) from the plurality of illumination color determination tables, and a payout table (e.g., a payout table in FIG. 14 to be described later) in which winning patterns and payouts are defined in association with illumination colors.

The processing of (Y-1) to (Y-5) are as follows:

(Y-1) determining an illumination color determination table from the plurality of illumination color determination tables by lottery processing with reference to the table for determining an illumination color determination table (e.g., step S1721 in FIG. 17, step S2239 in FIG. 22 (color table determination processing in FIG. 25) to be described later);

(Y-2) determining symbols to be rearranged on the display device (e.g., symbol lottery processing in FIG. 19 to be described later);

(Y-3) in a case where a plurality of symbols of a specific kind are to appear in the display area (e.g., step S2415 in FIG. 24 to be described later) and the illumination color table determined in the processing of (Y-2) is a table specifying a pure color (e.g., step S2417 in FIG. 24 to be described later), controlling the front light to emit light in the pure color upon start of spinning of the plurality of reels (e.g., step S2421 in FIG. 24 to be described later);

(Y-4) controlling the backlight to emit light in the pure color to illuminate the specific kind of symbols spinning with the spinning of the plurality of reels with the light in the pure color; and

(Y-5) controlling the backlight to illuminate the specific kind of symbols by emitting light in the pure color synchronously with spinning motion of the specific kind of symbols caused by spinning of the plurality of reels.

When an illumination color determination table specifying a pure color is determined, the front light emits light in the pure color. The player can expect for a high payout by seeing the light in the pure color. Depending on the illumination color, the player expects a different level of payout.

### <<<Basic Concept>>>

A slot machine 10 is a kind of gaming machine. The present embodiment describes a slot machine 10 as an example of a gaming machine; however, the gaming machine is not limited to this and is satisfactory if the apparatus independently operates a base game mode and develops the base game mode to a different game mode such as free game mode.

Games conducted in the base game mode in the present embodiment are conducted in the slot machine 10. In the present embodiment, games in the base game mode are referred to as base games. The base games are slot games that rearrange a plurality of symbols each time. The base games are games conceptually distinguished from free games.

Specifically, rearranging symbols in a slot game is performed by five reels M3a to M3e (hereinafter referred to as mech reels M3a to M3e) which can be mechanically rotated and stopped by activation and deactivation of motors. The symbols to be rearranged are stopped and shown in a symbol display area 141d of a lower display unit 141.

The slot games are categorized into base game mode and free game mode. The base game mode is to conduct unit games (base games or slot games) under the condition that a gaming medium (gaming value) is bet. Each unit game rearranges symbols in the symbol display area 141d and provides a normal payout in accordance with the rearranged symbols. The games in the base game mode are not limited to slot games and are satisfactory if the games can be conducted in a game terminal like a slot machine 10.

Upon start of a unit game, an arrangement of a set of symbols is released. The releasing the arrangement of symbols starts to show the symbols as being shuffled. After a predetermined time, the symbols are stopped. Stopping the symbols rearranges another set of symbols. Rearranging the symbols provides the result of the unit game. In the present embodiment, stopping symbols means showing the symbols (appearance of the symbols) on the display. Rearranging symbols forms a symbol matrix.

The free game mode is to conduct unit games (free games) when symbols rearranged in a base game mode satisfy a predetermined condition. Each unit game rearranges symbols under conditions different from those of a base game and provides a payout in accordance with the rearranged symbols.

Symbols are rearranged to be seen in the symbol display area 141d; they are not limited in kind or number. Symbol is a general concept of special symbol and normal symbol. Special symbols are added to normal symbols as necessary.

For example, special symbols include wild symbols (such as WILDs, which are described later) and trigger symbols (such as BONUSes, which are described later). Wild symbols are symbols that can substitute for other kinds of symbols. Wild symbols are replaced with other kinds of symbols to make an advantageous winning pattern. Trigger symbols are to be a trigger to start bonus games. Trigger symbols may have another function to increase special symbols in the bonus games, that is, to increase the special symbols of at least either trigger symbols or wild symbols. Alternatively, trigger symbols may have another function to increase bonus games in the bonus game mode.

Specifically, the term “symbol” is a generic term for a WILD (wild symbol), a RED7, a BLUE7, a GREEN7, a WHITE7, a 3BAR, a 2BAR, a 1BAR, a BONUS (trigger symbol), or a BLANK. The symbols in the present embodiment include BLANKs (blank symbols).

The BLANKs are symbols that will not be a constituent of a winning pattern. Accordingly, if a plurality of BLANKs are lined along a payline, they do not function as normal symbols to form a winning pattern. The BLANKs do not function as scatter symbols, either; if a plurality of BLANKs appear independently from a payline, they do not form a winning pattern.

A BLANK disposed on a mech reel functions as a symbol for controlling the stop position of the mech reel within the symbol display area 141d. The BLANKs are symbols for stop control of a mech reel; they are not taken into account in winning pattern identification even if they appear (are rearranged) in the symbol display area 141d.

In the present embodiment, the BLANKs do not include any picture or mark, making the player to see that the BLANKs do not form a winning pattern. For example, the BLANKs are preferably in a single color, but include areas that can be recognized as a single-colored area where, even if some decorative pattern or picture is provided, most of the area is in a single color or otherwise the color of the pattern or picture is pale.

The gaming value includes coins, bills, and electronically valuable information equivalent to these. The gaming value in the present embodiment is not specifically limited and can be gaming media such as medals, tokens, electronic money, and tickets. The tickets are not specifically limited and may be later-described tickets with barcodes.

Bonus games mean feature games. For example, bonus games may be unit games repeated in a free game mode. Bonus games can be any kind of games as far as the bonus games are advantageous over games in the base game mode. If the games are advantageous for the player, or if the games are advantageous over games in the base game mode, a plurality of kinds of bonus games may be mixed. For example, bonus games may be provided in one of the conditions or in combination of the conditions that more gaming value can be acquired than in the base game mode, that gaming value can be acquired at higher probability than in the base game mode, and that less gaming value is spent than in the base game mode.

Games in a free game mode (bonus games) may be any kind of games as far as they are different from base games. In the present embodiment, free games are conducted as bonus games. Free games can be conducted with a smaller bet of gaming value than base games and pays gaming value in the amount in accordance with a winning pattern completed with rearranged symbols. In other words, free games can be defined as games that can be started without requiring spending gaming value. “Without requiring spending gaming value” includes a case of zero bet.

Rearranging means an action of arranging symbols in the symbol display area 141d again after releasing an arrangement of symbols. An arrangement of symbols is released by starting a unit game (slot game) and subsequently, another set of symbols are arranged again (rearranged). The rearranged symbols determine a result of the unit game to terminate the unit game. Arrangement means a state in which symbols are visible by the player in the outside. A plurality of symbols rearranged in the symbol display area 141d forms a symbol matrix.

### <<<<Specific Overview of Gaming Machine in Present Embodiment>>>>

An overview of a gaming machine 1 in the present embodiment is as follows. Details are described later.

The gaming machine 1 has five mech reels M3a, M3b, M3c, M3d, and M3e. The five mech reels are rotatably mounted on a lower display unit 141. On each of the five mech reels M3a to M3e, a plurality of symbols are disposed. The plurality of symbols disposed on the five mech reels M3a to M3e are displayed in a symbol display area 141d of the lower display unit 141. A plurality of symbols are disposed along a longitudinal direction of each of the five mech reels M3a to M3e. The plurality of substantial symbols disposed on each of the five mech reels M3a to M3e are displayed in the symbol display area 141d. The plurality of symbols disposed on a mech reel constitute one reel strip (one symbol array). Five mech reels M3a to M3e provide five reel strips (five symbol arrays). In the present embodiment, reel strip means symbol array; five reel strips or some of the five reel strips are generally referred to as reel strips. The mech reels M3a to M3e are spun and stopped on the display to form scroll lines of the symbol arrays.

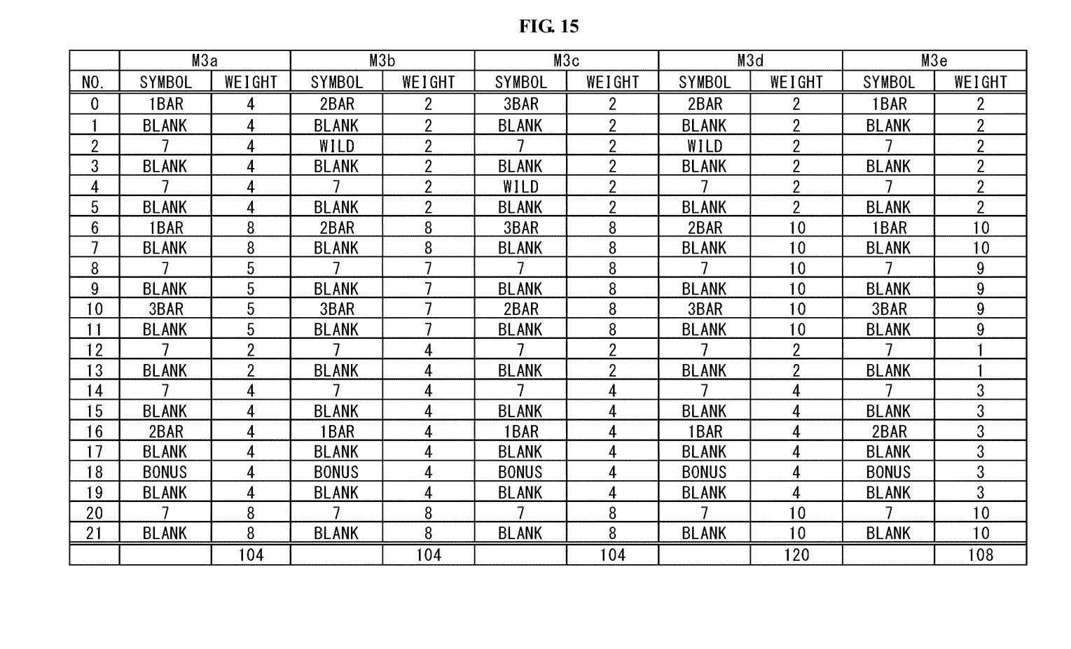

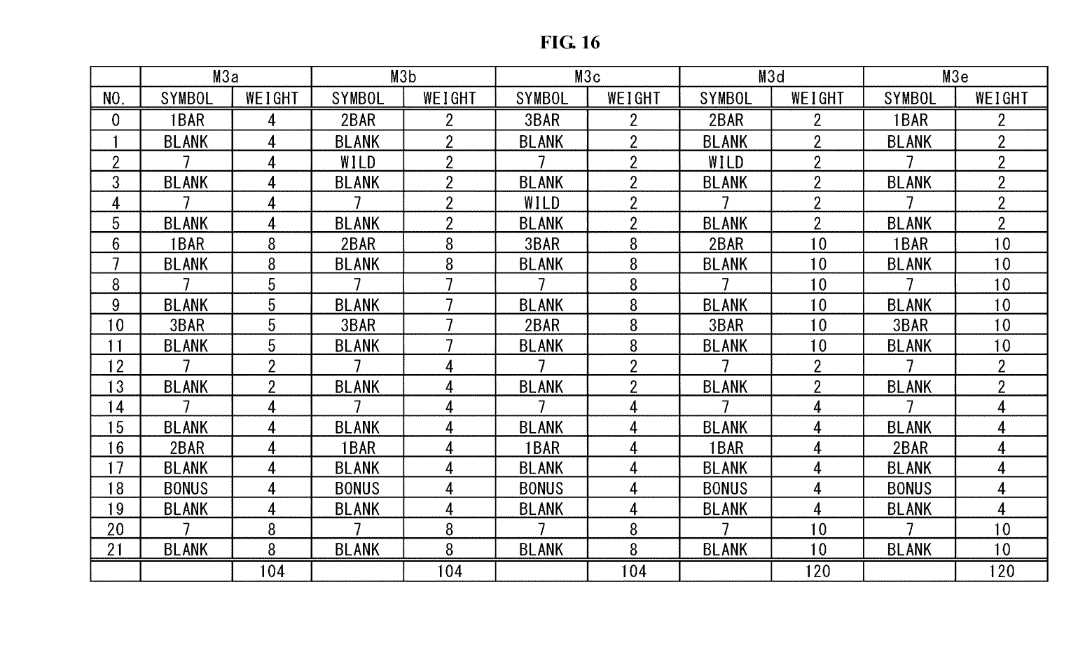

The present embodiment provides two game modes of base game mode and free game mode. The five reel strips to be used are common to these two game modes. As will be described later, the base game mode and the free game mode are provided with different weights for symbol lottery processing. FIG. 15 shows the five reel strips to be used in the base game mode and the weights of the symbols. FIG. 16 shows the five reel strips to be used in the free game mode and the weights of the symbols.

Thirty paylines are formed in the symbol display area 141d of the gaming machine 1. The thirty paylines do not depend on the bet count and are fixed.

The gaming machine 1 in the present embodiment has the following kinds of symbols: WILD (wild symbol), RED7, BLUE7, GREEN7, WHITE7, 3BAR, 2BAR, 1BAR, BONUS (trigger symbol), and BLANK.

The WILD is a symbol to be replaced with another kind of symbol in identifying a winning pattern completed along a payline. To make an advantageous winning pattern, a WILD is replaced with another kind of symbol in identifying a winning pattern. In the present embodiment, WILDs are provided on only three mech reels M3b, M3d, and M3d (see FIGS. 15 and 16).

The BONUS is a scatter symbol. Independently from the paylines, when a predetermined number, for example three, of BONUSes are determined to appear in the symbol display area 141d in symbol lottery processing, a winning pattern is completed. For example, when two BONUSes on the mech reel M3a and one BONUS on the mech reel M3d are determined to appear in the symbol display area 141d, a winning pattern is completed.

Completion of a winning pattern of BONUSes triggers a free game mode. Winning patterns of BONUSes are completed in both of the base game mode and the free game mode. The completion of a winning pattern of BONUSes in a free game mode retriggers the free game mode.

In the gaming machine 1 in the present embodiment, a specific kind of symbols, for example 7s, are disposed on the five mech reels M3a to M3e without being colored. That is to say, the outlines of the figures of 7s are drawn on the mech reels M3a to M3e. As will be described later, each of the five mech reels M3a to M3e is provided with a backlight M7 behind thereof. The backlight M7 includes four kinds of LEDs of red LEDs, blue LEDs, green LEDs, and white LEDs. The backlight M7 emits one of red, blue, green, and white light by lighting one of the four kinds of LEDs to illuminate each of the mech reels M3a to M3e.

When a symbol 7 is illuminated with red light, the gaming machine 1 in the present embodiment regards the symbol 7 as RED7 to identify a winning pattern. Likewise, when the symbol 7 is illuminated with blue light, the gaming machine 1 in the present embodiment regards the symbol 7 as BLUE7 to identify a winning pattern; when the symbol 7 is illuminated with green light, the gaming machine 1 in the present embodiment regards the symbol 7 as GREEN7 to identify a winning pattern; and when the symbol 7 is illuminated with white light, the gaming machine 1 in the present embodiment regards the symbol 7 as WHITE7 to identify a winning pattern.

The outline of determining the color to illuminate a 7 is as follows. The details of the method of determining the color will be described later (see FIGS. 25 and 26). First, a color table is determined with reference to color table determination table (FIGS. 27A and 27B). Next, the symbols to appear in the symbol display area 141d are determined through symbol lottery processing. For all of the 7s to appear in the symbol display area 141d, emission color is determined with reference to one of the color tables (FIGS. 28A to 28I).

### <Free Game Mode>

When the condition is satisfied that a winning pattern of BONUSes be completed in a unit game conducted in a base game mode, a free game mode is triggered. When the condition is satisfied that a winning pattern of BONUSes be completed in a unit game conducted in a free game mode, the free game mode is retriggered.

As mentioned above, the BONUSes are scatter symbols. Accordingly, when a predetermined number or more, for example three or more, of BONUSes are determined to appear in the symbol display area 141d through symbol lottery processing, a winning pattern is completed, so that a free game mode is triggered or retriggered.

When a free game mode is triggered, the game mode changes to a free game mode. There are a case where the game mode changes from a base game mode to a free game mode and a case where a free game mode is maintained (the free game mode is retriggered to continue the free game mode).

In entering a free game mode, a roulette game is conducted to determine the number of unit games to be conducted in the free game mode based on the result of the roulette game. The player can enjoy as many unit games as determined in the chance game mode.

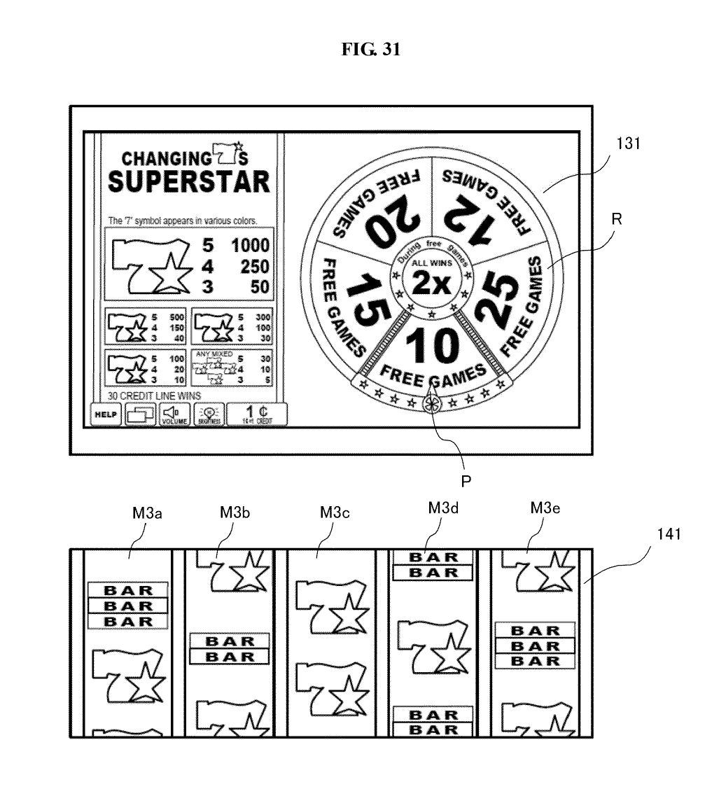

The roulette game is conducted in the upper display unit 131. A disc-like roulette board is displayed on the upper liquid crystal display panel 131b of the upper display unit 131 (see FIG. 31). The upper display unit 131 also includes an upper touch panel 131a, which is stacked on the upper liquid crystal display panel 131b. When the player touches and turns the roulette board on the upper display unit 131 with a finger, the upper touch panel 131a detects the motion of the player's finger and spins the roulette board. On the display, the roulette board first spins fast, gradually slows down the spinning speed, and eventually stops. There is an image of an arrow on the bottom of the roulette board; the number indicated in the section pointed by the arrow when the roulette board has stopped is determined to be the maximum number of unit games in the free game mode.

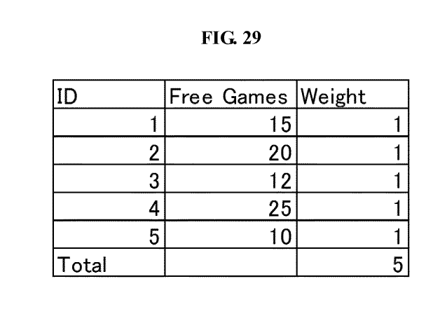

The roulette game selects the maximum number of unit games in the free game mode from five numbers of 10, 12, 15, 20, and 25. The maximum number of unit games is selected from these five numbers by lottery at an equal probability (see FIG. 29). In the roulette game, the maximum number of unit games selected by lottery is indicated in the section pointed by the arrow when the roulette board is finally stopped.

In a free game mode, a winning pattern of BONUSes may be completed, so that the free game mode is retriggered. When the free game mode is retriggered, another roulette game can be conducted. The number of unit games determined in this roulette game is added to the maximum number of unit games in the free game mode.

In the free game mode, the weights for symbol lottery processing are different from those in the base game mode (see FIGS. 15 and 16). Furthermore, the weights for color table lottery processing are also different from those in the base game mode (see FIGS. 27A and 27B).

In the free game mode, the multiplier for a payout is 2; each payout is multiplied by 2 to determine the amount of payout.

When the condition is satisfied that the number of unit games conducted in the free game mode reach the maximum number, the free game mode is terminated and the game mode returns to the base game mode.

### <<<Overall Configuration of Slot Machine 10>>>

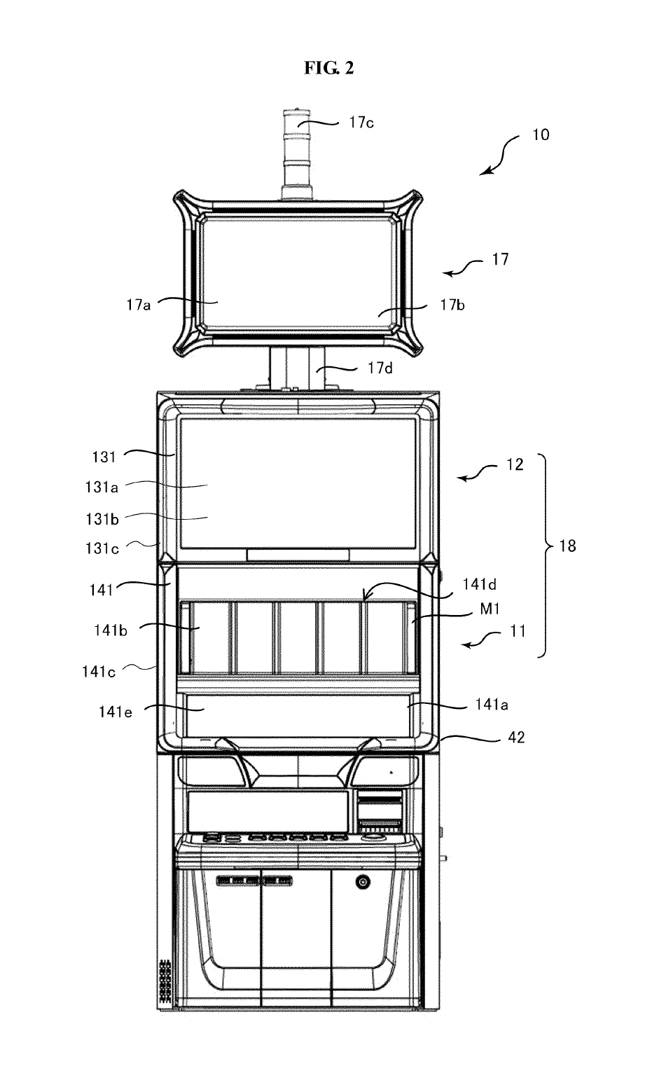

As illustrated in FIGS. 2 and 3, a slot machine 10 as a gaming machine includes a topper unit 17 and a gaming machine main body 18. On the top face of the gaming machine main body 18, the topper unit 17 is mounted. The gaming machine main body 18 includes a top unit 12 and a main unit 11. The top unit 12 includes an upper display unit 131. The top unit 12 is mounted on the top face of the main unit 11. The main unit 11 includes a lower display unit 141.

The topper unit 17 has a function to draw attention to the slot machine 10 from distant places and a function to advertise the games of the slot machine 10 to distant places. The top unit 12 has a function to display the specifics of the games, a payout table, and game-related information such as rules. The main unit 11 has a function to perform the games.

In the present embodiment, the region (direction) of the slot machine 10 facing (toward) the player is referred to as front (forward), the opposite region (direction) to the front (forward) is referred to as back (backward or depth direction), the right and the left as seen from the player are respectively referred to as right (rightward) and left (leftward) of the slot machine 10. The extent between the front and the back is referred to as front-to-back, thickness, or depth; the extent between the right and the left are referred to as left-to-right or width. The extent orthogonal to the front-to-back (thickness or depth) and the left-to-right (width) are referred to as top-to-bottom or height.

### <Outline of Topper Unit 17>

The topper unit 17 is provided on the top face of the top unit 12 to be located at the highest position of the slot machine 10. The topper unit 17 has a rotary shaft standing in the direction of the height of the slot machine 10 and is rotatable within a predetermined angle in a right direction (clockwise direction) and a reverse direction (counterclockwise direction) about this rotary shaft. This structure enables the topper unit 17 to switch its position between the front position (FIG. 2) where the screen 17a for displaying information on the games faces forward and an oblique position (FIG. 3) where the screen 17a faces obliquely forward.

The front position is selected in a normal state when games are being played or the slot machine 10 is standing by to show information on the game to people (players or game hall staff) distant from the slot machine 10. The oblique position is a special position to be selected to change the indication of the topper unit 17. As shown in FIG. 3, by turning the topper unit 17 so that the right end of the topper unit 17 will come forward, the oblique position allows the operation to change the indication of the topper unit 17 from the front of the slot machine 10.

### <Specific Configuration of Topper Unit 17>

As shown in FIGS. 2 and 3, the topper unit 17 includes a topper body 17b including a screen 17a and a tower member 17c provided on the top face of the topper body 17b. The tower member 17c has a cylindrical clear resin cover and has a light emission device like an LED therein. The tower member 17c shines at the top of the slot machine 10 in a single color or multiple colors to easily inform distant people of the place or the state of the slot machine 10.

The topper unit 17 has a topper support device 17d as shown in FIGS. 2 and 3. The topper support device 17d supports the topper body 17b to be horizontally rotatable within a specific angle with respect to the top unit 12.

### <Top Unit 12>

The topper unit 17 structured as described above is provided on the top of the top unit 12 as shown in FIGS. 2 and 3. The top unit 12 includes an upper display unit 131 provided on the front of the top unit 12. On the top face of the top unit 12, the topper body 17b is supported by the topper support device 17d to be horizontally rotatable within a specific angle with respect to the top unit 12.

### <Upper Display Unit 131>

The upper display unit 131 includes an upper touch panel 131a provided on the front, an upper liquid crystal display panel 131b provided behind the upper touch panel 131a, and an upper control board base 131c.

The upper liquid crystal display panel 131b displays motion picture such as a video and image data of still pictures such as characters and figures. The upper touch panel 131a transmits the images shown on the upper liquid crystal display panel 131b for the player to see the images and enables touch operations on the screen with the player's fingertip. The upper control board base 131c includes not-shown control boards for controlling the display of the upper liquid crystal display panel 131b inside thereof.

### <Main Unit 11>

The top unit 12 structured as described above is provided on the top of the main unit 11. The main unit 11 includes a lower display unit 141, an upper door unit 42, and a lower door unit 43 provided under the lower display unit 141 and on the front of the main unit 11. The upper door unit 42 and the lower door unit 43 are openable with respect to a gaming mechanism unit 41. The upper door unit 42 is structured to be allowed to open only when the lower door unit 43 is open.

### <Lower Display Unit 141>

The lower display unit 141 includes a lower touch panel 141a provided on the front, a lower liquid crystal display panel 141b provided behind the lower touch panel 141a, a lower control board base 141c, and a reel unit M1.

The lower liquid crystal display panel 141b shows motion picture such as a video and image data of still pictures such as characters and figures. The lower touch panel 141a transmits the images shown on the upper liquid crystal display panel 141b for the player to see the images and enables touch operations on the screen with the player's fingertip. The lower control board base 141c includes not-shown control boards for controlling the lower touch panel 141a inside thereof.

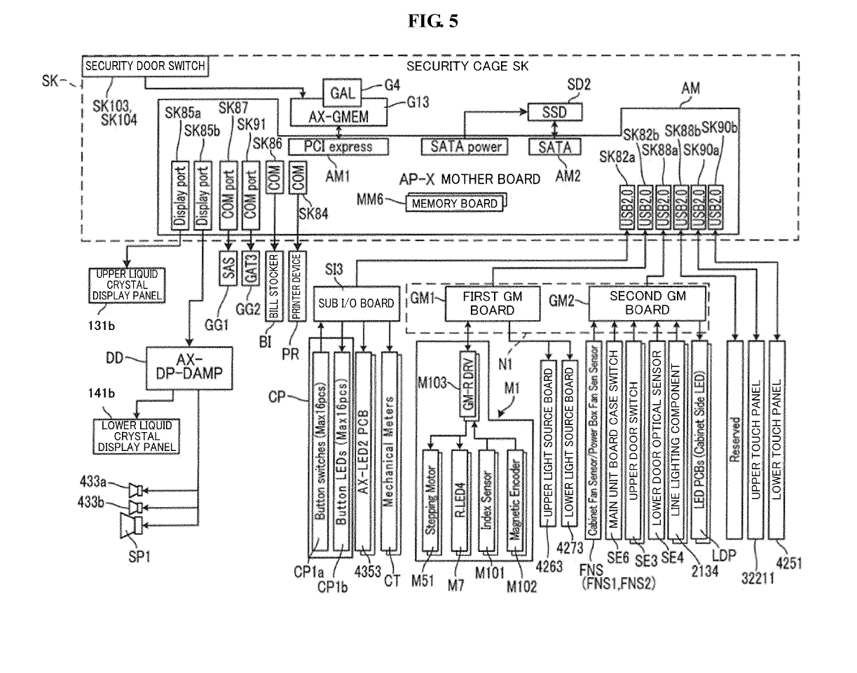

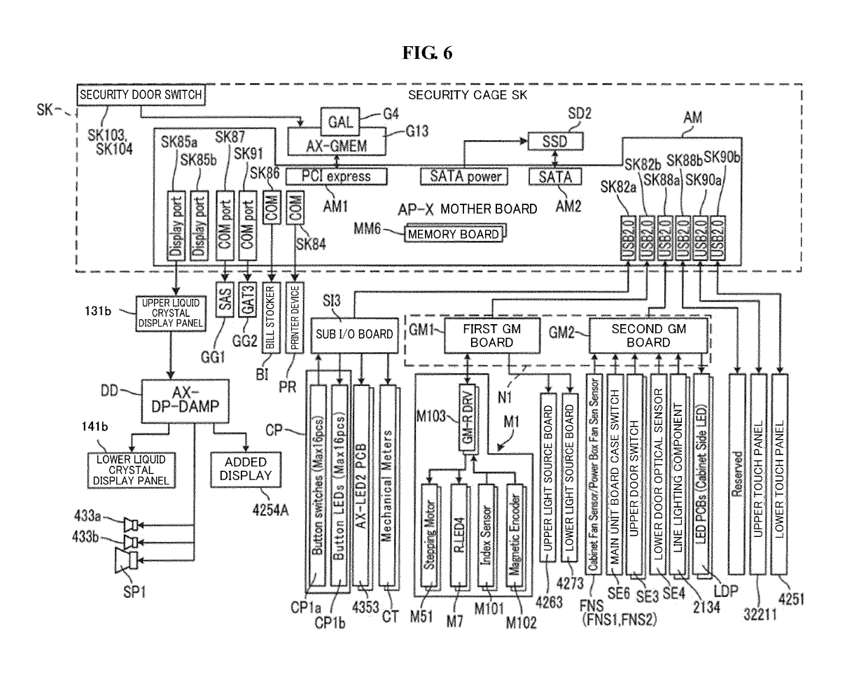

The reel unit M1 includes five rotatable mech reels M3a to M3e. The reel unit M1 further includes stepping motors M51 for spinning and stopping the five mech reels M3a to M3e (see FIGS. 5 and 6). On the outer surface of each of the five mech reels M3a to M3e, a plurality of symbols are disposed in a single line along the longitudinal direction. Each of the five mech reels M3a to M3e can change its spin speed and spin direction with a stepping motor M51.

The reel unit M1 spins and then stops the five mech reels M3a to M3e with the stepping motors M51. These operations make symbols disposed on the five mech reels M3a to M3e to be moved and stopped in the symbol display area 141d. Stopping symbols in the symbol display area 141d rearranges symbols in the symbol display area 141d.

In the present embodiment, three rows of a top row, a middle row, and a bottom row are defined as stop positions in the symbol display area 141d for the symbols on the mech reels M3a to M3e. Accordingly, when the five mech reels M3a to M3e (five reel strips) are stopped, 5 by 3 (5 columns by 3 rows) of 15 symbols in total appear (are stopped) in the symbol display area 141d. The five mech reels M3a to M3e start spinning (being shuffled) upon start of a unit game. After a predetermined time, the five mech reels M3a to M3e stop. As a result, 15 symbols appear (are stopped) in the symbol display area 141d and the symbols are rearranged. That is to say, each time a unit game is conducted, symbols are rearranged in the symbol display area 141d to show a result of the unit game. In the present embodiment, the 5 by 3 (5 columns by 3 rows) of 15 symbols rearranged in the symbol display area 141d form a symbol matrix.

The speeds and the directions in the shuffling of the five mech reels M3a to M3e can be determined individually depending on the game mode and the unit game.

The symbol display area 141d has symmetric payline generation columns on the left end and the right end thereof. The payline generation column on the left end provided on the left as seen from the player has 30 payline generators. The payline generation column on the right end provided on the right as seen from the player has 30 payline generators.

Each payline generator on the left end is paired with one of the payline generators on the right end and a payline starting from the payline generator on the left end to the paired payline generator on the right end is predefined. Thirty paylines are defined in the present embodiment.

In the present embodiment, the 30 paylines are always enabled. The number of paylines to be enabled may be determined based on the amount of bet. In the case of MAX BET or the maximum amount of bet, the full 30 paylines are enabled. The enabled paylines generate winning patterns of each kind of symbols. The details of the winning patterns are described later.

Although the present embodiment describes a slot machine 10 that displays symbols with the mech reels M3a to M3e, the slot machine 10 may display symbols by using a video reel system and a mech reel system together.

The lower display unit 141 has a game status indication area 141e under the symbol display area 141d. The game status indication area 141e indicates a variety of information on games such as a status of credits and details of bet.

### <Control Panel CP>

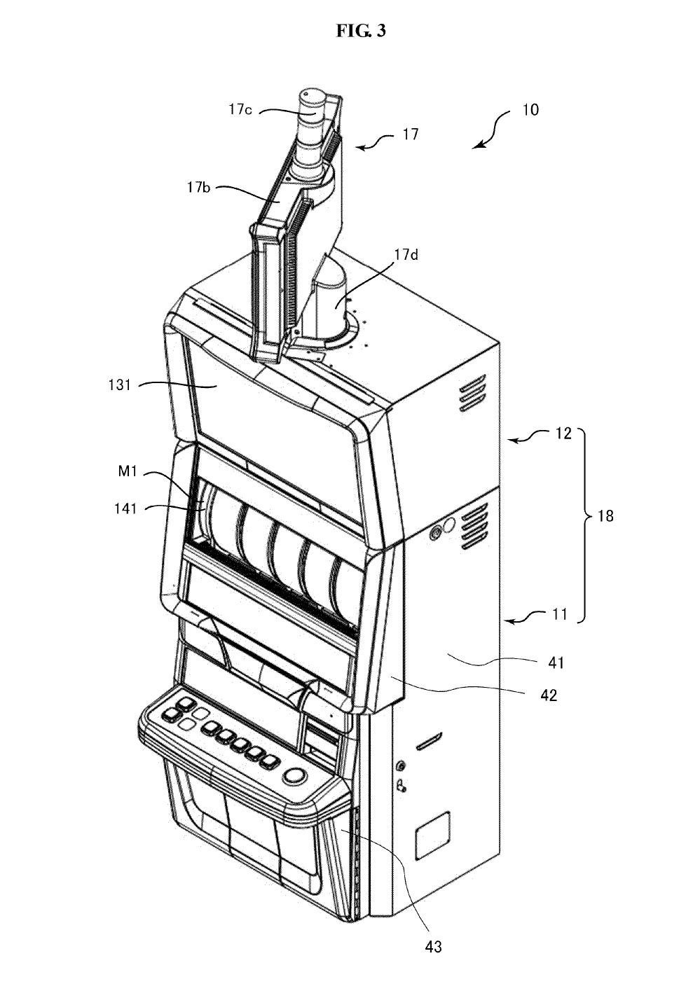

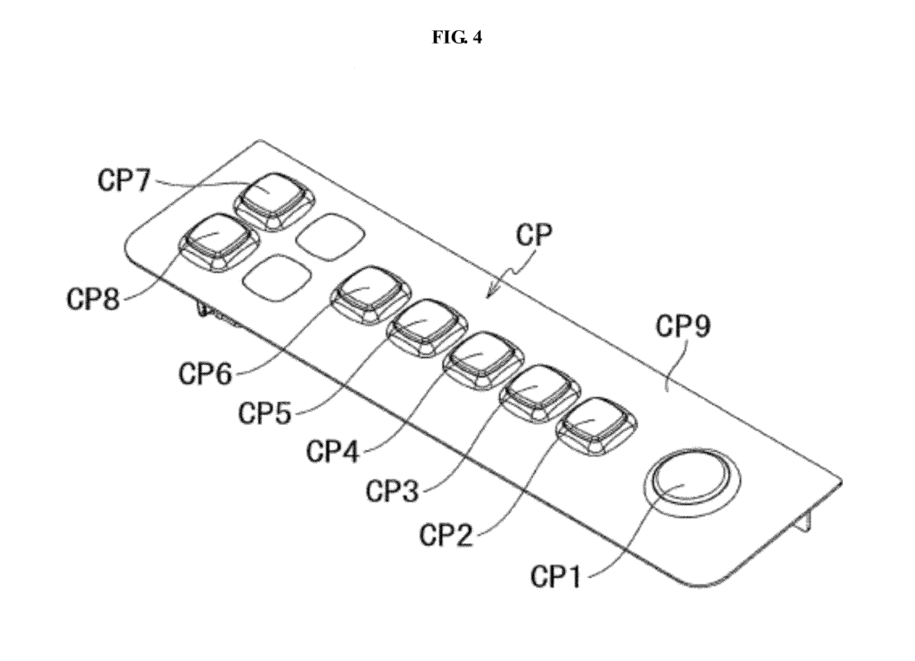

The slot machine 10 has a control panel CP. As shown in FIG. 4, the control panel CP includes a planar base plate CP9 and a plurality of operation buttons CP1 to CP8 provided on the base plate CP9. The operation button CP1 has a circular shape that is larger than the other buttons CP2 to CP8 so that the player can easily press it and easily distinguish it from the other buttons. The operation button CP1 is disposed on the rightmost area of the base plate CP9 and functions as a start button or spin button to start a game in response to a press operation.

The operation buttons CP2, CP3, CP4, CP5, and CP6 are disposed in a line at equal intervals on the left of the operation button CP1. These operation buttons CP2 to CP6 have square shapes. The rightmost operation button CP2 functions as a MAX BET button for a game to bet maximally, for example ten units of gaming value, in response to a press operation. The operation button CP3 functions as a 5BET button for a game to bet five units of gaming value in response to a press operation. The operation button CP4 functions as a 3BET button for a game to bet three units of gaming value in response to a press operation. The operation button CP5 functions as a 2BET button for a game to bet two units of gaming value in response to a press operation. The operation button CP6 functions as a 1BET button for a game to bet one unit of gaming value in response to a press operation.

The operation buttons CP7 and CP8 are disposed at the front and the back on the leftmost area of the base plate CP9. The operation button CP7 functions as a HELP button to indicate help information such as how to play games in the game status indication area 141e in response to a press operation. The operation button CP8 functions as a cashout button to return the credit by way of coins and printed information in response to a press operation.

### <Overall Configuration of Game System>

A game system 600 including slot machines 10 having the above-described functions is described.

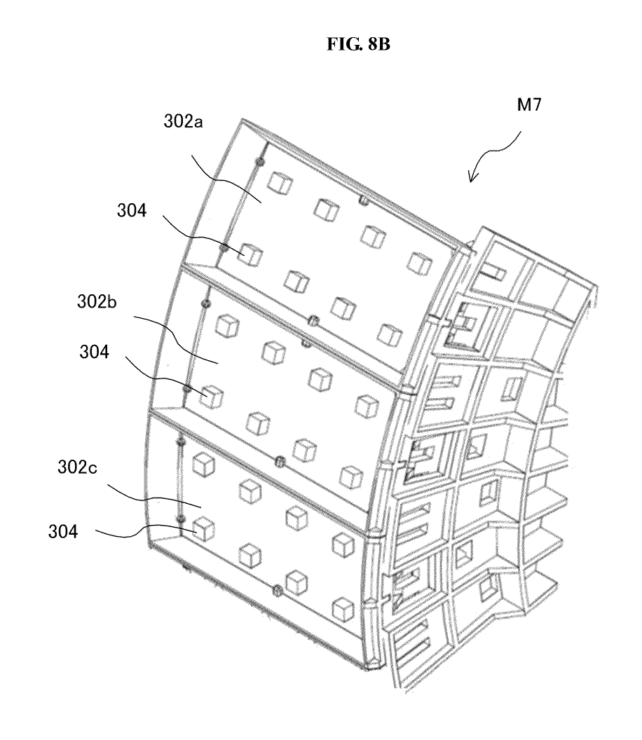

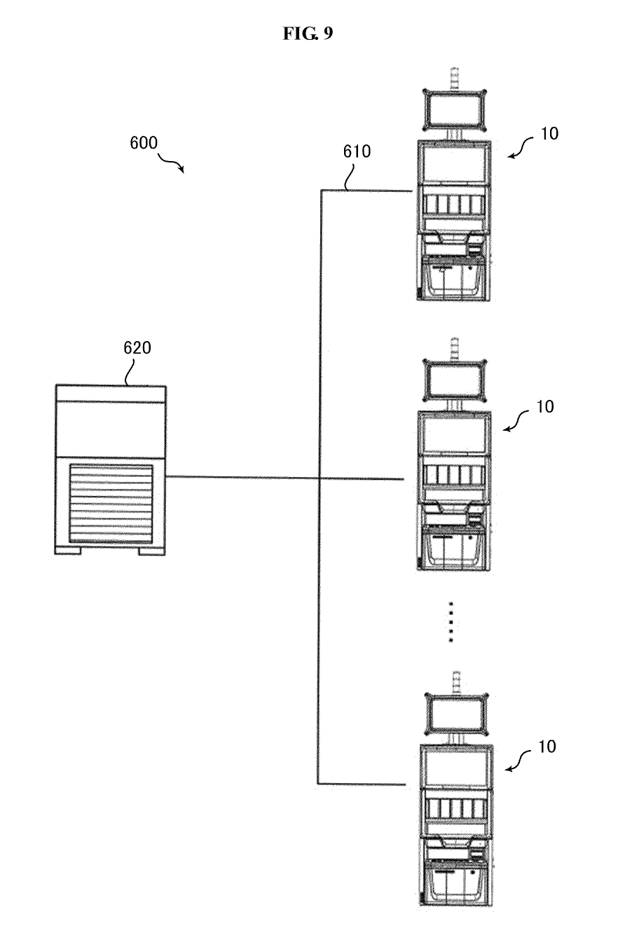

As illustrated in FIG. 9, a game system 600 includes a plurality of slot machines 10 and an external control device 620 connected with the slot machines 10 through a communication line 610.

The external control device 620 is to control the plurality of slot machines 10. In the present embodiment, the external control device 620 is a so-called hall server installed in a game hall having the plurality of slot machines 10. Each of the slot machines 10 is assigned a unique identification number; the external control device 620 identifies a slot machine 10 that sends data to the external control device 620 with the identification number. Furthermore, the external control device 620 uses the identification numbers to designate a destination in sending data to a slot machine 10.

The game system 600 may be constructed within a single game hall where various games can be conducted, such as a casino, or may be constructed among a plurality of game halls. In the case where the game system 600 is constructed in a single game hall, the game system 600 may be constructed on each floor or in each section of the game hall. The communication line 610 may be wired or wireless, and can adopt a dedicated line, an exchange line or the like.

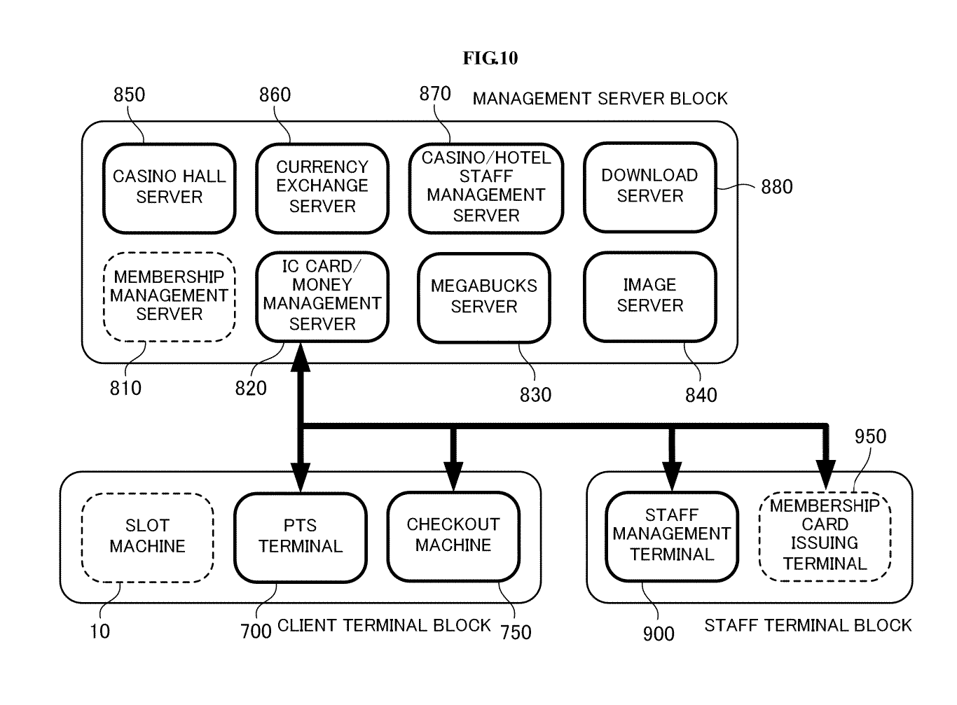

As illustrated in FIG. 10, the game system is generally grouped into the following three blocks: a management server block, a client terminal block, and a staff terminal block. The management server block includes a casino hall server 850, a currency exchange server 860, a casino/hotel staff management server 870 and a download server 880.

The casino hall server 850 is a server for managing the entire casino hall where the slot machines 10 are installed. The currency exchange server 860 is a server for generating exchange rate data based on currency exchange information. The casino/hotel staff management server 870 is a server for managing the staff working in the casino hall and/or a hotel related to the casino hall. The download server 880 is a server for downloading latest information such as information on the games and news and for notifying the players of the information through the PTS terminals 700 of the slot machines 10.

The management server block further include a member management server 810, an IC card/money management server 820, a megabucks server 830, and an image server 840.

The member management server 810 is a server for managing membership information on the players of the slot machines 10. The IC card/money management server 820 is a server for managing IC cards to be used in the slot machines 10. Specifically, the IC card/money management server 820 stores data on fractional amount of cash in association with an identification code and outputs the data on fractional amount of cash to a PTS terminal 700. The IC card/money management server 820 further generates and manages denomination rate data. The megabucks server 830 is a server for managing a megabucks, which is a kind of game that provides the total amount of bet of a plurality of slot machines 10 installed in a plurality of casino halls for an award. The image server 840 is a server for downloading latest images about the game and news and for notifying the players of the images through the PTS terminals 700 of the slot machines 10.

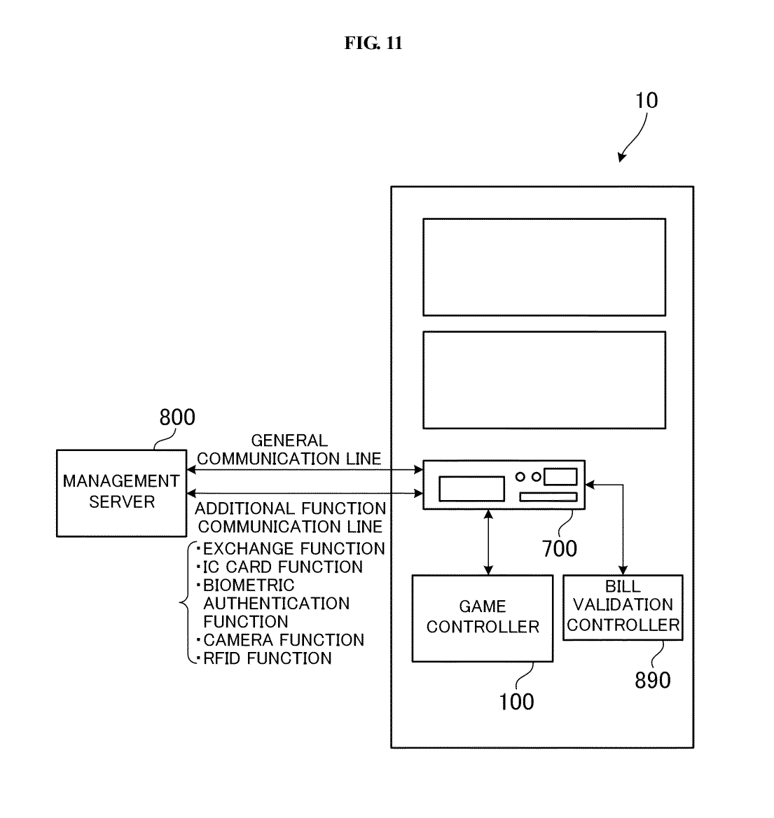

A client terminal block includes slot machines 10, PTS terminals 700, and a checkout machine 750. The PTS terminals 700 are attachable to the slot machines 10 and can interactively communicate with the management server 800 (see FIG. 11). The checkout machine 750 is a machine for a player to checkout by converting the money data stored in the player's IC card into cash or to store money data indicating the amount of coins or a bill in the IC card.

A staff terminal block includes a staff management terminal 900 and a membership card issuing terminal 950. The staff management terminal 900 is a terminal for the staff of the casino hall to manage the slot machines 10. Particularly in the present embodiment, the staff of the casino hall manages whether the PTS terminals 700 hold too many IC cards or are in short of IC cards. The membership card issuing terminal 950 is a terminal to be used to issue a membership card for a game player in the casino hall.

### <PTS Terminal 700>

The PTS terminals 700 are included in a PTS system as illustrated in FIG. 11. A PTS terminal 700 attached to a slot machine 10 is connected with the game controller 100 and the bill validation controller 890 of the slot machine 10 to be able to communicate with each other.

The PTS terminal 700 coordinates game effects of sound and images and updates credit data through communications with the game controller 100. The PTS terminal 700 sends credit data required for checkout through communications with the bill validation controller 890.

The PTS terminal 700 is also connected with the management server 800 to be able to communicate with each other. The PTS terminal 700 communicates with the management server 800 using two communication lines: a general communication line and an additional function communication line.

The PTS terminal 700 uses the general communication line to communicate data such as money data, identification code data, and player's membership information. The PTS terminal 700 uses the additional function communication line for communications related to newly added functions. The PTS terminal 700 in the present embodiment uses the additional function communication line for communications related to the exchange function, the IC card function, the biometric authentication function, the camera function, and the RFID (radio frequency identification) function, which is a function for identifying objects using radio wave.

### <Electrical Configuration of Slot Machine 10>

Next, the electrical configuration of the slot machine 10 is described. As illustrated in FIG. 5, the slot machine 10 employs a CPU having GPU (Graphics Processing Unit) functionality to eliminate a graphic board, which prevents unauthorized tampering through PCI Express and achieves lower power consumption and lower heating. In other words, the slot machine 10 is a gaming machine employing a CPU with integrated GPU and is configured with a motherboard including the CPU with an integrated GPU (on a single die), a PCI Express expansion slot AM1 connected with a GAL board G4 holding an authentication program, and DisplayPort connectors SK85 connected with the GPU.

This configuration eliminates a graphic board from being connected with the PCI Express expansion slot AM1; the slot machine 10 can use the expansion slot AM1 as a dedicated terminal for authentication. The distinct looks of the dedicated connection enables the security monitoring to be easier. Furthermore, the slot machine 10 can eliminate the possible problems caused by connecting a graphic board to the PCI Express expansion slot AM1, such as unsmoothness in outputting video signals or audio signals because of an interruption to or from another board and a collision of interruptions because of the relation with another board. In addition, the slot machine 10 can use the DisplayPort connectors SK85 as dedicated terminals for video (audio) to prevent interferences with other boards. As a result, video (audio) signals can be output smoothly to be synchronized accurately with the game process.

The slot machine 10 is equipped with a motherboard having a CPU with a built-in graphics engine for implementing the GPU functionality, which lowers the possibility that a video is suspended during a game. Using the motherboard having a CPU with a built-in graphics engine, the slot machine 10 outputs video data for video effects from the graphics engine controlled by the CPU to a sub board and outputs audio signal to a sub board from the CPU. In this configuration, video data and audio data is output from the motherboard in accordance with the control of a single CPU with a built-in graphics engine; accordingly, unless the CPU malfunctions, the slot machine 10 can prevent an accident of outputting only one of the video and audio to a sub board and making the effects unclear.

The slot machine 10 may be configured to perform the followings: connecting a security board (GAL board G4) having a flash RAM holding different sizes of startup-related data such as a boot BIOS and a public key to be used to start up the slot machine 10 to the motherboard via PCI Express, detecting the size of startup-related data, transferring the startup-related data to the DRAM on the motherboard at a transfer rate suitable for the data size, and executing startup processing based on the startup-related data with the DRAM. PCI Express allows software to dynamically change transfer rate; accordingly, this configuration enables power saving when the highest speed is not necessary. Even if update of the data of the boot BIOS significantly changes the data size on the security board, the slot machine 10 can automatically set an optimum time to start up and an optimum power to be consumed.

The slot machine 10 may further be configured to detect a rise in temperature of the security board caused by transferring data and to control the transfer rate of the startup-related data based on the rise in temperature in the foregoing operations of connecting a security board having a flash RAM holding different sizes of startup-related data such as a boot BIOS and a public key to be used to start up the slot machine 10 to the motherboard via PCI Express, transferring the startup-related data to the DRAM on the motherboard, and performing startup processing based on the startup-related data with the DRAM. The rise in temperature of the security board is supposed to be proportional to the power consumption; accordingly, controlling the transfer rate so as to keep the temperature constant enables startup processing to be performed at a transfer rate with stable power consumption.

The slot machine 10 is a gaming machine that uses an SSD (SSD board SD2) holding an OS (Operating System); the slot machine 10 is equipped with an AP-X motherboard AM including a CPU and a SATA terminal (SATA board-to-board connector AM2) and an SSD connected with the SATA terminal. By connecting to the SSD via the SATA terminal and booting the OS from the SSD, the slot machine 10 eliminates the problems caused by booting the OS from a flash memory like an SD card, for example, problems that a conversion adapter is required, that the operation frequently becomes unstable, and that the SD card is expensive. When booting the OS from a flash memory like an SD card, the flash memory needs to be recognized at the BIOS level, which does not allow some motherboards to boot the OS. However, when an SSD is used to boot the OS, the OS can be booted properly and speedily; the versatility is enhanced and programs for the gaming machine can be start up instantly.

The slot machine 10 is capable of triple display output with the motherboard having two DisplayPort terminals and a DVI output. This configuration enables high speed and large screen display and eliminates the license cost, compared to using HDMI. The slot machine 10 further includes a DP D-AMP board DD (DisplayPort audio amplifier board) for retrieving an audio signal from DisplayPort, and amplifying and outputting the audio signal.

The slot machine 10 outputs video data and audio data during games using DisplayPort by packets to produce video and audio effects with the devices for implementing the effects. Since the video data and the audio data are output to a DisplayPort signal line, the slot machine 10 can eliminate losing either one of the video data and the audio data. As a result, the slot machine 10 does not fail in sufficiently informing the player of a lottery result because of outputting only one of the video and the audio indicating a lottery result. Furthermore, this configuration allows a plurality of displays to be connected in series; accordingly, adding a display can be made easily, which facilitates design change based on the existing slot machine 10. For example, in adding a display device to the top unit 12 in addition to the upper liquid crystal display panel 131b and the lower liquid crystal display panel 141b, only connecting a signal line from the upper liquid crystal display panel 131b to the display device of the top unit 12 completes the mechanical signal line connection; in addition, easy maintenance of the display device can be attained. In the meanwhile, data transmission by packets does not require data transmission to the plurality of display devices one by one; programs can be modified easily.

The specific electrical configuration of the slot machine 10 is described. The slot machine 10 has an AP-X motherboard AM enclosed in a security cage SK. The AP-X motherboard AM includes a not-shown 4th Generation Intel® Core™ processor, so that the power management function (C state) in idling is improved. Further, a VR (voltage regulator) is integrated within the package/die of the processor to simplify the power design in the entire platform, so that low power consumption is achieved inclusive of the motherboard. The 4th Generation Intel® Core™ processor has 20 EUs (Execution Units) as graphics execution units in a GPU core. Accordingly, compared to the 3rd Generation Intel® Core™ processor, significant performance improvement has been achieved. The 4th Generation core i-series chipset has multiple ports for SATA 6 Gb/s (SATA 3.0) of a high-speed interface and supports PCI Express 3.0 for smooth data transfer to a high-performance video card and DDR3-1600 of a high-speed memory specification.

The AP-X motherboard AM has a PCI Express expansion slot AM1, a SATA board-to-board connector AM2, a first and a second DisplayPort connectors SK85a and SK85b, a first and a second LAN jacks SK87 and SK91, a first and a second D-sub connectors SK86 and SK84, a first to a sixth USB connectors SK82a, SK82b, SK88a, SK88b, SK90a, and SK90b.

PCI (Peripheral Component Interconnect) Express is a serial transfer interface for computers that supersedes PCI. PCI Express is not physically compatible with PCI employing parallel transfer; however, PCI Express uses the same communication protocol as PCI. The smallest unit of transmission channel (called lane) used in PCI Express is capable of full duplex communications at 2.5 Gbps in simplex and at 5.0 Gbps in duplex. The effective data transfer rate is 2.0 Gbps (250 MB/s) in simplex and 4.0 Gbps (500 MB/s) in duplex because transmitting 8-bit data requires 10 bits in which 2 bits of a clock signal and other data are added. The expansion slot AM1 of the AP-X motherboard AM is a PCI Express port containing multiple lanes.

SATA (Serial AT Attachment) is an expansion of IDE (ATA) standard for connecting a computer with a storage device such as a hard disk drive or an optical drive. SATA has been developed by changing the parallel transfer employed in the ATA specifications into serial transfer, achieving high transfer rate with a simple cable.

DisplayPort is a full digital video interface and employs micro packet system utilizing embedded clocks. The micro packet system can transfer secondary digital audio data in addition to the primary video data; the system encapsulates pixel data and audio signal in a packet called micro packet. That is to say, the micro packet system divides all the video and audio into micro packets called Transfer Units and serially transfers the Transfer Units to the destination devices.

DisplayPort generates a clock from data without using an external clock signal; accordingly, speedy data transfer and feature expansion is easily available. Furthermore, since DisplayPort is a video output interface designed for digital display devices, using a liquid crystal display as a display device reduces the number of components and attains a transmission distance of approximately 15 meters.

DisplayPort defines the output side as source device and the input side as sink device. The source device and the sink device communicate with each other to automatically optimize the resolution, color depth, refresh rate, and the like. Transmission rate of video and audio data can be changed using the combinations of one, two, and four channels called lanes and two data rates of 1.62 Gbps and 2.7 Gbps. For example, the lowest rate is obtained in the configuration of one lane at 1.62 Gbps and the highest rate is 10.8 Gbps obtained in the configuration of four lanes at 2.7 Gbps. The main data channel in DisplayPort can be configured with one, two, or four high-speed SerDes lanes and the bandwidth of 2.7 Gbps or 1.62 Gbps for each lane.

DisplayPort includes an HPD (Hot Plug Detect) signal. Hot Plug Detect is used not only to check whether a display device is connected but also to establish a link. Hot Plug Detect includes a process to inform the sender of establishing a link through a process called link training; during this process, both of the sender and the receiver check whether all the four lanes are necessary. DisplayPort further has an AUX (auxiliary) channel. The AUX channel is a low-speed “side channel” and is a communication channel for managing the link in accordance with the sender's information and controlling the status and configuration. The AUX channel enables bidirectional video and audio communications.

DisplayPort does not have limitation in using multiple screens or display devices from a single digital output port or in display application and brings out the full performance of the displays with zero latency. DisplayPort is featured by Plug and Play; the user does not need to reconfigure the system manually. For example, to add a display device without using DisplayPort, a graphics card or a multi-head graphics card having a plurality of output ports needs to be added. These cards increase the power consumption and the adding the card requires complex work. Using DisplayPort eliminates these problems. As a result, DisplayPort enables addition of a display device without opening the highly confidential security cage SK of the slot machine 10.

DisplayPort can simultaneously transmit a plurality of types of data such as audio, video stream, and the like by employing the micro packet system; accordingly, a plurality of video and audio packets can be transmitted on the same cable. As a result, DisplayPort achieves utilization of picture-in-picture or a plurality of daisy-chained display devices at a link speed as fast as the hub connection with a single connection.

The daisy chain connection is a connection topology in which, among display devices having an input port and an output port of DisplayPort, the output port of the source is connected to the input port of the next display device (sink) on a single link, and regarding the sink display device as a next source, the output port of the display device is connected to the input port of the next display device (sink). In contrast, the hub connection is a connection topology in which one input port is provided with a plurality of output ports and these output ports are connected to the input ports of a plurality of display devices.

The expansion slot AM1 is connected with the AX-GMEM board G13 to be able to transmit data unidirectionally. The AX-GMEM board G13 is connected with a GAL board G4 to be able to transmit data bidirectionally to perform self-authentication of the boot BIOS with the GAL board G4. The details of the boot BIOS self-authentication are described later. The AX-GMEM board G13 is also connected with a first detection sensor SK103 and a second detection sensor SK104 for functioning as security door switches; the open/closure of the security cage door SK3 is monitored based on the detection signals from these detection sensors SK103 and SK104.

The SATA board-to-board connector AM2 is connected with an SSD board SD2 to be able to transmit data bidirectionally. The first DisplayPort connector SK85a is connected with the upper liquid crystal display panel 131b to be able to transmit data unidirectionally. The second DisplayPort connector SK85b is connected with the DP D-AMP board DD to be able to transmit data unidirectionally. The DP D-AMP board DD is an audio amplifier board for DisplayPort and is connected with the lower liquid crystal display panel 141b and a speaker (not shown) to be able to transmit data unidirectionally.

The first LAN jack SK87 is a SAS (Serial Attached SCSI) interface and is provided for data communication with a PTS device GG1 having a SAS interface. SAS is an interface standard that has attained serial transmission in the SCSI standard. The second LAN jack SK91 is provided for data communication with a checking information processing device GG2 called GAT3. The first D-sub connector SK86 is connected with a bill stocker BI to be able to transmit data unidirectionally. The second D-sub connector SK84 is connected with a printer device PR to be able to transmit data unidirectionally.

The first USB connector SK82a is connected with a sub I/O board SI3 to be able to receive data unidirectionally. The sub I/O board S13 is connected with up to 16 button switches CP1a on the control panel CP and button LEDs CP1b. The sub I/O board SI3 is also connected with light emission boards 4353 and counter devices CT.

The second USB connector SK82b is connected with a first GM board GM1 to be able to receive data unidirectionally. The first GM board GM1 is connected with an upper light source board 4263 and a lower light source board 4273.

The third USB connector SK88a is connected with a second GM board GM2 to be able to receive data unidirectionally. The second GM board GM2 is connected with a cabinet fan sensor FNS2 (not shown) and a power box fan sensor FNS1 (not shown). The fan sensors FNS output fan temperature signals indicating the temperatures of these fans. The second GM board GM2 is also connected with a main unit board case switch SE6, upper door switches SE3, a lower door optical sensor SE4, and line lighting components 2134, as well as LED boards LDP for driving the line lighting components 2134 and illumination devices (not shown).

The fourth USB connector SK88b is used as a spare. The fifth USB connector SK90a is connected with the upper touch panel 32211 (131a) to be able to transmit data bidirectionally. The sixth USB connector SK90b is connected with the lower touch panel 4251 (141a) to be able to transmit data bidirectionally.

The AP-X motherboard AM has memory boards MM6 including DDR3 memories. The memory boards MM6 is used for OS authentication with the SSD board SD2 and other processing. The details of the OS authentication are described later.

The SSD enables the slot machine 10 to have a long life. The SSD includes a flash memory holding programs for activating and operating the slot machine 10. The slot machine 10 transfers the programs retrieved from the SSD to the DRAM on the motherboard and executes the programs on the DRAM to activate and operate the gaming machine.

Unlike an HDD, an SSD does not have a driving mechanism to spin a disk such as a bearing and a motor. For this reason, the above-described configuration considerably eliminates mechanical failures such as wear in the driving mechanism. Usually, when an SSD repeats rewrite and erasure, an oxide film acting as an insulator of the memory element of the flash memory is deteriorated by electrons. In the above-described configuration, however, most of the accesses to the SSD are to read a program. Accordingly, the deterioration of the memory element can be kept smaller than in the case of accesses including rewrite or erasure to the flash memory. For this reason, the slot machine 10 can use the SSD for a long time without wear of the memory element like in the case of accessing an HDD. As a result, the probability of occurrence of troubles, such as interruption of video or audio effects during a game, can be lowered compared with the configuration including an HDD. The SSD provides a longer life to the gaming machine.

Furthermore, the SSD enables the slot machine 10 to prevent a failure in the middle of a game. The slot machine 10 is equipped with an SSD including a flash memory holding programs for activating and operating the slot machine 10, grasps the count of write to and erasure from the SSD at predetermined intervals, such as a time of startup, and issues a request for replacement of the SSD when the count of write and erasure reaches a threshold for a failure of the memory element.

In the above-described configuration, the SSD is frequently written with some data such as startup information and data read records even if the data saving is not intentional. Accordingly, even if the SSD is used only for read accesses, the memory element is deteriorated by the use. When the gaming machine is used for a long time, the deterioration of the memory element reaches the level to be failed easily. For this reason, the slot machine 10 configured as described above issues a request for replacement of the SSD when the count of write and erasure reaches a threshold for a failure of the memory element, so that a failure in the middle of a game can be prevented.

In the present embodiment, one DisplayPort connector SK85a is connected with the upper liquid crystal display panel 131b and the other DisplayPort connector SK85b is connected with the lower liquid crystal display panel 141b via the DP D-AMP board DD to individually control the plurality of displays with the plurality of DisplayPort terminals. However, the configuration is not limited to this; a plurality of displays may be controlled with a single DisplayPort terminal.

For example, as illustrated in FIG. 6, the upper liquid crystal display panel 131b having input and output ports of DisplayPort may be daisy chained with the lower liquid crystal display panel 141b by connecting the output port of DisplayPort of the upper liquid crystal display panel 131b to the DP D-AMP board DD. Alternatively, the lower liquid crystal display panel 141b having an output port of DisplayPort may be connected with the upper liquid crystal display panel 131b. Furthermore, in adding a display, the display to be added may be connected to the output port of the upper liquid crystal display panel 131b or the lower liquid crystal display panel 141b.

### <AP-X Motherboard AM>

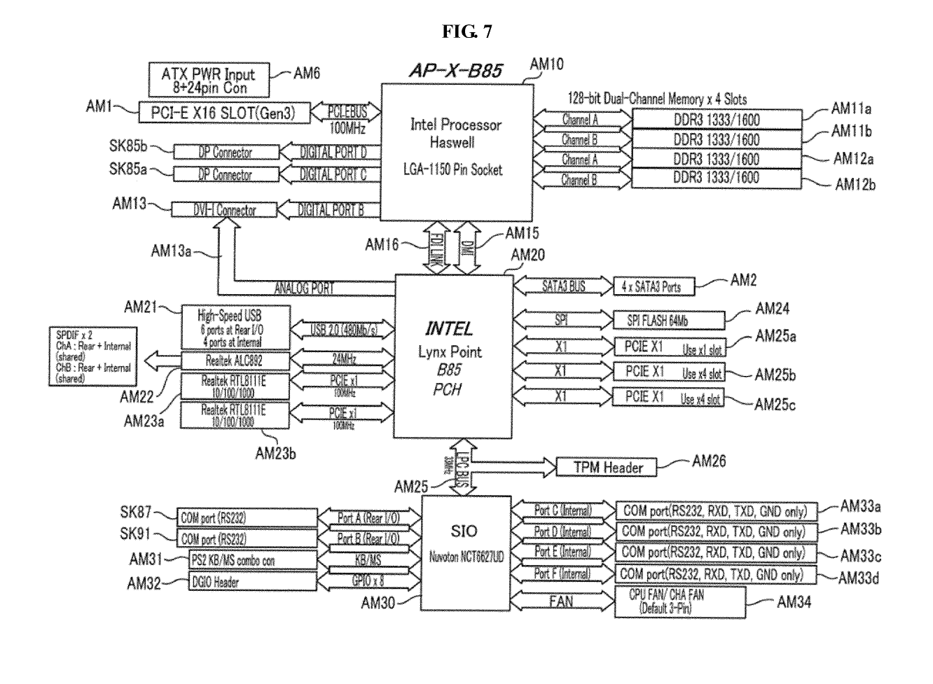

Next, the electrical configuration of the AP-X motherboard AM is described. As illustrated in FIG. 7, the AP-X motherboard AM includes a 4th Generation Intel® Core™ processor (Haswell) AM10, which has 20 EUs as graphics execution units in a GPU core. The processor AM10 is mounted on an Intel LGA 1150 CPU socket and connected with an expansion slot AM1 supporting PCIe (Gen3)×16 specifications (see FIG. 5) to be able to bidirectionally transmit data via a PCIe bus (100 MHz). The AP-X motherboard AM is supplied with power through an 8-pin and 24-pin connector AM6.

The processor AM10 is also connected with four memory slots of slots AM11a and AM12a for Channel A and slots AM11b and AM12b for Channel B to operate in 128-bit dual-channel mode. Each memory slot is occupied by a DDR3 SRAM of a DDR3-1333 or a DDR3-1600. The processor AM10 is further connected with DP (DisplayPort) connectors SK85a and SK85b to be able to unidirectionally transmit data via digital ports C and D. The processor AM10 is still further connected with a DVI-I connector AM13 capable of transmitting both analog and digital video signals to be able to unidirectionally transmit data via a digital port B.

The AP-X motherboard AM also includes a PCH (Lynx Point B85) AM20 of an Intel chipset. The PCH chipset AM20 is a platform controller hub in which the functions of a north bridge (MCH) to connect to the memories and graphics chips and the functions of a south bridge (ICH) to provide interfaces such as PCIe and SATA slots are integrated. The PCH chipset AM20 and the processor AM10 are connected by both of a DMI (Direct Media Interface) bus AM15 and an FDI (Flexible Display Interface) bus AM16 to be able to transmit data bidirectionally.

The PCH chipset AM20 is connected with a plurality of high-speed USB ports AM21 by USB 2.0 with a transfer rate of 480 Mb/s to be able to transmit data bidirectionally. Six of the high-speed USB ports are shown in FIG. 5 as the USB connectors SK82a, SK82b, SK88a, SK88b, SK90a, and SK90b.

The PCH chipset AM20 is also connected with an audio codec chip (Realtek ALC892) AM22 to be able to bidirectionally transmit data at 24 MHz. The audio codec chip AM 22 is connected with two SPDIF channels ChA and ChB. SPDIF is a standard for transferring digital audio signals in video or audio equipment. The PCH chipset AM20 is further connected with two network controller chips (Realtek RTL8111E 10/100/1000) AM23a and AM23b to be able to bidirectionally transmit data at 100 MHz. Furthermore, the PCH chipset AM20 is connected with the DVI-I connector AM13 to be able to unidirectionally transmit data via an analog port AM13a.

The PCH chipset AM20 is connected with four SATA 3 ports AM2 (not shown) to be able to bidirectionally transmit data via a SATA 3 bus. The PCH chipset AM20 is also connected with an SPI flash port AM24 to be able to bidirectionally transmit data at 64 Mb via an SPI (Serial Peripheral Interface) bus. The PCH chipset AM20 is further connected with a plurality of PCIe×1 slots AM25a to 25c to be able to bidirectionally transmit data via a plurality of PCIe×1 buses.

The AP-X motherboard AM includes an SIO (super I/O) chip (Nuvoton NCT6627UD) AM 30. The SIO chip AM30 is an input/output controller integrated circuit for a motherboard and combines interfaces for various low-bandwidth devices. The PCH chipset AM20 and the SIO chip AM30 are connected by an LPC (Low Pin Count) bus AM25, which is a bus for connecting low-bandwidth devices (legacy devices connected by the SIO chip) to a processor, to be able to bidirectionally transmit data at 33 MHz. The LPC bus AM25 is connected with a TPM (Trusted Platform Module) header AM26 to be able to transmit data unidirectionally. The TPM is a hardware tamper-resistant security chip to ensure security.

The SIO chip AM30 is connected with RS232C COM ports SK87 and SK91 (see FIG. 5) to be able to bidirectionally transmit data via ports A and B. The SIO chip AM30 is also connected with a PS2 KB/MS combo connector AM31 to be able to bidirectionally transmit data via a KB/MS bus. The SIO chip AM30 is further connected with a DGIO header AM 32 to be able to bidirectionally transmit data via a GPIO×8 bus. The SIO chip AM30 is still further connected with RS232, RXD, TXD, or GND COM ports AM 33a to 33d to be able to bidirectionally transmit data via internally provided ports C, D, E, and F. The SIO chip AM30 is still further connected with a fan AM34 provided for the CPU or the chassis to be able to bidirectionally transmit data via a fan bus. The fan AM34 is usually connected to a 3-pin connector.

In the present embodiment, the AP-X motherboard AM is referred to as controller 100 or game controller 100. The processor AM10 is referred to as main CPU 200. The DDR3 SRAM attached to a memory slot is referred to as main RAM 210. Furthermore, an SSD device SD2 is referred to as auxiliary storage device 220.

### <<Front Light 420 and Backlight M7>>

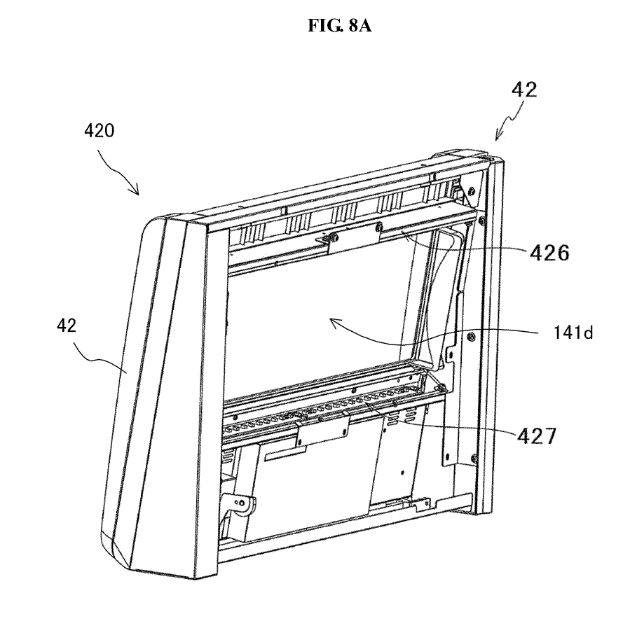

FIG. 8A is a perspective view of a front light 420 and FIG. 8B is a perspective view of a backlight M7.

The upper door unit 42 includes an upper illumination device 426 and a lower illumination device 427 as illustrated in FIG. 8A. FIG. 8A is a perspective view showing the inside of the upper door unit 42 from which the reel unit M1 is removed. The upper door unit 42 is provided with a symbol display area 141d.

The upper illumination device 426 is provided along the upper side of the symbol display area 141d and the lower illumination device 427 is provided along the lower side of the symbol display area 141d. The upper illumination device 426 primarily illuminates the upper area of the five mech reels M3a to M3e from the front. The lower illumination device 427 primarily illuminates the lower area of the five mech reels M3a to M3e from the front.

In the present embodiment, the upper illumination device 426 and the lower illumination device 427 have red, blue, green, and white LEDs (not shown). The upper illumination device 426 and the lower illumination device 427 are electrically connected with the lower light source board 4273 (see FIGS. 5 and 6). The upper illumination device 426 and the lower illumination device 427 are controlled by the main CPU 200 (processor AM10) to turn on, turn off, and select LEDs to light up.

The upper illumination device 426 and the lower illumination device 427 constitute the front light 420.

Behind each of the five mech reels M3a to M3e, a backlight unit M7 is provided. The backlight M7 has three modules 302a to 302c. The three modules 302a to 302c are disposed to fit the curved reel. The module 302a illuminates the top row in the symbol display area 141d; the module 302b illuminates the middle row in the symbol display area 141d; and the module 302c illuminates the bottom row in the symbol display area 141d. In this way, the top row, the middle row, and the bottom row in the symbol display area 141d can be illuminated separately.

On each of the modules 302a to 302c, eight LEDs 304 are disposed in a matrix. Each LED 304 is an aggregation of four kinds of LEDs: an LED for emitting red light, an LED for emitting blue light, an LED for emitting green light, and an LED for emitting white light.

The three modules 302a to 302c (backlight M7) are electrically connected with the lower light source board 4273 (see FIGS. 5 and 6). The three modules 302a to 302c are controlled by the main CPU 200 (processor AM10) to turn on, turn off, and select LEDs to light up. Accordingly, turning on, turning off, or selecting LEDs to light up can be controlled separately for the top row, the middle row, and the bottom row in the symbol display area 141d.

The lower light source board 4273 is connected with index sensors M101, magnetic encoders M102, and others (see FIGS. 5 and 6). The index sensors M101 are sensors to detect the origins of spin angles of the five mech reels M3a to M3e. The magnetic encoders M102 are sensors to detect spin angles of the five mech reels M3a to M3e.

The spin speed of a mech reel (one of the five mech reels M3a to M3e) can be calculated from detection signals from an index sensor M101 and a magnetic encoder M102. The calculated spin speed enables determination of the timing to sequentially turn on and turn off the three modules 302a to 302c. By sequentially turning on and turning off the three modules 302a to 302c with the timing matched with the spin speed, the symbols can be illuminated synchronously with the movement of a symbol. For example, when a 7 determined to be red is moving, the 7 can be illuminated in red synchronously with the movement by turning on the three modules 302a to 302c in red and then turning off one by one.

### <<State Transitions of Games>>

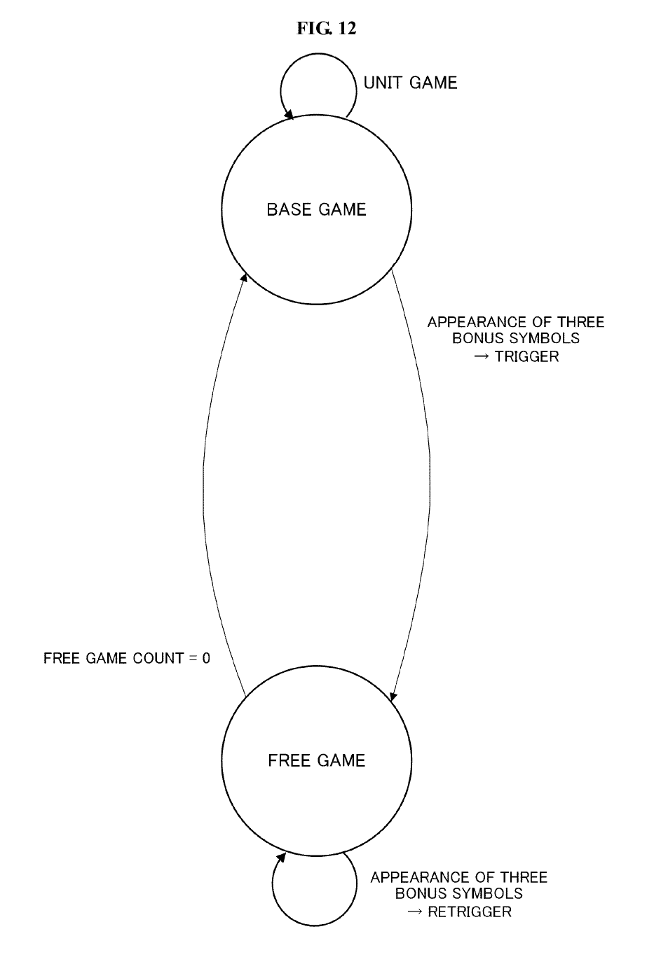

FIG. 12 is a diagram for illustrating state transitions in the gaming machine 1. Specifically, FIG. 12 is a diagram for illustrating transitions between base game mode and free game mode.

The gaming machine 1 has two game modes: base game mode and free game mode. The gaming machine 1 offers unit games basically in the base game mode. When a free game trigger (event) occurs in the base game mode, the game mode changes to the free game mode.

As illustrated in FIG. 12, the base game mode repeats a unit game until a free game trigger is completed. The games in the base game mode are games to conduct unit games by spending (betting) gaming media such as medals. In the games in this base game mode, when one of the winning patterns illustrated in FIG. 14 is completed, an award in the amount in accordance with the payout for the winning pattern is paid out.

Completion of a winning pattern of BONUSes in the base game mode triggers a free game mode. Winning patterns of BONUSes can be also completed in the free game mode. In those cases, the free game mode is retriggered.

BONUSes are scatter symbols, which can make winning patterns independently from paylines. The number of BONUSes shown in the symbol display area 141d determines whether a winning pattern is completed or not.

Under the condition that a predetermined number, for example three, of BONUSes are determined to appear in the symbol display area 141d through symbol lottery processing, a winning pattern is completed. For example, when one BONUS on the mech reel M3a, one BONUS on the mech reel M3d, and one BONUS on the mech reel M3e are determined to appear in the symbol display area 141d, a winning pattern is completed.

Since the BONUSes are scatter symbols, a winning pattern is also completed when two BONUSes on the mech reel M3a and one BONUS on the mech reel M3d are determined to appear in the symbol display area 141d.

The game mode changes to a free game mode when the free game mode is triggered. The free game mode trigger results in two cases: a case where the game mode changes from the base game mode to the free game mode and a case where the free game mode is maintained (a case where the free game trigger acts as a retrigger to continue the free game mode).

The games in the free game mode are games to conduct unit games without spending gaming media such as medals. In the present embodiment, a roulette game is conducted when entering the free game mode to determine the maximum number of unit games in the free game mode. The player can play unit games up to the maximum number in the free game mode.

As described above, winning patterns of BONUSes can be completed in the free game mode to retrigger the free game mode. When the free game mode is retriggered, a roulette game is conducted to determine the number of unit games in the free game mode. As a result of the retrigger, the unit games determined by the roulette game are newly added to increase the maximum number of unit games in the free game mode.

Instead of newly adding unit games, the number of unit games determined by the roulette game offered by the retrigger may replace the maximum number of unit games. Replacing the maximum number may result in reduction of the maximum number of unit games, providing the player with tension.

The free game mode ends when all the maximum number of unit games determined by the roulette game are consumed and the game mode returns to the base game mode.

### <Payline>

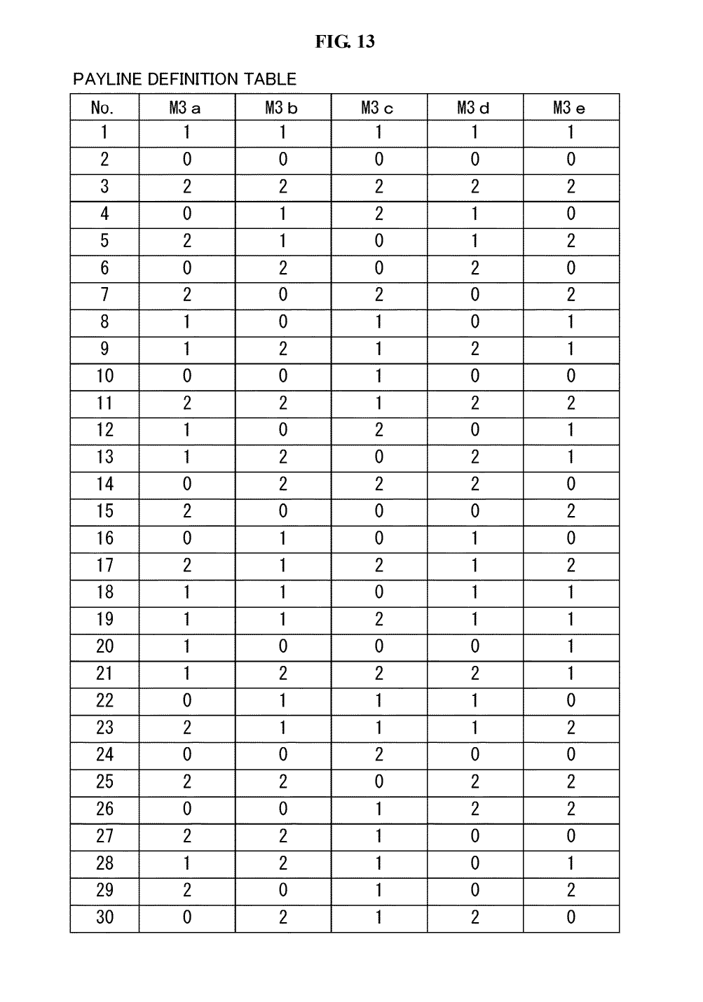

FIG. 13 is a view for illustrating an example of a payline definition table defining paylines employed in the gaming machine 1. As mentioned above, in the gaming machine 1 of the present embodiment, three rows of the top row, the middle row, and the bottom row in are defined in the symbol display area 141d as stop positions of symbols on the five mech reels M3a to M3e. In the gaming machine 1, thirty paylines are defined within a five by three (five columns by three rows) symbol matrix. The payline definition table defines paylines each formed by connecting one of the top row, the middle row, and the bottom row of the five mech reels M3a to M3e in the symbol display area 141d.

For example, the payline definition table indicates that a payline (Payline No. 1) is formed of the middle row of the mech reel M3a (the first reel strip), the middle row of the mech reel M3b (the second reel strip), the middle row of the mech reel M3c (the third reel strip), the middle row of the mech reel M3d (the fourth reel strip), and the middle row of the mech reel M3e (the fifth reel strip).

In the slot machine 10 of the present embodiment, all of the thirty paylines are active regardless of the amount of bet or the player's choice. However, the paylines may be separately activated in accordance with the player's choice. The total number of paylines can be determined as appropriate depending on the size of the symbol matrix.

### <Payout Table>

FIG. 14 is a view for illustrating an example of a payout table. The payout table in FIG. 14 defines winning patterns of 11 kinds of symbols.

The payout table indicates relations among the kind of the symbols constituting the winning pattern, the Kind number, and the payout. The Kind number equals the number of constituent symbols of the winning pattern that are successively arranged from the left to the right along the payline. The gaming machine 1 of the present embodiment determines a win or a loss on a left-to-right basis except for BONUSes. Accordingly, the payout is determined depending on the kind and the number of symbols successively arranged along a payline. Instead of the left-to-right basis, the number of symbols arranged along a payline, even if they are not successive, may determine whether a winning pattern is completed.

The first winning patterns are patterns where WILDs are successively arranged. In the present embodiment, successive WILDs are not assigned a direct payout. A WILD is a symbol to substitute for another symbol to make an advantageous winning pattern. When a winning pattern is completed with other symbols substituted by WILDs, a payout for the winning pattern is determined. In the present embodiment, however, a WILD cannot substitute for a BONUS.

The second winning patterns are patterns where three to five RED7s are successively arranged along a payline. For example, the payout when five RED7s are successively arranged along a payline is defined as 1000.

The third winning patterns are patterns where three to five BLUE7s are successively arranged along a payline. For example, the payout when five BLUE7s are successively arranged along a payline is defined as 500.

The fourth winning patterns are patterns where three to five GREEN7s are successively arranged along a payline. For example, the payout when five GREEN7s are successively arranged along a payline is defined as 300.

The fifth winning patterns are patterns where three to five WHITE7s are successively arranged along a payline. For example, the payout when five WHITE7s are successively arranged along a payline is defined as 100.

As noted from the above, the payouts for the RED7s are highest and the payouts for the WHITE7s are lowest among the RED7s, BLUE7s, GREEN7s, and WHITE7s.

The sixth winning patterns are patterns where three to five ANY7s are successively arranged along a payline. The winning patterns of ANY7 are patterns where a mixture of at least two kinds out of RED7, BLUE7, GREEN7, and WHITE7 are successively arranged along a payline. For example, the payout when two RED7s and one WHITE7 are arranged along a payline is defined as 5.

The seventh winning patterns are patterns where three to five 3BARs are successively arranged along a payline. For example, the payout when five 3BARs are successively arranged along a payline is defined as 150.

The eighth winning patterns are patterns where three to five 2BARs are successively arranged along a payline. For example, the payout when five 2BARs are successively arranged along a payline is defined as 100.

The ninth winning patterns are patterns where three to five 1BARs are successively arranged along a payline. For example, the payout when five 1BARs are successively arranged along a payline is defined as 7S.

As noted from the above, the payouts for the 3BARs are highest and the payouts for the 1BARs are lowest among the 3BARs, 2BARs, and 1BARs.

The tenth winning patterns are patterns where three to five ANYBARs are arranged along a payline. The winning patterns of ANYBAR are patterns where a mixture of at least two kinds out of 3BAR, 2BAR, and 1BAR are successively arranged along a payline. For example, the payout when two 2BARs and one 1BAR are arranged along a payline is defined as 5.

The eleventh winning patterns are winning patterns where three to five BONUSes appear. As mentioned above, the BONUSes are scatter symbols. Accordingly, BONUSes arranged along a payline are not a requirement to complete a winning pattern and the number of appearing BONUSes determines whether an eleventh winning pattern is completed. The payout when three BONUSes appear is defined as 1; the payout when four BONUSes appear is defined as 2; and the payout when five BONUSes appear is defined as 5.

As mentioned above, under the condition that three or more BONUSes are determined to appear in the symbol display area 141d through symbol lottery processing, a free game mode is triggered or retriggered. Accordingly, when three or more BONUSes are determined to appear in the symbol display area 141d through symbol lottery processing, both of the benefits of receiving payout and entering the free game mode are provided to the player.

### <Configuration of Reel Strips>

FIGS. 15 and 16 are views for illustrating reel strips (symbol arrays) included in the five mech reels M3a to M3e and weights of individual symbols. The relations between the symbols and the weights indicated in FIGS. 15 and 16 are digitalized and stored in the SSD device SD2 of the auxiliary storage device 220. These FIGS. 15 and 16 function as symbol determination tables to be described later.

FIG. 15 shows the reel strips included in the five mech reels M3a to M3e in the base game mode and FIG. 16 shows the reel strips included in the five mech reels M3a to M3e in the free game mode. As shown in FIGS. 15 and 16, the arrays of the symbols in the base game mode and the arrays of the symbols in the free game mode are the same. The longitudinal directions in FIGS. 15 and 16 are the spin direction.

On each of the five mech reels M3a to M3e, total 22 symbols are disposed. Each of these 22 symbols is assigned a code number (0 to 21) to identify the symbol. Each of the five mech reels M3a to M3e is also assigned a reel number (1 to 5) to identify the reel. Identifying a reel number and a code number leads to identifying one symbol.

On the five mech reels M3a to M3e, WILDs, 7s, 3BARs, 2BARs, 1BARs, BONUSes, and BLANKs are disposed. The BLANKs are disposed alternately along the spin direction.

As to the WILDs, each of only the three mech reels M3b, M3c and M3d has one WILD.

As illustrated in FIGS. 15 and 16, the symbols of 7s are merely Specified as 7 and are not specified about their colors. In the relations between symbols and weights, the 7s are merely specified that they are “7”. On the five mech reels M3a to M3e, the outlines of figure 7s are disposed.

As illustrated in the payout table in FIG. 14, however, the present embodiment is provided with four kinds of 7s, RED7, BLUE7, GREEN7, and WHITE7, to determine a winning pattern or payout. As described above, a backlight M7 is provided behind each of the five mech reels M3a to M3e. The backlight M7 has four kinds of LEDs: an LED for emitting red light, an LED for emitting blue light, an LED for emitting green light, and an LED for emitting white light.

When a symbol 7 is illuminated with red light, it is regarded as RED7 to determine a winning pattern. In similar, when the symbol 7 is illuminated with blue light, it is regarded as BLUE7 to determine a winning pattern; when the symbol 7 is illuminated with green light, it is regarded as GREEN7 to determine a winning pattern; and when the symbol 7 is illuminated with white light, it is regarded as WHITE7 to determine a winning pattern.

### <<Description of Program>>

Now, with reference to FIGS. 17 to 26, the program to be executed by the gaming machine 1 is described.

### <Main Control Processing>

With reference to FIG. 17, main control processing is described. FIG. 17 is a flowchart of main control processing for the gaming machine 1 according to the embodiment of the present invention. The game mode in this main control in FIG. 17 is the base game mode.

First, when the power is supplied to the gaming machine 1, the main CPU 200 retrieves the authenticated game program and game system program from the auxiliary storage device 220 (SSD device SD2) through the AX-GMEM board G13, and writes the programs into the main RAM 210 (step S1711).

Next, the main CPU 200 conducts at-one-game-end initialization processing (step S1712). For example, the main CPU 200 clears data that becomes unnecessary after each game in the working areas of the main RAM 210, such as the bet count and the symbols determined by lottery.

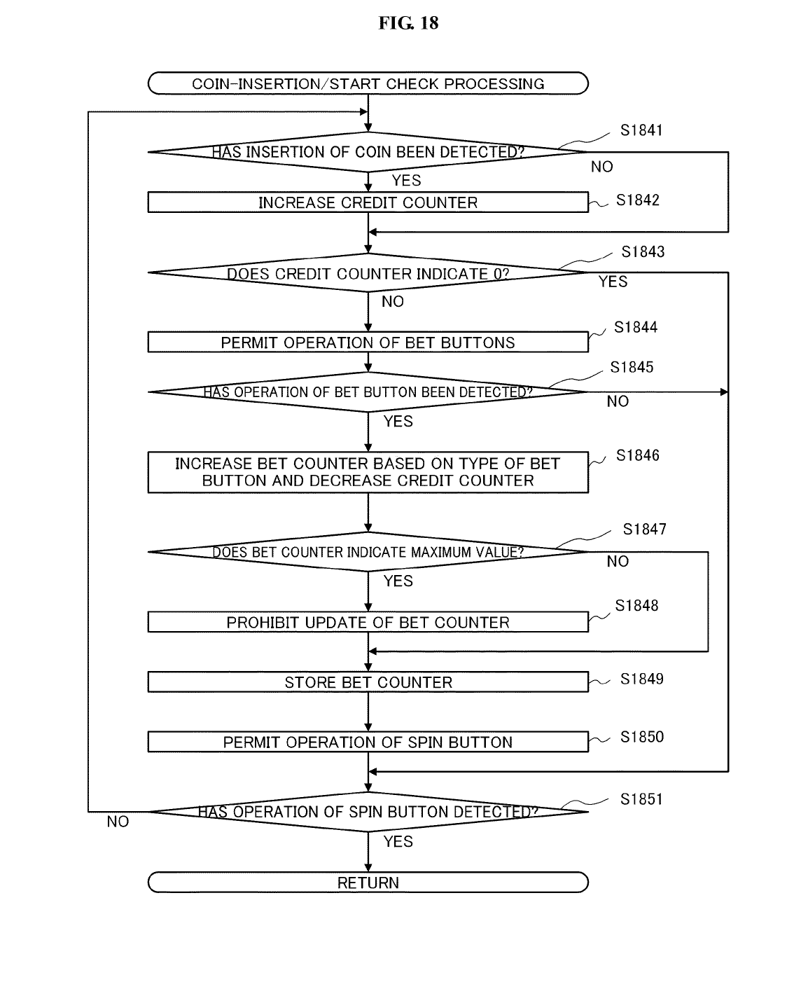

Next, the main CPU 200 performs coin-insertion/start check processing which is described later with reference to FIG. 18 (step S1713). In the processing, whether input from any of the BET buttons (operation buttons CP2 to CP6) or the spin button (operation button CP1) has been detected is checked.

Next, the main CPU 200 invokes and conducts color table determination processing which is described later with reference to FIG. 25 (S1721). In the processing, one color table is determined.

Next, the main CPU 200 conducts symbol lottery processing which is described later with reference to FIG. 19 (step S1714). In the processing, to-be stopped symbols are determined based on the random numbers for symbol determination and if a specified number of BONUSes are determined to appear, a free game trigger is completed.

Next, the main CPU 200 conducts effect initiation processing which is described later with reference to FIG. 24 (step S1715).

As will be described later, in the processing of step S1715, if a illumination color determination table specifying a pure color is determined, the front light 420 emits light in the specified pure color. The front light 420 primarily illuminates the upper area and the lower area of the five mech reels M3a to M3e from the front with light in a pure color. The player can expect a high payout by recognizing the light in the pure color.

Furthermore, the processing of step S1715 can start the following presentation effects. The main CPU 200 extracts a random number for determination of effects, and determines an effect content from the predefined plurality of effect contents by lottery, and executes the determined effect content with predetermined timing. For example, the main CPU 200 performs control to display a video for presentation effects on the upper liquid crystal display panel 131b, to output audio from a speaker (not shown), to flash a lamp (not shown), and to apply special effects to these.

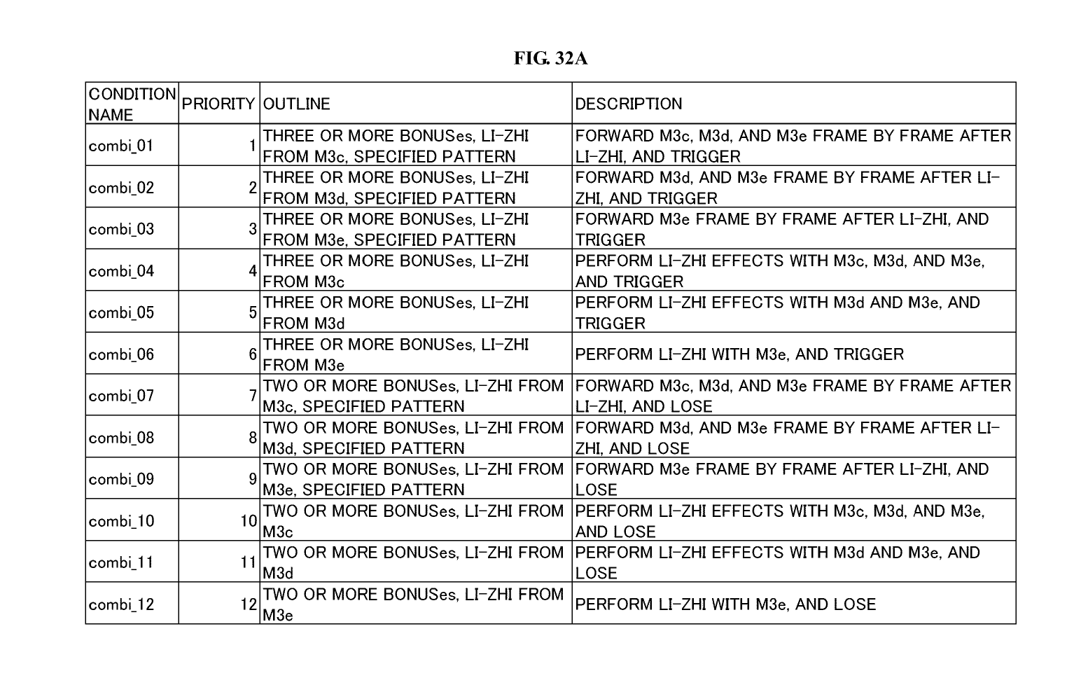

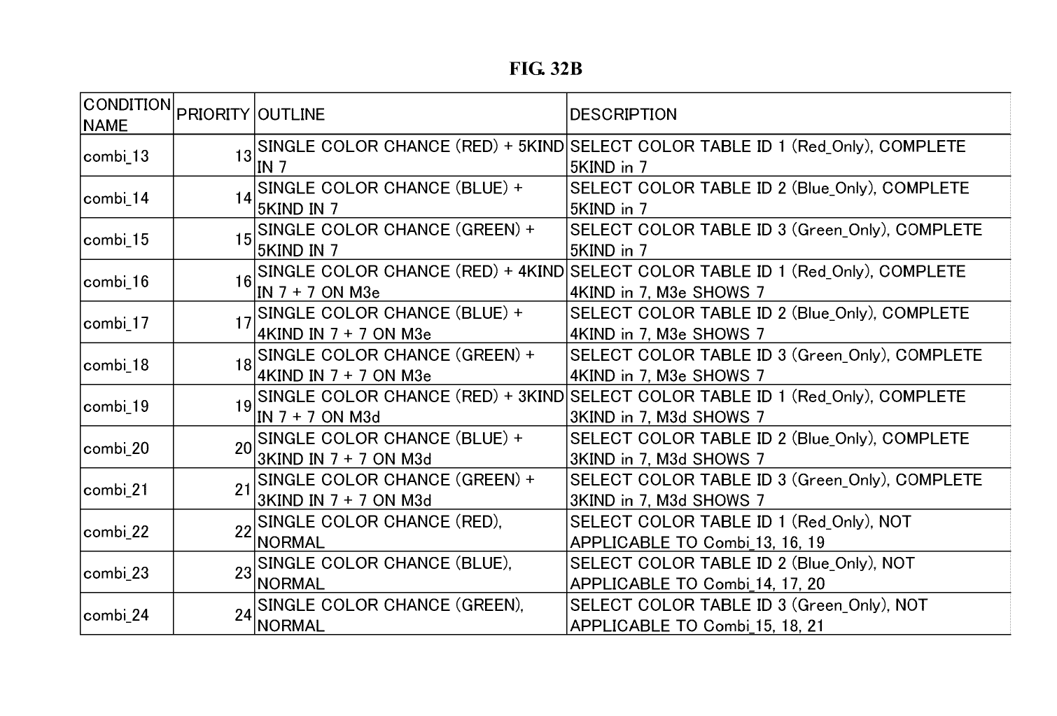

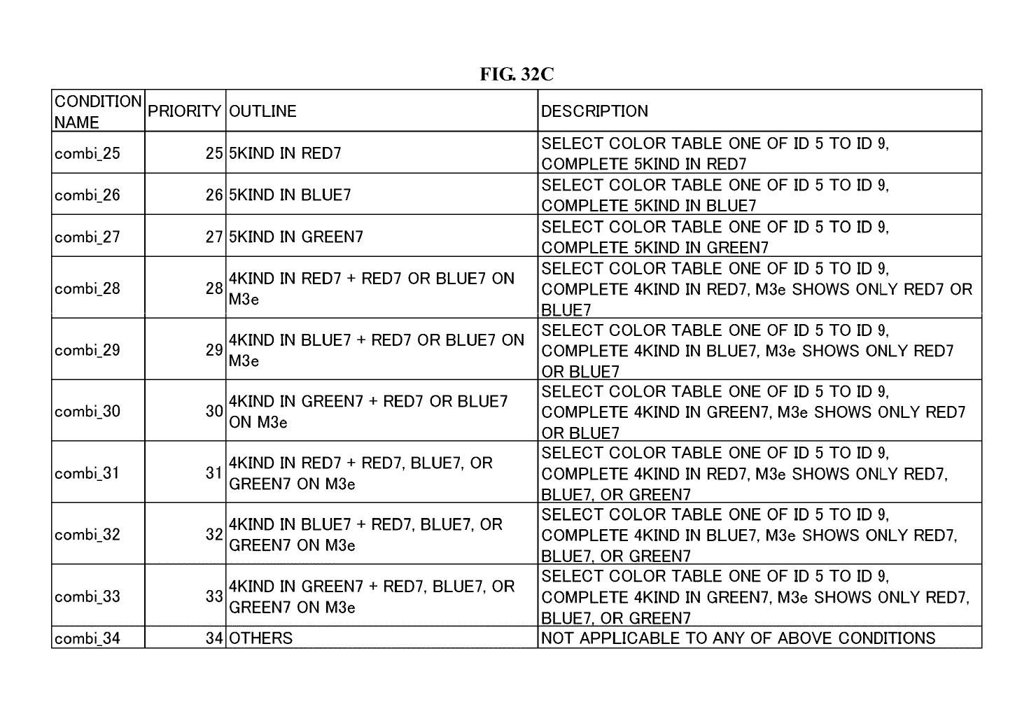

The effect initiation processing of step S1715 further determines predictive/li-zhi effects as illustrated in FIGS. 32A to 32C. The predictive/li-zhi effects are performed by controlling the spin speed, spin direction, spin time (spin angle), and time to stop of the individual stepping motors M51 for driving the five mech reels M3a to M3e. In the effect initiation processing, the main CPU 200 determines parameters for these spin speed, spin direction, spin time (spin angle), and time to stop of the stepping motors M51.

Next, the main CPU 200 conducts symbol display control processing which is described later with reference to FIG. 20 (step S1716). In the processing, spinning the five mech reels M3a to M3e (scrolling the five reel strips) is started, and the to-be stopped symbols determined in the symbol lottery processing of step S1714 are stopped at predetermined positions.

Next, the main CPU 200 conducts payout determination processing which is described later with reference to FIG. 21 (step S1717). In the processing, the amount of payout based on the payout table (see FIG. 14) is determined depending on the winning pattern, and is stored into a payout storage area (payout counter) provided in the main RAM 210.

Next, the main CPU 200 conducts payout processing (step S1722). The main CPU 200 adds the value stored in the payout storage area (payout counter) to the value stored in a credit storage area (credit counter) provided in the main RAM 210. It is to be noted that operations of the hopper (not shown) may be controlled to discharge coins corresponding to the value stored in the payout counter from the coin payout exit. Alternatively, operations of the ticket printer (not shown) may be controlled to issue a ticket with a barcode on which a value stored in the payout counter is recorded.

Next, the main CPU 200 determines whether or not a free game trigger is completed (step S1718). If the main CPU 200 determines that a free game trigger is completed, the main CPU 200 conducts free game mode processing which is described later with reference to FIG. 22 (step S1719) and returns the processing to step S1712.

If determining that a free game trigger is not completed in step S1718, the main CPU 200 returns the processing to step S1712.

### <Coin-Insertion/Start Check Processing>

Next, with reference to FIG. 18, coin-insertion/start check processing is described. FIG. 18 is a flowchart of the coin-insertion/start check processing for the gaming machine 1 according to the embodiment of the present invention.

First, the main CPU 200 determines whether or not insertion of a coin has been detected by the coin counter (step S1841). When determining that the insertion of a coin has been detected, the main CPU 200 adds the value of the inserted coin to the value stored in the credit storage area (credit counter) (step S1842). It is to be noted that, in addition to the insertion of a coin, the main CPU 200 may determine whether or not insertion of a bill has been detected with a bill validator (e.g., the PTS terminal 700), and when determining that the insertion of a bill has been detected, the main CPU 200 may add a value corresponding to the amount of bill to the value stored in the credit counter.

After step S1842 or when determining in step S1841 that no insertion of a coin has been detected, the main CPU 200 determines whether or not the credit counter indicates zero (step S1843). When determining that the credit counter indicates a non-zero value, the main CPU 200 permits operation of the BET buttons (the operation buttons CP2 to CP6) (step S1844).

Next, the main CPU 200 determines whether or not operation of any of the BET buttons (the operation buttons CP2 to CP6) has been detected (step S1845). When the main CPU 200 detects press of a BET button (one of the operation buttons CP2 to CP6) by the player with a BET switch, the main CPU 200 makes an addition to a value stored in a bet storage area (bet counter) provided in the main RAM 210 and makes a subtraction in the credit counter, based on the type of the BET button (one of the operation buttons CP2 to CP6) (step S1846).

The main CPU 200 then determines whether or not the bet counter indicates a maximum value (step S1847). When determining that the BET counter indicates the maximum value, the main CPU 200 prohibits updating the bet counter (step S1848).

After step S1848 or when determining in step S1847 that the bet counter does not indicate a maximum value, the main CPU 200 stores the value of the BET counter (step S1849). The free game mode allows conducting free games (unit games) without spending gaming media such as medals. Accordingly, free games can be started without bet; the bet counter cannot be determined through a BET button operation. For this reason, after entering the free game mode, the value of the bet counter in the base game mode before entering the free game mode is used. The value of the bet counter stored in step S1849 is retrieved and used after entering the free game mode.

Next, the main CPU 200 permits operation of the spin button (the operation button CP1) (step S1850).

After step S1850, when determining in step S1845 that no operation of BET buttons (the operation buttons CP2 to CP6) has been detected, or when determining in step S1843 that the credit counter 320 indicates zero, the main CPU 200 determines whether or not operation of the spin button (the operation button CP1) has been detected (step S1851). When determining that no operation of the spin button (the operation button CP1) has been detected, the main CPU returns to step S1841.

When determining that the operation of the spin button (the operation button CP1) has been detected, the main CPU 200 terminates the coin-insertion/start check processing.

### <Symbol Lottery Processing>

Next, with reference to FIG. 19, symbol lottery processing is described. FIG. 19 is a flowchart of the symbol lottery processing for the gaming machine 1 according to the embodiment of the present invention.

First, the main CPU 200 extracts five random numbers for symbol determination (step S1911). The main CPU 200 then determines to-be stopped symbols for the five mech reels M3a to M3e by lottery with the five random numbers (step S1912).

In the processing of step S1912, the main CPU 200 determines five to-be stopped symbols with reference to the symbol determination table. In the present embodiment, the symbol determination table is the table illustrated in FIG. 15 or 16.

When the game mode is the base game mode, the main CPU 200 determines five to-be stopped symbols with reference to the symbol determination table for base game mode illustrated in FIG. 15.

When the game mode is the free game mode, the main CPU 200 determines five to-be stopped symbols with reference to the symbol determination table for free game mode illustrated in FIG. 16.

That is to say, the main CPU 200 extracts five random numbers for symbol determination, and determines one symbol to be a to-be stopped symbol for each of the five mech reels M3a to M3e with reference to the symbol determination table in FIG. 15 or 16 depending on the game mode.

In the present embodiment, to-be stopped symbols are selected in accordance with the weights in the symbol determination table in FIG. 15 or 16.

Through the processing of step S1912, five to-be stopped symbols for the five mech reels M3a to M3e are determined. Each of the five mech reels M3a to M3e is controlled to be stopped so that the determined to-be stopped symbol stops at the middle row of the symbol matrix (the middle row of the symbol display area 141d).

Next, the main CPU 200 stores the determined to-be stopped symbols for the individual mech reels to a symbol storage area provided in the main RAM 210 (step S1913).

As described above, according to this symbol lottery processing, the symbols on the five mech reels M3a to M3e are selected in accordance with the weights indicated in FIG. 15 or 16. However, the to-be stopped symbols may be determined at an equal probability in accordance with the numbers of the symbols on the five mech reels M3a to M3e.

### <Symbol Display Control Processing>

Next, with reference to FIG. 20, symbol display control processing is described. FIG. 20 is a flowchart of the symbol display control processing for the gaming machine 1 according to the embodiment of the present invention.

The main CPU 200 starts scrolling the five mech reels M3a to M3e displayed in the symbol display area 141d of the lower display unit 141 (step S2011).

The scrolling speeds and directions of the five mech reels M3a to M3e are controlled with the parameters for predictive/li-zhi effects determined in the effect initiation processing of step S1715 or step S2221.

In the present embodiment, the five mech reels M3a to M3e illustrated in FIGS. 15 and 16 are displayed as reel strips.

Next, the main CPU 200 stops one or more specified mech reels out of the five mech reels M3a to M3e based on the symbol storage area (step S2013). The mech reels to be stopped or the time to stop are determined with the parameters for predictive/li-zhi effects determined in the effect initiation processing of step S1715 or step S2221.

Next, the main CPU 200 determines whether any 7 has appeared in the symbol display area 141d (step S2015).

When determining that one or more 7s have appeared in the symbol display area 141d, the main CPU 200 turns on the LEDs at the stop positions of the 7s in the symbol display area 141d in the color determined in the emission color determination processing in FIG. 26 (step S2017).

This step illuminates the 7s shown in the symbol display area 141d in the emission colors determined in the emission color determination processing in FIG. 26 in order of stopping the mech reels. Accordingly, the player can successively recognize that each 7 that has appeared in the symbol display area 141d is a RED7, a BLUE7, a GREEN7, or a WHITE7 every time one or more mech reels are stopped.

As will be described later, when a plurality of 7s are to appear in the symbol display area 141d, the main CPU 200 can separately determine colors for all the 7s. In the foregoing step S2017, all the 7s can be illuminated by turning on the LEDs at the positions of the 7s in the determined emission colors.

Meanwhile in the foregoing processing of S2011, the main CPU 200 successively turns on and off the three modules 302a to 302c of the backlight M7 to illuminate the symbols synchronously with the movement of the symbols. For example, when a 7 determined to be red is moving, three modules 302a to 302c are sequentially turned on to light up in red and then turned off to synchronously illuminate the moving 7.

Next, the main CPU 200 determines whether all the five mech reels M3a to M3e are stopped (step S2019). When determining that all the five mech reels M3a to M3e are not stopped, the main CPU 200 returns the processing to step S2013. When determining that all the five mech reels M3a to M3e are stopped, the main CPU 200 exits this subroutine.

In the present embodiment, after the start of scrolling the five mech reels M3a to M3e until the stop of the scrolling, various predictive/li-zhi effects are performed with the five mech reels M3a to M3e as illustrated in FIGS. 32A to 32C. The main CPU 200 controls the spin speeds, spin directions, and spin times (spin angles) of the stepping motors M51 for driving the five mech reels M3a to M3e to perform the predictive/li-zhi effects.

The foregoing has provided an example that illuminates the 7s that have appeared in the symbol display area 141d with the emission colors determined in the emission color determination processing in FIG. 26 each time one or more mech reels are stopped. However, another example can be provided that does not illuminate the 7s until all the five mech reels M3a to M3e are stopped, and illuminates all the 7s shown in the symbol display area 141d after all the five mech reels M3a to M3e are stopped. Such effects that the player cannot recognize the illumination colors for the 7s already shown in the symbol display area 141d until all the five mech reels M3a to M3e are stopped enable the player to feel expectation or anxiety for a winning pattern.

### <Payout Determination Processing>

Next, with reference to FIG. 21, payout determination processing is described. FIG. 21 is a flowchart of the payout determination processing for the gaming machine 1 according to the embodiment of the present invention.

First, the main CPU 200 determines the kinds of the stopped symbols in accordance with the emission color (step S2111). When a 7 is illuminated in red, the main CPU 200 determines that the 7 is a RED7. When a 7 is illuminated in blue, the main CPU 200 determines that the 7 is a BLUE7. When a 7 is illuminated in green, the main CPU 200 determines that the 7 is a GREEN7. When a 7 is illuminated in white, the main CPU 200 determines that the 7 is a WHITE7.

Next, the main CPU 200 determines whether any winning pattern is completed based on the symbols stored in the symbol storage area with reference to the payout table in FIG. 14 (step S2112).

Next, the main CPU 200 determines whether any winning pattern is completed with the kinds of symbols determined in step S2111 (S2113).

Next, if a winning pattern is completed, the main CPU 200 determines the amount of payout based on the payout associated with the completed winning pattern with reference to the symbol storage area and the payout table (FIG. 14) (step S2115).

Next, the main CPU 200 stores the determined amount of payout in the payout counter in the payout storage area (step S2117) and exits this subroutine.

If determining that no winning pattern is completed in the determination of step S2113, the main CPU 200 immediately exits this subroutine.

### <Free Game Mode Processing>

With reference to FIG. 22, free game mode processing is described. FIG. 22 is a flowchart of the free game mode processing for the gaming machine 1 according to the embodiment of the present invention.

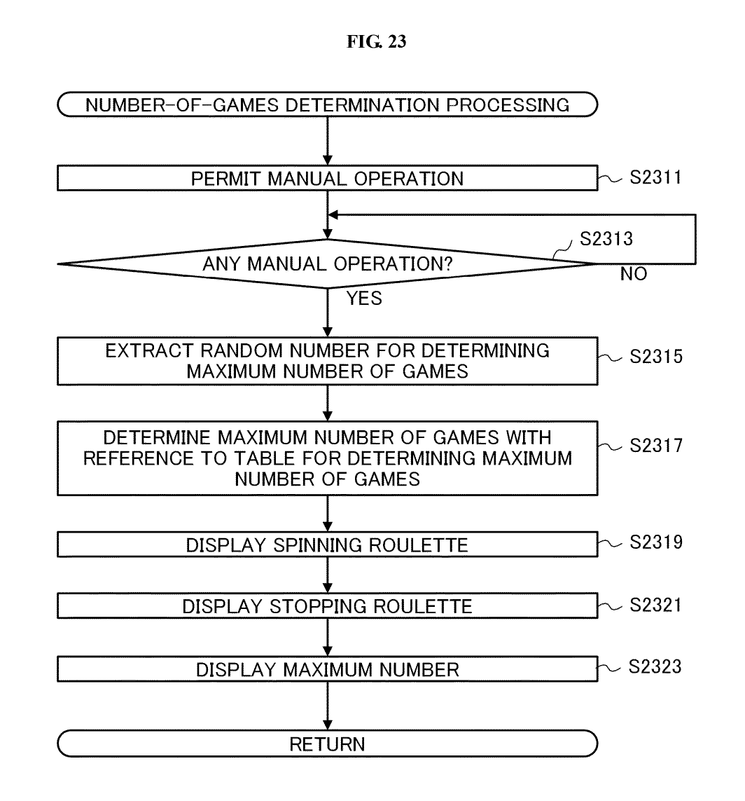

First, the main CPU 200 invokes a subroutine of number-of-games determination processing illustrated in FIG. 23 to determine the maximum number for the unit games in the free game mode (step S2211). In the free game mode, the maximum number for the unit games is determined through the number-of-games determination processing.

Next, the main CPU 200 stores the maximum number for the unit games in the game counter (step S2213).

Next, the main CPU 200 conducts free game mode starting effect execution processing (S2215). The main CPU 200 extracts a random number for determination of effects, and determines one of the effect contents for starting the free game mode from the predefined plurality of effect contents by lottery, and executes the determined free game mode starting effects. For example, the main CPU 200 performs control to display a video for presentation effects on the upper liquid crystal display panel 131b, to output audio from a speaker (not shown), to flash a lamp (not shown), and to apply special effects to these. These effects notify the player of entering the free game mode.

Next, the main CPU 200 conducts at-one-game-end initialization processing (step S2217). For example, the main CPU 200 clears data that becomes unnecessary after each game in the working areas of the main RAM 210, such as the symbols determined by lottery.

Next, the main CPU 200 invokes and conducts color table determination processing in FIG. 25 to be described later (step S2239). Through this processing, one color table is determined.

Next, the main CPU 200 conducts symbol lottery processing described with reference to FIG. 19 (step S2219). In the processing, to-be stopped symbols are determined based on random numbers for symbol determination.

Next, the main CPU 200 conducts effect initiation processing illustrated in FIG. 24 (step S2221).

As will be described later, in the processing of step S2221, if a illumination color determination table specifying a pure color is determined, the front light 420 emits light in the specified pure color. The front light 420 primarily illuminates the upper area and the lower area of the five mech reels M3a to M3e from the front with light in a pure color. The player can expect a high payout by recognizing the light in the pure color.

Furthermore, the processing of step S2219 can start the following presentation effects. The main CPU 200 extracts a random number for determination of effects, and determines one of the effect contents from the predefined plurality of effect contents by lottery, and executes the determined effect contents with predetermined timing. For example, the main CPU 200 performs control to display a video for presentation effects on the upper liquid crystal display panel 131b, to output audio from a speaker (not shown), to flash a lamp (not shown), and to apply special effects to these.

The effect initiation processing of step S2221 further determines predictive/li-zhi effects as illustrated in FIGS. 32A to 32C. The predictive/li-zhi effects are performed by controlling the spin speed, spin direction, spin time (spin angle), and time to stop of the individual stepping motors M51 for driving the five mech reels M3a to M3e. In the effect initiation processing, the main CPU 200 determines parameters for these spin speed, spin direction, spin time (spin angle), and time to stop of the stepping motors M51.

Next, the main CPU 200 conducts symbol display control processing described with reference to FIG. 20 (step S2223). In this processing, spinning the five mech reels M3a to M3e is started and to-be stopped symbols determined in the symbol lottery processing of step S2219 are stopped at the predetermined positions.

Next, the main CPU 200 determines the multiplier to be 2 (step S2225).

Next, the main CPU 200 invokes a subroutine of the payout determination processing illustrated in FIG. 21 to determine the amount of payout (step S2227). In this processing, the main CPU 200 determines a payout based on the payout table (see FIG. 14) in accordance with the winning pattern, multiplies the payout by the multiplier determined in step S2225, and stores the result in the payout storage area provided in the main RAM 210.

Next, the main CPU 200 conducts payout processing (step S2229). The main CPU 200 adds the value stored in the payout storage area to a value stored in a credit storage area provided in the main RAM 210.

It is to be noted that operations of the hopper (not shown) may be controlled to discharge coins corresponding to the value stored in the payout counter from the coin payout exit. Alternatively, operations of the ticket printer (not shown) may be controlled to issue a ticket with a barcode on which a value stored in the payout counter is recorded.

Next, the main CPU 200 decrements the game count by one (step S2231).

Next, the main CPU 200 determines whether a retrigger for the free games is completed (step S2233). When determining that a retrigger for the free games is completed, the main CPU 200 invokes a subroutine of the number-of-games determination processing illustrated in FIG. 23, determines the maximum number for unit games in the free game mode (step S2235), and returns the processing to step S2217.

When determining that a retrigger is not completed, the main CPU 200 determines whether the game count is more than zero (step S2237).

When determining that the game count is more than zero, the main CPU 200 returns the processing to step S2217. When determining that the game count is zero, the main CPU 200 exits this subroutine.

### <Number-of-Games Determination Processing>

FIG. 23 is a subroutine of determining the maximum number for unit games in a free game mode. In the present embodiment, the maximum number for unit games is determined by a roulette game. The maximum number for unit games is internally determined by lottery and the maximum number for unit games is indicated as the result of the roulette game.

First, the main CPU 200 permits manual operation in the roulette game (step S2311). This permission of manual operation is permission for the player to operate the upper touch panel 131a of the upper display unit 131. The upper display unit 131 displays a roulette board R as illustrated in FIG. 31. On the bottom of the roulette board R, an arrow P is displayed. The player rotates this roulette board R and the numerical value pointed by the arrow P when the roulette board R stops is determined to be the maximum number for the unit games.

Next, the main CPU 200 determines whether the upper touch panel 131a has been operated by the player (step S2313).

When determining that the upper touch panel 131a is not operated by the player, the main CPU 200 returns the processing to step S2313.

When determining that the upper touch panel 131a has been operated by the player, the main CPU 200 extracts a random number for determining the maximum number of games (step S2315).

Next, the main CPU 200 determines the maximum number of games with reference to a table for determining the maximum number of games (see FIG. 29) with the extracted random number (step S2317). As illustrated in FIG. 29, five maximum numbers of 10, 12, 15, 20, and 25 are individually assigned weights. In the example in FIG. 29, all the five maximum numbers are assigned a weight of 1; one of the five maximum numbers is selected at equal probabilities.

Next, the main CPU 200 displays the roulette board displayed on the upper display unit 131 in a spinning fashion (step S2319).

Next, the main CPU 200 slows down the spin speed of the roulette board and displays the roulette board stopped at a position where the arrow points the section indicating the maximum number of games (step S2321).

Next, the main CPU 200 displays the maximum number of games (step S2323) and exits this subroutine.

### <Effect Initiation Processing>

FIG. 24 is a subroutine of effect initiation processing.

First, the main CPU 200 invokes emission color determination processing in FIG. 26 to be described later (step S2413). This processing determines emission colors to illuminate the 7s to appear in the symbol display area 141d of the lower display unit 141.

Next, the main CPU 200 determines whether the number of 7s to appear in the symbol display area 141d of the lower display unit 141 determined in the symbol lottery processing in FIG. 19 is three or more (step S2415).

Next, when determining that the number of 7s to appear in the symbol display area 141d of the lower display unit 141 is three or more, the main CPU 200 determines whether the selected from the color tables in the processing of step S2413 is a pure color table (step S2417).

Next, when determining that the selected from the color tables is a pure color table, the main CPU 200 selects the LEDs for the color of the pure color table selected in step S2417 out of the LEDs of the front light 420 (step S2419).

Next, the main CPU 200 turns on the LEDs selected in step S2419 (step S2421).

When determining that the number of 7s to appear in the symbol display area 141d of the lower display unit 141 is less than three, when determining that the selected from the color tables is not a pure color table, or after the processing of step S2421, the main CPU 200 exits this subroutine.

As understood from the above, when an illumination color determination table specifying a pure color is determined, the front light 420 emits light in the color; the player can expect a high payout by seeing the light in the pure color. Depending on the illumination color, the player expects a different level of payout.

### <Color Table Determination Processing>

FIG. 25 is a subroutine of color table determination processing.

First, the main CPU 200 extracts a random number for determining a color table (step S2511).

Next, the main CPU 200 determines a color table with reference to color table determination tables (see FIGS. 27A and 27B) with the extracted random number (step S2513) and exits this subroutine.

The color table determination table shown in FIG. 27A is a color table determination table to be referred to in a base game mode and the color table determination table shown in FIG. 27B is a color table determination table to be referred to in a free game mode.

The color table determination table is a table to select one from nine color tables named Red Only, Blue Only, Green Only, White Only, Red Main, Blue Main, Green Main, White Main, and Any Main.

Examples of the nine color tables are shown in FIGS. 28A to 28I. In each of the tables, weights for the 7s in four colors, RED 7, BLUE 7, GREEN 7, and WHITE 7, are defined.

When RED 7 is selected, the main CPU 200 turns on the red LEDs of the backlight M7 to illuminate the 7 with red light and makes a RED7. When BLUE 7 is selected, the main CPU 200 turns on the blue LEDs of the backlight M7 to illuminate the 7 with blue light and makes a BLUE7.

When GREEN 7 is selected, the main CPU 200 turns on the green LEDs of the backlight M7 to illuminate the 7 with green light and makes a GREEN7. When WHITE 7 is selected, the main CPU 200 turns on the white LEDs of the backlight M7 to illuminate the 7 with white light and makes a WHITE7.

The color table Red Only (FIG. 28A) is a table to select only the red LEDs of the backlights

M7 (the red LEDs are selected at 100%). The color table Blue Only (FIG. 28B) is a table to select only the blue LEDs of the backlights M7 (the blue LEDs are selected at 100%). The color table Green Only (FIG. 28C) is a table to select only the green LEDs of the backlights M7 (the green LEDs are selected at 100%). The color table White Only (FIG. 28D) is a table to select only the white LEDs of the backlights M7 (the white LEDs are selected at 100%).

The tables Red Only, Blue Only, Green Only, and White Only represent the color determination table for selecting a specific color and the color determination tables for selecting a color excluding the specific color.

The color table Red Main (FIG. 28E) is a table to select the red LEDs at the highest probability among the red LEDs, blue LEDs, green LEDs, and white LEDs of the backlight M7. The color table Blue Main (FIG. 28F) is a table to select the blue LEDs at the highest probability among the red LEDs, blue LEDs, green LEDs, and white LEDs of the backlight M7. The color table Green Main (FIG. 28G) is a table to select the green LEDs at the highest probability among the red LEDs, blue LEDs, green LEDs, and white LEDs of the backlight M7. The color table White Main (FIG. 28H) is a table to select the white LEDs at the highest probability among the red LEDs, blue LEDs, green LEDs, and white LEDs of the backlight M7.

The color table Any Main (FIG. 28I) is a table to select any color of LEDs from the red LEDs, blue LEDs, green LEDs, and white LEDs of the backlight M7.

The tables Red Main, Blue Main, Green Main, White Main, and Any Main represent the color determination tables for selecting any of the two or more colors.

As illustrated in FIGS. 27A and 27B, there are a color table determination table for base game mode and a color table determination table for free game mode. Both of the tables define weights for nine kinds of color tables.

According to the color table determination table for base game mode, the weight for Red Only is 1, the weight for Blue Only is 2, the weight for Green Only is 4, the weight for White Only is 4, the weight for Red Main is 17, the weight for Blue Main is 26, the weight for Green Main is 26, the weight for White Main is 64, and the weight for Any Main is 56.

In the base game mode, the four color tables of Red Only, Blue Only, Green Only, and White Only are determined at low probabilities and the color tables such as White Main and Any Main are determined at high probabilities because of the weights as defined above.

According to the color table determination table for free game mode, the weight for Red Only is 10, the weight for Blue Only is 10, the weight for Green Only is 10, the weight for White Only is 10, the weight for Red Main is 10, the weight for Blue Main is 20, the weight for Green Main is 44, the weight for White Main is 86, and the weight for Any Main is 0.

In the free game mode, the color table Any Main is not selected since the weight for Any Main is 0. The probabilities of five color tables of Red Only, Blue Only, Green Only, White Only, and Red Main are low since their weights are 10; the probability rises in order of Blue Main and Green Main; and the probability that the color table White Main will be determined is the highest.

The color table determination processing in FIG. 25 is processing to select one of the nine color tables of Red Only, Blue Only, Green Only, White Only, Red Main, Blue Main, Green Main, White Main, and Any Main with reference to the color table determination table in FIG. 27A when the game mode is base game mode or the color table determination table in FIG. 27B when the game mode is free game mode.

In the processing in FIG. 26 to be described later, an emission color for each 7 is determined with reference to the color table selected in the color table determination processing of FIG. 25 (see step S2617) and the LEDs are turned on with the LEDs of the emission color selected (see step S2017 in FIG. 20).

### <Emission Color Determination Processing>

FIG. 26 is a subroutine of emission color determination processing.

First, the main CPU 200 acquires stop positions of 7s to appear in the symbol display area 141d of the lower display unit 141 when all the five mech reels M3a to M3e are stopped in the processing of FIG. 20 (step S2611). That is to say, for each of the 7s to appear, the mech reel (M3a, M3b, M3c, M3d, or M3e) and the stop position (the top row, the middle row, or the bottom row) are acquired.

Next, the main CPU 200 acquires the number of 7s to appear in the symbol display area 141d (step S2613).

Next, the main CPU 200 extracts a random number for determining an emission color (step S2615).

Next, the main CPU 200 determines an emission color with reference to the color table (step S2617).

Next, the main CPU 200 determines whether emission colors for all the 7s to appear in the symbol display area 141d have been determined (step S2619). If determining that emission colors for all the 7s to appear in the symbol display area 141d have not been determined, the main CPU 200 returns to step S2615. If determining that emission colors for all the 7s to appear in the symbol display area 141d have been determined, the main CPU 200 exits this subroutine.

Since this processing determines emission colors in accordance with the number of 7s to appear in the symbol display area 141d, the emission colors can be determined separately for all the 7s to appear. For example, in the case where six 7s are to appear in the symbol display area 141d, emission colors can be determined separately for the six 7s so that the six 7s can be individually illuminated in the above-described processing of step S2017 in FIG. 20.

Since the emission colors are determined separately for all the 7s, the 7s can be illuminated in different emission colors. For example, a part of the 7s can be illuminated in red and the other 7s can be illuminated in green.

### <Specific Examples of Determining Emission Colors>

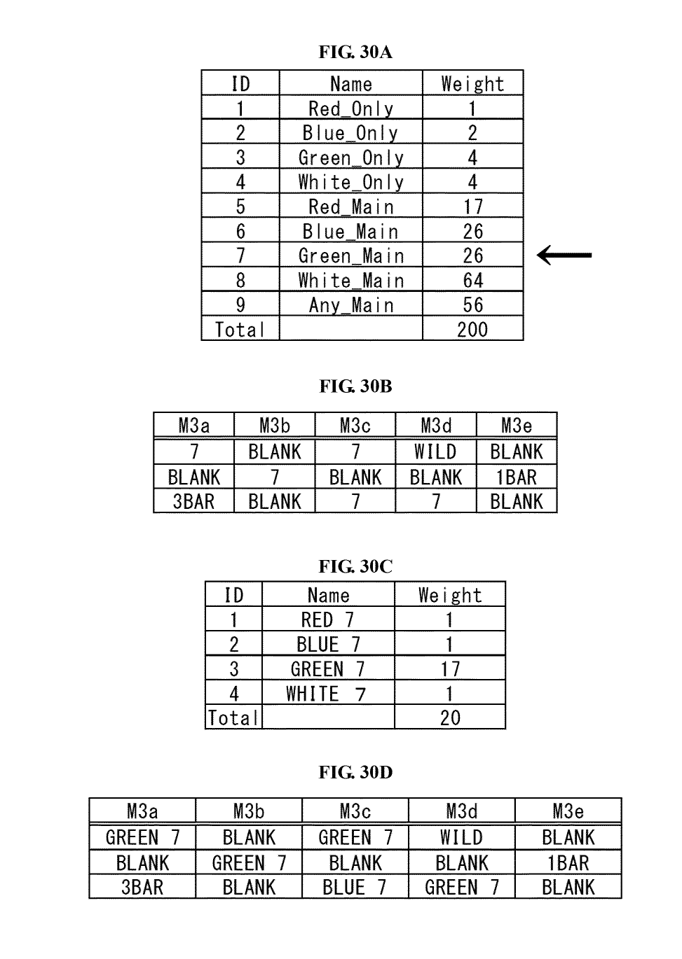

FIGS. 30A to 30D provide drawings for illustrating a specific example of determining emission colors.

First, a color table is determined using the color table determination table shown in FIG. 27A when the game mode is a base game mode (FIG. 30A).

The example in FIG. 30A indicates that the color table Green Main (FIG. 30C=FIG. 28G) is selected out of the nine tables through the color table determination processing of FIG. 25.

Further, symbols are determined to be rearranged as shown in FIG. 30B through the symbol lottery processing of FIG. 19. That is to say, a 7, a BLANK, and a 3BAR are to appear on the top row, the middle row, and the bottom row of the mech reel M3a; a BLANK, a 7, and a BLANK are to appear on the top row, the middle row, and the bottom row of the mech reel M3b; a 7, a BLANK, and a 7 are to appear on the top row, the middle row, and the bottom row of the mech reel M3c; a WILD, a BLANK, and a 7 are to appear on the top row, the middle row, and the bottom row of the mech reel M3d; and a BLANK, a 1BAR, and a BLANK are to appear on the top row, the middle row, and the bottom row of the mech reel M3e.

In the example shown in FIG. 30B, five 7s are to appear on the top row of the mech reel M3a, the middle row of the mech reel M3b, the top row and the bottom row of the mech reel M3c, and the bottom row of the mech reel M3d.

In the processing of step S2611 in the emission color determination processing of FIG. 26, the main CPU 200 acquires the five positions of the top row of the mech reel M3a, the middle row of the mech reel M3b, the top row and the bottom row of the mech reel M3c, and the bottom row of the mech reel M3d. In the processing of step S2613, the main CPU 200 acquires the number of 7s to appear, or 5.

Next, in the processing of steps S2615 to S2619 in the emission color determination processing of FIG. 26, the main CPU 200 determines an emission color for each of the five 7s. As mentioned above, the color table Green Main (FIG. 30C) has been selected in this example; accordingly, the main CPU 200 uses Green Main to determine emission colors for the five 7s.

With reference to the color table Green Main, the 7 on the top row of the mech reel M3a is determined to be green, the 7 on the middle row of the mech reel M3b to be green, the 7 on the top row of the mech reel M3c to be green, the 7 on the bottom row of the mech reel M3c to be blue, and the 7 on the bottom row of the mech reel M3d to be green.

By illuminating the five 7s with the LEDs for emitting light in the colors determined in this way, the final symbols shown in FIG. 30D are determined. The payout table in FIG. 14 is referred to with these determined symbols for winning pattern matching to determine a payout.

As described above, the present embodiment performs winning pattern matching and determines a payout after determining the emission colors for all the 7s to appear. That is to say, the winning pattern matching cannot be conducted at the time of completion of the symbol lottery processing because the colors of 7s are not determined yet. Accordingly, after conducting the symbol lottery processing and determining colors for the 7s to appear, winning pattern matching is conducted.

The above-described example has provided a method that determines emission colors for the 7s to appear after determining the symbols to be rearranged in the symbol display area 141d by determining the symbols through symbol lottery processing of FIG. 19. That is to say, emission colors for the 7s are determined before the five mech reels M3a to M3e are stopped. Since this method determines emission colors before stopping the five mech reels M3a to M3e, the 7s can be illuminated at the instant of the stop of the five mech reels M3a to M3e.

Alternatively, emission colors may be determined after the five mech reels M3a to M3e are stopped and all the symbols have appeared in the symbol display area 141d. Since the five mech reels M3a to M3e are driven by motors, 7s may appear at positions different from the result of symbol lottery processing in the case of stepping out of the motors. Accordingly, detecting the positions of 7s and determining the emission colors after the five mech reels M3a to M3e are stopped enable determination of colors depending on the actual positions of the 7s to properly illuminate the 7s that have appeared on the display.

### <<Predictive/Li-Chi Effects>>

FIGS. 32A to 32C are tables for illustrating outlines of predictive/li-zhi effects. The present embodiment has 34 kinds of predictive/li-zhi effects (combi_{—}01 to combi_{—}34). As shown in FIGS. 32A to 32C, the 34 kinds of predictive/li-zhi effects (combi_{—}01 to combi_{—}34) are assigned priorities in this order. In the present embodiment, “li-zhi” is a state where a specific kind of symbols rearranged on as many mech reels as the number obtained by subtracting one or more from a predetermined number (for example, on at least two mech reels) have made a part of a winning pattern. Since a winning pattern is partially made, the li-zhi state is a high winning-possible state having a high possibility of completing a winning pattern.

The first predictive/li-zhi effects (combi_{—}01) are performed for the pattern where three or more BONUSes appear when the five mech reels M3a to M3e are stopped. In the first predictive/li-zhi effects, the li-zhi effects are started from the mech reel M3c to make a specified pattern (symbol matrix). Specifically, after a li-zhi state is made, three mech reels M3c to M3e are forwarded frame by frame to complete a winning pattern with three or more BONUSes. This pattern corresponds to the first symbol matrix to be described later.

The second predictive/li-zhi effects (combi_{—}02) are performed for the pattern where three or more BONUSes appear when the five mech reels M3a to M3e are stopped. In the second predictive/li-zhi effects, the li-zhi effects are started from the mech reel M3d to make a specified pattern (symbol matrix). Specifically, after a li-zhi state is made, two mech reels M3d and M3e are forwarded frame by frame to complete a winning pattern with three or more BONUSes. This pattern corresponds to the second symbol matrix to be described later.

The third predictive/li-zhi effects (combi_{—}03) are performed for the pattern where three or more BONUSes appear when the five mech reels M3a to M3e are stopped. In the third predictive/li-zhi effects, the li-zhi effects are started from the mech reel M3e to make a specified pattern (symbol matrix). Specifically, after a li-zhi state is made, one mech reel M3e is forwarded frame by frame to complete a winning pattern with three or more BONUSes. This pattern corresponds to the third symbol matrix to be described later.

The fourth predictive/li-zhi effects (combi_{—}04) are performed for the pattern where three or more BONUSes appear when the five mech reels M3a to M3e are stopped. In the fourth predictive/li-zhi effects, the li-zhi effects are started from the mech reel M3c. Specifically, after a li-zhi state is made, three mech reels M3c to M3e perform li-zhi effects to complete a winning pattern with three or more BONUSes. This pattern corresponds to the fourth symbol matrix to be described later.

The fifth predictive/li-zhi effects (combi_{—}05) are performed for the pattern where three or more BONUSes appear when the five mech reels M3a to M3e are stopped. In the fifth predictive/li-zhi effects, the li-zhi effects are started from the mech reel M3d. Specifically, after a li-zhi state is made, two mech reels M3d and M3e perform li-zhi effects to complete a winning pattern with three or more BONUSes. This pattern corresponds to the fifth symbol matrix to be described later.

The sixth predictive/li-zhi effects (combi_{—}06) are performed for the pattern where three or more BONUSes appear when the five mech reels M3a to M3e are stopped. In the sixth predictive/li-zhi effects, the li-zhi effects are started from the mech reel M3e. Specifically, after a li-zhi state is made, one mech reel M3e performs li-zhi effects to complete a winning pattern with three or more BONUSes. This pattern corresponds to the sixth symbol matrix to be described later.

The seventh predictive/li-zhi effects (combi_{—}07) are performed for the pattern where two BONUSes appear when the five mech reels M3a to M3e are stopped. In the seventh predictive/li-zhi effects, the li-zhi effects are started from the mech reel M3c to make a specified pattern (symbol matrix). Specifically, after a li-zhi state is made, three mech reels M3c to M3e are forwarded frame by frame, but a winning pattern is not completed with two BONUSes. This pattern corresponds to the seventh symbol matrix to be described later.

The eighth predictive/li-zhi effects (combi_{—}08) are performed for the pattern where two BONUSes appear when the five mech reels M3a to M3e are stopped. In the eighth predictive/li-zhi effects, the li-zhi effects are started from the mech reel M3d to make a specified pattern (symbol matrix). Specifically, after a li-zhi state is made, two mech reels M3d and M3e are forwarded frame by frame, but a winning pattern is not completed with two BONUSes. This pattern corresponds to the eighth symbol matrix to be described later.

The ninth predictive/li-zhi effects (combi_{—}09) are performed for the pattern where two BONUSes appear when the five mech reels M3a to M3e are stopped. In the ninth predictive/li-zhi effects, the li-zhi effects are started from the mech reel M3e to make a specified pattern (symbol matrix). Specifically, after a li-zhi state is made, one mech reel M3e is forwarded frame by frame, but a winning pattern is not completed with two BONUSes. This pattern corresponds to the ninth symbol matrix to be described later.

The tenth predictive/li-zhi effects (combi_{—}10) are performed for the pattern where two BONUSes appear when the five mech reels M3a to M3e are stopped. In the tenth predictive/li-zhi effects, the li-zhi effects are started from the mech reel M3c. Specifically, after a li-zhi state is made, three mech reels M3c to M3e perform li-zhi effects, but a winning pattern is not completed with two BONUSes. This pattern corresponds to the tenth symbol matrix to be described later.

The eleventh predictive/li-zhi effects (combi_{—}11) are performed for the pattern where two BONUSes appear when the five mech reels M3a to M3e are stopped. In the eleventh predictive/li-zhi effects, the li-zhi effects are started from the mech reel M3d. Specifically, after a li-zhi state is made, two mech reels M3d and M3e perform li-zhi effects, but a winning pattern is not completed with two BONUSes. This pattern corresponds to the eleventh symbol matrix to be described later.

The twelfth predictive/li-zhi effects (combi_{—}12) are performed for the pattern where two BONUSes appear when the five mech reels M3a to M3e are stopped. In the twelfth predictive/li-zhi effects, the li-zhi effects are started from the mech reel M3e. Specifically, after a li-zhi state is made, one mech reel M3e performs li-zhi effects, but a winning pattern is not completed with two BONUSes. This pattern corresponds to the twelfth symbol matrix to be described later.

The 13th predictive/li-zhi effects (combi_{—}13) are performed for the pattern where a 5Kind in RED7 is completed when the five mech reels M3a to M3e are stopped. Specifically, the 13th predictive/li-zhi effects are performed when a color table Red Only (FIG. 28A) is selected and a 5Kind in RED7 is completed.

The 14th predictive/li-zhi effects (combi_{—}14) are performed for the pattern where a 5Kind in BLUE7 is completed when the five mech reels M3a to M3e are stopped. Specifically, the 14th predictive/li-zhi effects are performed when a color table Blue Only (FIG. 28B) is selected and a 5Kind in BLUE7 is completed.

The 15th predictive/li-zhi effects (combi_{—}15) are performed for the pattern where a 5Kind in GREEN7 is completed when the five mech reels M3a to M3e are stopped. Specifically, the 15th predictive/li-zhi effects are performed when a color table Green Only (FIG. 28C) is selected and a 5Kind in GREEN7 is completed.

The 16th predictive/li-zhi effects (combi_{—}16) are performed for the pattern where a 4Kind in RED7 is completed and a 7 appears on the mech reel M3e when the five mech reels M3a to M3e are stopped. Specifically, the 16th predictive/li-zhi effects are performed when a color table Red Only (FIG. 28A) is selected, a 4Kind in RED7 is completed, and the mech reel M3e shows one or more 7s. This pattern corresponds to the 13th symbol matrix to be described later.

The 17th predictive/li-zhi effects (combi_{—}17) are performed for the pattern where a 4Kind in BLUE7 is completed and a 7 appears on the mech reel M3e when the five mech reels M3a to M3e are stopped. Specifically, the 17th predictive/li-zhi effects are performed when a color table Blue Only (FIG. 28B) is selected, a 4Kind in BLUE7 is completed, and the mech reel M3e one or more 7s. This pattern corresponds to the 13th symbol matrix to be described later.

The 18th predictive/li-zhi effects (combi_{—}18) are performed for the pattern where a 4Kind in GREEN7 is completed and a 7 appears on the mech reel M3e when the five mech reels M3a to M3e are stopped. Specifically, the 18th predictive/li-zhi effects are performed when a color table Green Only (FIG. 28C) is selected, a 4Kind in GREEN7 is completed, and the mech reel M3e shows one or more 7s. This pattern corresponds to the 13th symbol matrix to be described later.

The 19th predictive/li-zhi effects (combi_{—}19) are performed for the pattern where a 3Kind in RED7 is completed and a 7 appears on the mech reel M3d when the five mech reels M3a to M3e are stopped. Specifically, the 19th predictive/li-zhi effects are performed when a color table Red Only (FIG. 28A) is selected, a 3Kind in RED7 is completed, and the mech reel M3d shows one or more 7s. This pattern corresponds to the 14th symbol matrix to be described later.

The 20th predictive/li-zhi effects (combi_{—}20) are performed for the pattern where a 3Kind in BLUE7 is completed and a 7 appears on the mech reel M3d when the five mech reels M3a to M3e are stopped. Specifically, the 20th predictive/li-zhi effects are performed when a color table Blue Only (FIG. 28B) is selected, a 3Kind in BLUE7 is completed, and the mech reel M3d shows one or more 7s. This pattern corresponds to the 14th symbol matrix to be described later.

The 21st predictive/li-zhi effects (combi_{—}21) are performed for the pattern where a 3Kind in GREEN7 is completed and a 7 appears on the mech reel M3d when the five mech reels M3a to M3e are stopped. Specifically, the 21st predictive/li-zhi effects are performed when a color table Green Only (FIG. 28C) is selected, a 3Kind in GREEN7 is completed, and the mech reel M3d shows one or more 7s. This pattern corresponds to the 14th symbol matrix to be described later.

The 22nd predictive/li-zhi effects (combi_{—}22) are performed for the pattern where one or more RED7s appear when the five mech reels M3a to M3e are stopped. Specifically, the 22nd predictive/li-zhi effects are performed when a color table Red Only (FIG. 28A) is selected and none of the foregoing 13th, 16th, and 19th effects are applicable.

The 23rd predictive/li-zhi effects (combi_{—}23) are performed for the pattern where one or more BLUE7s appear when the five mech reels M3a to M3e are stopped. Specifically, the 23rd predictive/li-zhi effects are performed when a color table Blue Only (FIG. 28B) is selected and none of the foregoing 14th, 17th, and 20th effects are applicable.

The 24th predictive/li-zhi effects (combi_{—}24) are performed for the pattern where one or more GREEN7s appear when the five mech reels M3a to M3e are stopped. Specifically, the 24th predictive/li-zhi effects are performed when a color table Green Only (FIG. 28C) is selected and none of the foregoing 15th, 18th, and 21st effects are applicable.

The 25th predictive/li-zhi effects (combi_{—}25) are performed for the pattern where a 5Kind in RED7 is completed when the five mech reels M3a to M3e are stopped. Specifically, the 25th predictive/li-zhi effects are performed when a color table Red Main (FIG. 28E), Blue Main (FIG. 28F), Green Main (FIG. 28G), White Main (FIG. 28H), or Any Main (FIG. 28I) is selected and a 5Kind in RED7 is completed.

The 26th predictive/li-zhi effects (combi_{—}26) are performed for the pattern where a 5Kind in BLUE7 is completed when the five mech reels M3a to M3e are stopped. Specifically, the 26th predictive/li-zhi effects are performed when a color table Red Main (FIG. 28E), Blue Main (FIG. 28F), Green Main (FIG. 28G), White Main (FIG. 28H), or Any Main (FIG. 28I) is selected and a 5Kind in BLUE7 is completed.

The 27th predictive/li-zhi effects (combi_{—}27) are performed for the pattern where a 5Kind in GREEN7 is completed when the five mech reels M3a to M3e are stopped. Specifically, the 27th predictive/li-zhi effects are performed when a color table Red Main (FIG. 28E), Blue Main (FIG. 28F), Green Main (FIG. 28G), White Main (FIG. 28H), or Any Main (FIG. 28I) is selected and a 5Kind in GREEN7 is completed.

The 28th predictive/li-zhi effects (combi_{—}28) are performed for the pattern where a 4Kind in RED7 is completed and the mech reel M3e shows one or two RED7s or BLUE7s, or a mixture of a RED7 and a BLUE7 when the five mech reels M3a to M3e are stopped. Specifically, the 28th predictive/li-zhi effects are performed when a color table Red Main (FIG. 28E), Blue Main (FIG. 28F), Green Main (FIG. 28G), White Main (FIG. 28H), or Any Main (FIG. 28I) is selected, a 4Kind in RED7 is completed, and the mech reel M3e shows one or more RED7s or BLUE7s, or a mixture of a RED7 and a BLUE7. This pattern corresponds to the fifteenth symbol matrix to be described later.

The 29th predictive/li-zhi effects (combi_{—}29) are performed for the pattern where a 4Kind in BLUE7 is completed and the mech reel M3e shows one or two RED7s or BLUE7s, or a mixture of a RED7 and a BLUE7 when the five mech reels M3a to M3e are stopped. Specifically, the 29th predictive/li-zhi effects are performed when a color table Red Main (FIG. 28E), Blue Main (FIG. 28F), Green Main (FIG. 28G), White Main (FIG. 28H), or Any Main (FIG. 28I) is selected, a 4Kind in BLUE7 is completed, and the mech reel M3e shows one or more RED7s or BLUE7s, or a mixture of a RED7 and BLUE7. This pattern corresponds to the fifteenth symbol matrix to be described later.

The 30th predictive/li-zhi effects (combi_{—}30) are performed for the pattern where a 4Kind in GREEN7 is completed and the mech reel M3e shows one or two RED7s or BLUE7s, or a mixture of a RED7 and a BLUE7 when the five mech reels M3a to M3e are stopped. Specifically, the 30th predictive/li-zhi effects are performed when a color table Red Main (FIG. 28E), Blue Main (FIG. 28F), Green Main (FIG. 28G), White Main (FIG. 28H), or Any Main (FIG. 28I) is selected, a 4Kind in GREEN7 is completed, and the mech reel M3e shows one or more RED7s or BLUE7s, or a mixture of a RED7 and a BLUE7. This pattern corresponds to the fifteenth symbol matrix to be described later.

The 31st predictive/li-zhi effects (combi_{—}31) are performed for the pattern where a 4Kind in RED7 is completed and the mech reel M3e shows one or two RED7s, BLUE7s, or GREEN7s, or a mixture of any two of a RED7, a BLUE7, and a GREEN7 when the five mech reels M3a to M3e are stopped. Specifically, the 31st predictive/li-zhi effects are performed when a color table Red Main (FIG. 28E), Blue Main (FIG. 28F), Green Main (FIG. 28G), White Main (FIG. 28H), or Any Main (FIG. 28I) is selected, a 4Kind in RED7 is completed, and the mech reel M3e shows one or two RED7s, BLUE7s, or GREEN7s, or a mixture of any two of a RED7, a BLUE7, and a GREEN7. This pattern corresponds to the 16th symbol matrix to be described later.

The 32nd predictive/li-zhi effects (combi_{—}32) are performed for the pattern where a 4Kind in BLUE7 is completed and the mech reel M3e shows one or two RED7s, BLUE7s, or GREEN7s, or a mixture of any two of a RED7, a BLUE7, and a GREEN7 when the five mech reels M3a to M3e are stopped. Specifically, the 32nd predictive/li-zhi effects are performed when a color table Red Main (FIG. 28E), Blue Main (FIG. 28F), Green Main (FIG. 28G), White Main (FIG. 28H), or Any Main (FIG. 28I) is selected, a 4Kind in BLUE7 is completed, and the mech reel M3e shows one or two RED7s, BLUE7s, or GREEN7s, or a mixture of any two of a RED7, a BLUE7, and a GREEN7. This pattern corresponds to the 16th symbol matrix to be described later.

The 33rd predictive/li-zhi effects (combi_{—}33) are performed for the pattern where a 4Kind in GREEN7 is completed and the mech reel M3e shows one or two RED7s, BLUE7s, or GREEN7s, or a mixture of any two of a RED7, a BLUE7, and a GREEN7 when the five mech reels M3a to M3e are stopped. Specifically, the 33rd predictive/li-zhi effects are performed when a color table Red Main (FIG. 28E), Blue Main (FIG. 28F), Green Main (FIG. 28G), White Main (FIG. 28H), or Any Main (FIG. 28I) is selected, a 4Kind in GREEN7 is completed, and the mech reel M3e shows one or two RED7s, BLUE7s, or GREEN7s, or a mixture of any two of a RED7, a BLUE7, and a GREEN7. This pattern corresponds to the 16th symbol matrix to be described later.

The 34th predictive/li-zhi effects (combi_{—}34) are effects for the patterns where none of the foregoing first to 33rd predictive/li-zhi effects are applicable.

### <<Conditions for Symbol Matrices>>

Hereinafter, conditions for the symbol matrices are described. A symbol matrix is formed of symbols rearranged in the symbol display area 141d of the lower display unit 141 when the five mech reels M3a to M3e are stopped.

### <First Symbol Matrix>

The first symbol matrix is a symbol matrix satisfying the conditions that two BONUSes appear on the mech reels M3a and M3b and one or more BONUSes appear on the mech reels M3c to M3e. Accordingly, three or more BONUSes are shown to complete a free game mode trigger. Specifically, the first symbol matrix can be formed when the symbol of code No. 17, 18 or 19 is selected for the mech reel M3a, the symbol of code No. 17, 18 or 19 for the mech reel M3b, the symbol of code No. 16, 17, 18, 19, or 20 for the mech reel M3c, the symbol of code No. 16, 17, 18, 19, or 20 for the mech reel M3d, and the symbol of code No. 16, 17, 18, 19, or 20 for the mech reel M3e in the symbol lottery processing. However, the condition that the symbols of code No. 16 are selected together for the mech reels M3c to M3e and the condition that the symbols of code No. 20 are selected together for the mech reels M3c to M3e are excluded. When the symbols of code No. 16 are selected together for the mech reels M3c to M3e and when the symbols of code No. 20 are selected together for the mech reels M3c to M3e, no BONUS appears on the mech reels M3c to M3e so that three or more BONUSes in total cannot appear in the symbol matrix. Accordingly, these conditions should be excluded.

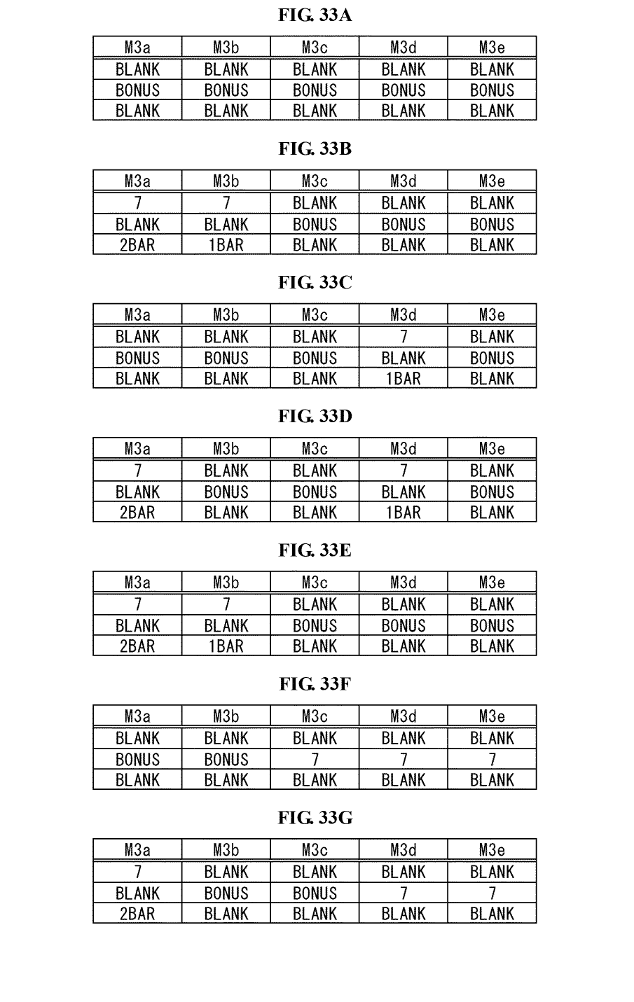

For example, the first symbol matrix can be formed when a BLANK (17), a BONUS (18), and BLANK (19) respectively appear on the top row, the middle row, and the bottom row of the mech reel M3a; a BLANK (17), a BONUS (18), and BLANK (19) respectively appear on the top row, the middle row, and the bottom row of the mech reel M3b; a BLANK (17), a BONUS (18), and BLANK (19) respectively appear on the top row, the middle row, and the bottom row of the mech reel M3c; a BLANK (17), a BONUS (18), and BLANK (19) respectively appear on the top row, the middle row, and the bottom row of the mech reel M3d; and a BLANK (17), a BONUS (18), and BLANK (19) respectively appear on the top row, the middle row, and the bottom row of the mech reel M3e (see FIG. 33A). In the foregoing sentence, the numerals in the parentheses following the symbols are the code numbers indicated in FIGS. 15 and 16.

### <Second Symbol Matrix>

The second symbol matrix is a symbol matrix satisfying the conditions that two BONUSes appear on the mech reels M3a to M3c and one or more BONUSes appear on the mech reels M3d and M3e, and a li-zhi state is not made with the mech reel M3b. At the final phase, three or more BONUSes are shown to complete a free game mode trigger. This second symbol matrix has two patterns.

The first pattern of the second symbol matrix can be formed when the symbol of code No. 17, 18 or 19 is selected for the mech reel M3a, the symbol of any one of the symbol code Nos. 0 to 16, 20, and 21 for the mech reel M3b, the symbol of code No. 17, 18, or 19 for the mech reel M3c, the symbol of code No. 16, 17, 18, 19, or 20 for the mech reel M3d, and the symbol of code No. 16, 17, 18, 19, or 20 for the mech reel M3e in the symbol lottery processing. However, the condition that the symbols of code No. 16 are selected together for the mech reels M3d and M3e and the condition that the symbols of code No. 20 are selected together for the mech reels M3d and M3e are excluded. When the symbols of code No. 16 are selected together for the mech reels M3d and M3e and when the symbols of code No. 20 are selected together for the mech reels M3d and M3e, no BONUS appears on the mech reels M3d and M3e so that three or more BONUSes in total cannot appear on the symbol matrix. Accordingly, these conditions should be excluded.

The second pattern of the second symbol matrix can be formed when the symbol of any one of the symbol code Nos. 0 to 16, 20, and 21 is selected for the mech reel M3a, the symbol of code No. 17, 18 or 19 for the mech reel M3b, the symbol of code No. 17, 18, or 19 for the mech reel M3c, the symbol of code No. 16, 17, 18, 19, or 20 for the mech reel M3d, and the symbol of code No. 16, 17, 18, 19, or 20 for the mech reel M3e in the symbol lottery processing. However, the condition that the symbols of code No. 16 are selected together for the mech reels M3d and M3e and the condition that the symbols of code No. 20 are selected together for the mech reels M3d and M3e are excluded. When the symbols of code No. 16 are selected together for the mech reels M3d and M3e and when the symbols of code No. 20 are selected together for the mech reels M3d and M3e, no BONUS appears on the mech reels M3d and M3e so that three or more BONUSes in total cannot appear on the symbol matrix. Accordingly, these conditions should be excluded.

For example, the second symbol matrix can be formed when a BLANK (17), a BONUS (18), and BLANK (19) respectively appear on the top row, the middle row, and the bottom row of the mech reel M3a; a BLANK (17), a BONUS (18), and BLANK (19) respectively appear on the top row, the middle row, and the bottom row of the mech reel M3b; a BLANK (17), a BONUS (18), and BLANK (19) respectively appear on the top row, the middle row, and the bottom row of the mech reel M3c; a BLANK (17), a BONUS (18), and BLANK (19) respectively appear on the top row, the middle row, and the bottom row of the mech reel M3d; and a BLANK (17), a BONUS (18), and BLANK (19) respectively appear on the top row, the middle row, and the bottom row of the mech reel M3e (see FIG. 33A). In the foregoing sentence, the numerals in the parentheses following the symbols are the code numbers indicated in FIGS. 15 and 16.

### <Third Symbol Matrix>

The third symbol matrix is a symbol matrix satisfying the conditions that two BONUSes appear on the mech reels M3a to M3d and one BONUS appears on the mech reel M3e, and a li-zhi state is not made with the mech reel M3b or M3c. At the final phase, three or more BONUSes are shown to complete a free game mode trigger. This third symbol matrix has three patterns.

The first pattern of the third symbol matrix can be formed when the symbol of code No. 17, 18 or 19 is selected for the mech reel M3a, the symbol of any one of the symbol code Nos. 0 to 16, 20, and 21 for the mech reel M3b, the symbol of any one of the symbol code Nos. 0 to 16, 20, and 21 for the mech reel M3c, the symbol of code No. 17, 18, or 19 for the mech reel M3d, and the symbol of code No. 17, 18, or 19 for the mech reel M3e in the symbol lottery processing.

The second pattern of the third symbol matrix can be formed when the symbol of any one of the symbol code Nos. 0 to 16, 20, and 21 is selected for the mech reel M3a, the symbol of code No.

17, 18 or 19 for the mech reel M3b, the symbol of any one of the symbol code Nos. 0 to 16, 20, and 21 for the mech reel M3c, the symbol of code No. 17, 18, or 19 for the mech reel M3d, and the symbol of code No. 17, 18, or 19 for the mech reel M3e in the symbol lottery processing.

The third pattern of the third symbol matrix can be formed when the symbol of any one of the symbol code Nos. 0 to 16, 20, and 21 is selected for the mech reel M3a, the symbol of any one of the symbol code Nos. 0 to 16, 20, and 21 for the mech reel M3b, the symbol of code No. 17, 18 or 19 for the mech reel M3c, the symbol of code No. 17, 18, or 19 for the mech reel M3d, and the symbol of code No. 17, 18, or 19 for the mech reel M3e in the symbol lottery processing.

For example, the third symbol matrix can be formed when a 7 (14), a BLANK (15), and a 2BAR (16) respectively appear on the top row, the middle row, and the bottom row of the mech reel M3a; a 7 (14), a BLANK (15), and a 1BAR (16) respectively appear on the top row, the middle row, and the bottom row of the mech reel M3b; a BLANK (17), a BONUS (18), and BLANK (19) respectively appear on the top row, the middle row, and the bottom row of the mech reel M3c; a BLANK (17), a BONUS (18), and BLANK (19) respectively appear on the top row, the middle row, and the bottom row of the mech reel M3d; and a BLANK (17), a BONUS (18), and BLANK (19) respectively appear on the top row, the middle row, and the bottom row of the mech reel M3e (see FIG. 33B). In the foregoing sentence, the numerals in the parentheses following the symbols are the code numbers indicated in FIGS. 15 and 16.

### <Fourth Symbol Matrix>

The fourth symbol matrix is a symbol matrix satisfying the conditions that two BONUSes appear on the mech reels M3a and M3b and one or more BONUSes appear on the mech reels M3c to M3e, and the first symbol matrix is excluded. At the final phase, three or more BONUSes are shown to complete a free game mode trigger.

For example, the fourth symbol matrix can be formed when a BLANK (17), a BONUS (18), and BLANK (19) respectively appear on the top row, the middle row, and the bottom row of the mech reel M3a; a BLANK (17), a BONUS (18), and BLANK (19) respectively appear on the top row, the middle row, and the bottom row of the mech reel M3b; a BLANK (17), a BONUS (18), and BLANK (19) respectively appear on the top row, the middle row, and the bottom row of the mech reel M3c; a 7 (14), a BLANK (15), and a 1BAR (16) respectively appear on the top row, the middle row, and the bottom row of the mech reel M3d; and a BLANK (17), a BONUS (18), and BLANK (19) respectively appear on the top row, the middle row, and the bottom row of the mech reel M3e (see FIG. 33C). In the foregoing sentence, the numerals in the parentheses following the symbols are the code numbers indicated in FIGS. 15 and 16.

### <Fifth Symbol Matrix>

The fifth symbol matrix is a symbol matrix satisfying the conditions that two BONUSes appear on the mech reels M3a to M3c and one or more BONUSes appear on the mech reels M3d and M3e, a li-zhi state is not made with the mech reel M3b, and the second symbol matrix is excluded. At the final phase, three or more BONUSes are shown to complete a free game mode trigger.

For example, the fifth symbol matrix can be formed when 7 (14), a BLANK (15), and a 2BAR (16) respectively appear on the top row, the middle row, and the bottom row of the mech reel M3a; a BLANK (17), a BONUS (18), and BLANK (19) respectively appear on the top row, the middle row, and the bottom row of the mech reel M3b; a BLANK (17), a BONUS (18), and BLANK (19) respectively appear on the top row, the middle row, and the bottom row of the mech reel M3c; a 7 (14), a BLANK (15), and a 1BAR (16) respectively appear on the top row, the middle row, and the bottom row of the mech reel M3d; and a BLANK (17), a BONUS (18), and BLANK (19) respectively appear on the top row, the middle row, and the bottom row of the mech reel M3e (see FIG. 33D). In the foregoing sentence, the numerals in the parentheses following the symbols are the code numbers indicated in FIGS. 15 and 16.

### <Sixth Symbol Matrix>

The sixth symbol matrix is a symbol matrix satisfying the conditions that two BONUSes appear on the mech reels M3a to M3d and one BONUS appears on the mech reel M3e, a li-zhi state is not made with the mech reel M3b or M3c, and the third symbol matrix is excluded. At the final phase, three or more BONUSes are shown to complete a free game mode trigger.

For example, the sixth symbol matrix can be formed when 7 (14), a BLANK (15), and a 2BAR (16) respectively appear on the top row, the middle row, and the bottom row of the mech reel M3a; a 7 (14), a BLANK (15), and a 1BAR (16) respectively appear on the top row, the middle row, and the bottom row of the mech reel M3b; a BLANK (17), a BONUS (18), and BLANK (19) respectively appear on the top row, the middle row, and the bottom row of the mech reel M3c; a BLANK (17), a BONUS (18), and BLANK (19) respectively appear on the top row, the middle row, and the bottom row of the mech reel M3d; and a BLANK (17), a BONUS (18), and BLANK (19) respectively appear on the top row, the middle row, and the bottom row of the mech reel M3e (see FIG. 33E). In the foregoing sentence, the numerals in the parentheses following the symbols are the code numbers indicated in FIGS. 15 and 16.

### <Seventh Symbol Matrix>

The seventh symbol matrix is a symbol matrix satisfying the conditions that two BONUSes appear on the mech reels M3a and M3b and no BONUS appears on the mech reels M3c to M3e. At the final phase, three or more BONUSes are not shown so that a free game mode trigger is not completed.

Specifically, the seventh symbol matrix can be formed when the symbol of code No. 17, 18 or 19 is selected for the mech reel M3a, the symbol of code No. 17, 18 or 19 for the mech reel M3b, the symbol of code No. 16 or 20 for the mech reel M3c, the symbol of code No. 16 or 20 for the mech reel M3d, and the symbol of code No. 16 or 20 for the mech reel M3e.

For example, the seventh symbol matrix can be formed when BLANK (17), a BONUS (18), and BLANK (19) respectively appear on the top row, the middle row, and the bottom row of the mech reel M3a; a BLANK (17), a BONUS (18), and BLANK (19) respectively appear on the top row, the middle row, and the bottom row of the mech reel M3b; a BLANK (19), a 7 (20), and a BLANK (21) respectively appear on the top row, the middle row, and the bottom row of the mech reel M3c; a BLANK (19), a 7 (20), and a BLANK (21) respectively appear on the top row, the middle row, and the bottom row of the mech reel M3d; and a BLANK (19), a 7 (20), and a BLANK (21) respectively appear on the top row, the middle row, and the bottom row of the mech reel M3e (see FIG. 33F). In the foregoing sentence, the numerals in the parentheses following the symbols are the code numbers indicated in FIGS. 15 and 16.

### <Eighth Symbol Matrix>

The eighth symbol matrix is a symbol matrix satisfying the conditions that two BONUSes appear on the mech reels M3a to M3c, no BONUS appears on the mech reels M3d and M3e, and a li-zhi state is not made with the mech reel M3b. At the final phase, three or more BONUSes are not shown so that a free game mode trigger is not completed. This eighth symbol matrix has two patterns.

The first pattern of the eighth symbol matrix can be formed when the symbol of code No. 17, 18 or 19 is selected for the mech reel M3a, the symbol of any one of the symbol code Nos. 0 to 16, 20, and 21 for the mech reel M3b, the symbol of code No. 17, 18, or 19 for the mech reel M3c, the symbol of code No. 16 or 20 for the mech reel M3d, and the symbol of code No. 16 or 20 for the mech reel M3e in the symbol lottery processing.

The second pattern of the eighth symbol matrix can be formed by selecting the symbol of any one of the symbol code Nos. 0 to 16, 20, and 21 for the mech reel M3a, the symbol of code No. 17, 18 or 19 for the mech reel M3b, the symbol of code No. 17, 18, or 19 for the mech reel M3c, the symbol of code No. 16 or 20 for the mech reel M3d, and the symbol of code No. 16 or 20 for the mech reel M3e in the symbol lottery processing.

For example, the eighth symbol matrix can be formed when a 7 (14), a BLANK (15), and a 2BAR (16) respectively appear on the top row, the middle row, and the bottom row of the mech reel M3a; a BLANK (17), a BONUS (18), and a BLANK (19) respectively appear on the top row, the middle row, and the bottom row of the mech reel M3b; a BLANK (17), a BONUS (18), and a BLANK (19) respectively appear on the top row, the middle row, and the bottom row of the mech reel M3c; a BLANK (19), a 7 (20), and a BLANK (21) respectively appear on the top row, the middle row, and the bottom row of the mech reel M3d; and a BLANK (19), a 7 (20), and a BLANK (21) respectively appear on the top row, the middle row, and the bottom row of the mech reel M3e (see FIG. 33G). In the foregoing sentence, the numerals in the parentheses following the symbols are the code numbers indicated in FIGS. 15 and 16.

### <Ninth Symbol Matrix>

The ninth symbol matrix is a symbol matrix satisfying the conditions that two BONUSes appear on the mech reels M3a to M3d, no BONUS appears on the mech reel M3e, and a li-zhi state is not made with the mech reel M3b or M3c. At the final phase, three or more BONUSes are not shown so that a free game mode trigger is not completed. This ninth symbol matrix has three patterns.

The first pattern of the ninth symbol matrix can be formed when the symbol of code No. 17, 18 or 19 is selected for the mech reel M3a, the symbol of any one of the symbol code Nos. 0 to 16, 20, and 21 for the mech reel M3b, the symbol of any one of the symbol code Nos. 0 to 16, 20, and 21 for the mech reel M3c, the symbol of code No. 17, 18 or 19 for the mech reel M3d, and the symbol of code No. 16 or 20 for the mech reel M3e in the symbol lottery processing.

The second pattern of the ninth symbol matrix can be formed when the symbol of any one of the symbol code Nos. 0 to 16, 20, and 21 is selected for the mech reel M3a, the symbol of code No. 17, 18 or 19 for the mech reel M3b, the symbol of any one of the symbol code Nos. 0 to 16, 20, and 21 for the mech reel M3c, the symbol of code No. 17, 18 or 19 for the mech reel M3d, and the symbol of code No. 16 or 20 for the mech reel M3e in the symbol lottery processing.

The third pattern of the ninth symbol matrix can be formed when the symbol of any one of the symbol code Nos. 0 to 16, 20, and 21 is selected for the mech reel M3a, the symbol of any one of the symbol code Nos. 0 to 16, 20, and 21 for the mech reel M3b, the symbol of code No. 17, 18 or 19 for the mech reel M3c, the symbol of code No. 17, 18 or 19 for the mech reel M3d, and the symbol of code No. 16 or 20 for the mech reel M3e in the symbol lottery processing.

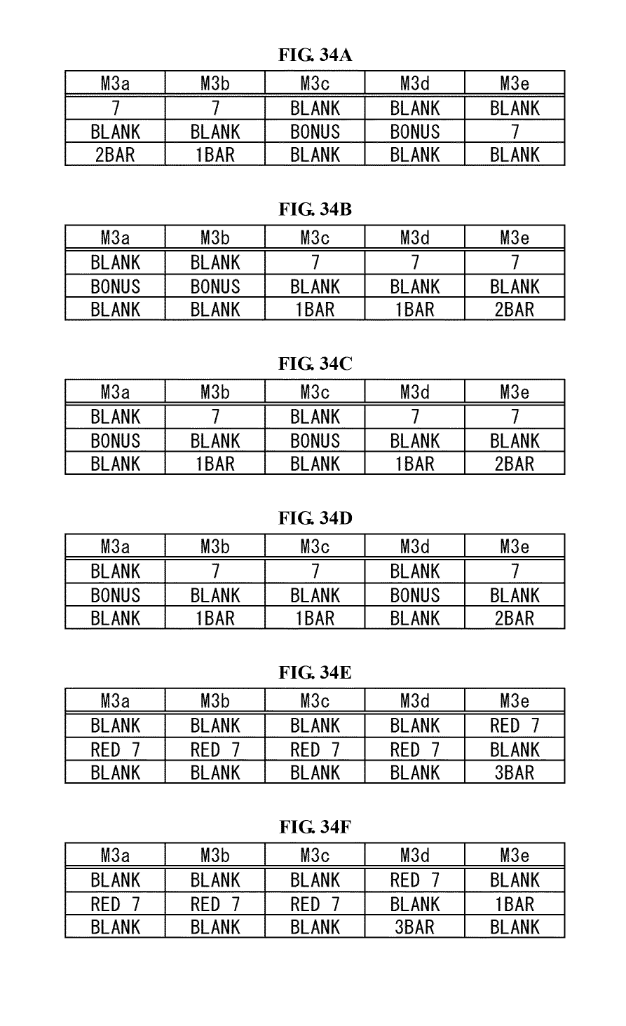

For example, the ninth symbol matrix can be formed when a 7 (14), a BLANK (15), and a 2BAR (16) respectively appear on the top row, the middle row, and the bottom row of the mech reel M3a; a 7 (14), a BLANK (15), and a 1BAR (16) respectively appear on the top row, the middle row, and the bottom row of the mech reel M3b; a BLANK (17), a BONUS (18), and a BLANK (19) respectively appear on the top row, the middle row, and the bottom row of the mech reel M3c; a BLANK (17), a BONUS (18), and a BLANK (19) respectively appear on the top row, the middle row, and the bottom row of the mech reel M3d; and a BLANK (19), a 7 (20), and a BLANK (21) respectively appear on the top row, the middle row, and the bottom row of the mech reel M3e (see FIG. 34A). In the foregoing sentence, the numerals in the parentheses following the symbols are the code numbers indicated in FIGS. 15 and 16.

### <Tenth Symbol Matrix>

The tenth symbol matrix is a symbol matrix satisfying the conditions that two BONUSes appear on the mech reels M3a and M3b and no BONUS appears on the mech reels M3c to M3e. At the final phase, three or more BONUSes are not shown so that a free game mode trigger is not completed.

For example, the tenth symbol matrix can be formed when a BLANK (17), a BONUS (18), and a BLANK (19) respectively appear on the top row, the middle row, and the bottom row of the mech reel M3a; a BLANK (17), a BONUS (18), and a BLANK (19) respectively appear on the top row, the middle row, and the bottom row of the mech reel M3b; a 7 (14), a BLANK (15), and a 1BAR (16) respectively appear on the top row, the middle row, and the bottom row of the mech reel M3c; a 7 (14), a BLANK (15), and a 1BAR (16) respectively appear on the top row, the middle row, and the bottom row of the mech reel M3d; and a 7 (14), a BLANK (15), and a 2BAR (16) respectively appear on the top row, the middle row, and the bottom row of the mech reel M3e (see FIG. 34B). In the foregoing sentence, the numerals in the parentheses following the symbols are the code numbers indicated in FIGS. 15 and 16.

### <Eleventh Symbol Matrix>

The eleventh symbol matrix is a symbol matrix satisfying the conditions that two BONUSes appear on the mech reels M3a to M3c, no BONUS appears on the mech reels M3d and M3e, and a li-zhi state is not made with the mech reel M3b. At the final phase, three or more BONUSes are not shown so that a free game mode trigger is not completed.

For example, the eleventh symbol matrix can be formed when a BLANK (17), a BONUS (18), and a BLANK (19) respectively appear on the top row, the middle row, and the bottom row of the mech reel M3a; a 7 (14), a BLANK (15), and a 1BAR (16) respectively appear on the top row, the middle row, and the bottom row of the mech reel M3b; a BLANK (17), a BONUS (18), and a BLANK (19) respectively appear on the top row, the middle row, and the bottom row of the mech reel M3c; a 7 (14), a BLANK (15), and a 1BAR (16) respectively appear on the top row, the middle row, and the bottom row of the mech reel M3d; and a 7 (14), a BLANK (15), and a 2BAR (16) respectively appear on the top row, the middle row, and the bottom row of the mech reel M3e (see FIG. 34C). In the foregoing sentence, the numerals in the parentheses following the symbols are the code numbers indicated in FIGS. 15 and 16.

### <Twelfth Symbol Matrix>

The twelfth symbol matrix is a symbol matrix satisfying the conditions that two BONUSes appear on the mech reels M3a to M3d, no BONUS appears on the mech reel M3e, and a li-zhi state is not made with the mech reel M3b or M3c. At the final phase, three or more BONUSes are not shown so that a free game mode trigger is not completed.

For example, the twelfth symbol matrix can be formed when a BLANK (17), a BONUS (18), and a BLANK (19) respectively appear on the top row, the middle row, and the bottom row of the mech reel M3a; a 7 (14), a BLANK (15), and a 1BAR (16) respectively appear on the top row, the middle row, and the bottom row of the mech reel M3b; a 7 (14), a BLANK (15), and a 1BAR (16) respectively appear on the top row, the middle row, and the bottom row of the mech reel M3c; a BLANK (17), a BONUS (18), and a BLANK (19) respectively appear on the top row, the middle row, and the bottom row of the mech reel M3d; and a 7 (14), a BLANK (15), and a 2BAR (16) respectively appear on the top row, the middle row, and the bottom row of the mech reel M3e (see FIG. 34D). In the foregoing sentence, the numerals in the parentheses following the symbols are the code numbers indicated in FIGS. 15 and 16.

### <Thirteenth Symbol Matrix>

The thirteenth symbol matrix is a symbol matrix satisfying the conditions that a 4Kind in 7 is completed and a 5Kind in 7 is not completed because of the position of a 7 on the mech reel M3e.

For example, the thirteenth symbol matrix can be formed when a BLANK (13), a RED7 (14), and a BLANK (15) respectively appear on the top row, the middle row, and the bottom row of the mech reel M3a; a BLANK (13), a RED7 (14), and a BLANK (15) respectively appear on the top row, the middle row, and the bottom row of the mech reel M3b; a BLANK (13), a RED7 (14), and a BLANK (15) respectively appear on the top row, the middle row, and the bottom row of the mech reel M3c; a BLANK (13), a RED7 (14), and a BLANK (15) respectively appear on the top row, the middle row, and the bottom row of the mech reel M3d; and a RED7 (8), a BLANK (9), and a 3BAR (10) respectively appear on the top row, the middle row, and the bottom row of the mech reel M3e (see FIG. 34E). In the foregoing sentence, the numerals in the parentheses following the symbols are the code numbers indicated in FIGS. 15 and 16.

### <Fourteenth Symbol Matrix>

The fourteenth symbol matrix is a symbol matrix satisfying the conditions that a 3Kind in 7 is completed and a 4Kind in 7 is not completed because of the position of a 7 on the mech reel M3d. For example, the fourteenth symbol matrix can be formed when a BLANK (13), a RED7 (14), and a BLANK (15) respectively appear on the top row, the middle row, and the bottom row of the mech reel M3a; a BLANK (13), a RED7 (14), and a BLANK (15) respectively appear on the top row, the middle row, and the bottom row of the mech reel M3b; a BLANK (13), a RED7 (14), and a BLANK (15) respectively appear on the top row, the middle row, and the bottom row of the mech reel M3c; a RED7 (8), a BLANK (9), and a 3BAR (10) respectively appear on the top row, the middle row, and the bottom row of the mech reel M3d; and a BLANK (5), and a 1BAR (6), and a BLANK (7) respectively appear on the top row, the middle row, and the bottom row of the mech reel M3e, (see FIG. 34F). In the foregoing sentence, the numerals in the parentheses following the symbols are the code numbers indicated in FIGS. 15 and 16.

### <Fifteenth Symbol Matrix>

The fifteenth symbol matrix is a symbol matrix satisfying the conditions that a 4Kind in 7 is completed and a 5Kind in 7 is not completed because of the position or color (red or blue) of a 7 on the mech reel M3e. This fifteenth symbol matrix has two patterns.

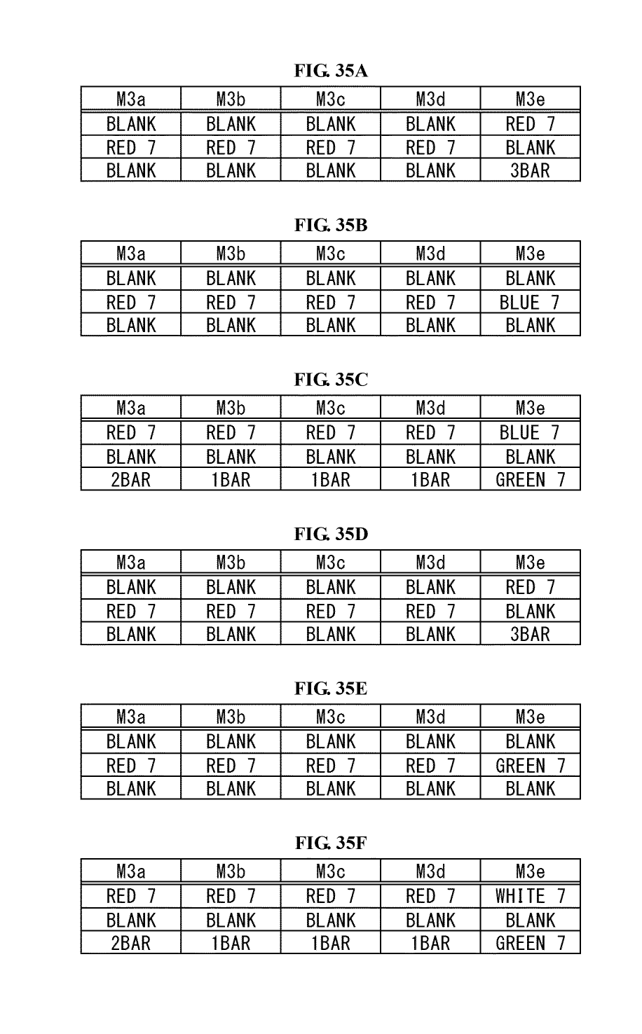

The first pattern of the fifteenth symbol matrix is formed when a BLANK (13), a RED7 (14), and a BLANK (15) respectively appear on the top row, the middle row, and the bottom row of the mech reel M3a; a BLANK (13), a RED7 (14), and a BLANK (15) respectively appear on the top row, the middle row, and the bottom row of the mech reel M3b; a BLANK (13), a RED7 (14), and a BLANK (15) respectively appear on the top row, the middle row, and the bottom row of the mech reel M3c; a BLANK (13), a RED7 (14), and a BLANK (15) respectively appear on the top row, the middle row, and the bottom row of the mech reel M3d; and a RED7 (8), a BLANK (9), and a 3BAR (10) respectively appear on the top row, the middle row, and the bottom row of the mech reel M3e (see FIG. 35A). In the foregoing sentence, the numerals in the parentheses following the symbols are the code numbers indicated in FIGS. 15 and 16.

The second pattern of the fifteenth symbol matrix is formed when a BLANK (13), a RED7 (14), and a BLANK (15) respectively appear on the top row, the middle row, and the bottom row of the mech reel M3a; a BLANK (13), a RED7 (14), and a BLANK (15) respectively appear on the top row, the middle row, and the bottom row of the mech reel M3b; a BLANK (13), a RED7 (14), and a BLANK (15) respectively appear on the top row, the middle row, and the bottom row of the mech reel M3c; a BLANK (13), a RED7 (14), and a BLANK (15) respectively appear on the top row, the middle row, and the bottom row of the mech reel M3d; and a BLANK (13), a BLUE7 (14), and a BLANK (15) respectively appear on the top row, the middle row, and the bottom row of the mech reel M3e (see FIG. 35B). In the foregoing sentence, the numerals in the parentheses following the symbols are the code numbers indicated in FIGS. 15 and 16.

An example of a pattern that does not match the fifteenth symbol matrix is a pattern formed of a RED7 (14), a BLANK (15), and a 2BAR (16) respectively shown on the top row, the middle row, and the bottom row of the mech reel M3a; a RED7 (14), a BLANK (15), and a 1BAR (16) respectively shown on the top row, the middle row, and the bottom row of the mech reel M3b; a RED7 (14), a BLANK (15), and a 1BAR (16) respectively shown on the top row, the middle row, and the bottom row of the mech reel M3c; a RED7 (14), a BLANK (15), and a 1BAR (16) respectively shown on the top row, the middle row, and the bottom row of the mech reel M3d; and a BLUE7 (12), a BLANK (13), and a GREEN7 (14) respectively shown on the top row, the middle row, and the bottom row of the mech reel M3e (see FIG. 35C). Patterns including a WHITE7 or a GREEN7 do not satisfy the conditions of the fifteenth symbol matrix. In the foregoing sentence, the numerals in the parentheses following the symbols are the code numbers indicated in FIGS. 15 and 16.

### <Sixteenth Symbol Matrix>

The sixteenth symbol matrix is a symbol matrix satisfying the conditions that a 4Kind in 7 is completed and a 5Kind in 7 is not completed because of the position or color (red, blue, or green) of the 7 on the mech reel M3e. This sixteenth symbol matrix has two patterns.

The first pattern of the sixteenth symbol matrix is formed when a BLANK (13), a RED7 (14), and a BLANK (15) respectively appear on the top row, the middle row, and the bottom row of the mech reel M3a; a BLANK (13), a RED7 (14), and a BLANK (15) respectively appear on the top row, the middle row, and the bottom row of the mech reel M3b; a BLANK (13), a RED7 (14), and a BLANK (15) respectively appear on the top row, the middle row, and the bottom row of the mech reel M3c; a BLANK (13), a RED7 (14), and a BLANK (15) respectively appear on the top row, the middle row, and the bottom row of the mech reel M3d; and a RED7 (8), a BLANK (9), and a 3BAR (10) respectively appear on the top row, the middle row, and the bottom row of the mech reel M3e (see FIG. 35D). In the foregoing sentence, the numerals in the parentheses following the symbols are the code numbers indicated in FIGS. 15 and 16.

The second pattern of the sixteenth symbol matrix is formed when a BLANK (13), a RED7 (14), and a BLANK (15) respectively appear on the top row, the middle row, and the bottom row of the mech reel M3a; a BLANK (13), a RED7 (14), and a BLANK (15) respectively appear on the top row, the middle row, and the bottom row of the mech reel M3b; a BLANK (13), a RED7 (14), and a BLANK (15) respectively appear on the top row, the middle row, and the bottom row of the mech reel M3c; a BLANK (13), a RED7 (14), and a BLANK (15) respectively appear on the top row, the middle row, and the bottom row of the mech reel M3d; and a BLANK (13), a GREEN7 (14), and a BLANK (15) respectively appear on the top row, the middle row, and the bottom row of the mech reel M3e (see FIG. 35E). In the foregoing sentence, the numerals in the parentheses following the symbols are the code numbers indicated in FIGS. 15 and 16.

An example of a pattern that does not match the sixteenth symbol matrix is a pattern formed of a RED7 (14), a BLANK (15), and a 2BAR (16) respectively shown on the top row, the middle row, and the bottom row of the mech reel M3a; a RED7 (14), a BLANK (15), and a 1BAR (16) respectively shown on the top row, the middle row, and the bottom row of the mech reel M3b; a RED7 (14), a BLANK (15), and a 1BAR (16) respectively shown on the top row, the middle row, and the bottom row of the mech reel M3c; a RED7 (14), a BLANK (15), and a 1BAR (16) respectively shown on the top row, the middle row, and the bottom row of the mech reel M3d; and a WHITE7 (12), a BLANK (13), and a GREEN7 (14) respectively shown on the top row, the middle row, and the bottom row of the mech reel M3e (see FIG. 35F). Patterns including a WHITE7 do not satisfy the conditions of the sixteenth symbol matrix. In the foregoing sentence, the numerals in the parentheses following the symbols are the code numbers indicated in FIGS. 15 and 16.

### <<Specifics of Predictive/Li-Zhi Effects>>

### <Predictive Effects>

There are thirty kinds of predictive effects in the present embodiment: δ normal, δ reverse normal, a two simultaneous stops 1 to α two simultaneous stops 12, β three simultaneous stops 1 to β three simultaneous stops 8, and γ four simultaneous stops 1 to γ four simultaneous stops 8. The effects δ normal provides motion that all the five mech reels M3a to M3e spin forward. The δ reverse normal provides motion that all the five mech reels M3a to M3e spin reversely. For predictive effects from the start of spinning of the five mech reels M3a to M3e until the intermediate state where at least one mech reel stops and the remaining mech reels keep spinning, one of thirty kinds of predictive effects are selected in accordance with the to-be stopped symbol matrix. Thirty kinds of predictive effects are selectively performed so that diverse reel motion variations can be provided based on the to-be stopped symbol matrix.

The twelve kinds of predictive effects α two simultaneous stops 1 to a two simultaneous stops 12 provide motion that two of the five mech reels M3a to M3e stop simultaneously. Accordingly, the remaining three mech reels M3 keep spinning.

In a two simultaneous stops 1 (↓↓↓↓↓), after the five mech reels M3a to M3e spin forward for a predetermined time, two mech reels M3a and M3b stop and the remaining three mech reels M3c, M3d, and M3e keep spinning.

In α two simultaneous stops 2 (↑↑↓↓↓), after two mech reels M3a and M3b spin reversely and the remaining three mech reels M3c, M3d, and M3e spin forward for a predetermined time, two mech reels M3a and M3b stop and the remaining three mech reels M3c, M3d, and M3e keep spinning.

In α two simultaneous stops 3 (↓↓↓↓↓), after the five mech reels M3a to M3e spin forward for a predetermined time, two mech reels M3a and M3e stop and the remaining three mech reels M3b, M3c, and M3d keep spinning.

In α two simultaneous stops 4 (↑↓↓↓↑), after two mech reels M3a and M3e spin reversely and the remaining three mech reels M3b, M3c, and M3d spin forward for a predetermined time, two mech reels M3a and M3e stop and the remaining three mech reels M3b, M3c, and M3d keep spinning.

In α two simultaneous stops 5 (↓↓↓↓↓), after the five mech reels M3a to M3e spin forward for a predetermined time, two mech reels M3b and M3d stop and the remaining three mech reels M3a, M3c, and M3e keep spinning.

In α two simultaneous stops 6 (↓↑↓↑↓), after two mech reels M3b and M3d spin reversely and the remaining three mech reels M3a, M3c, and M3e spin forward for a predetermined time, two mech reels M3b and M3d stop and the remaining three mech reels M3a, M3c, and M3e keep spinning.

In α two simultaneous stops 7 (↓↓↑↑↑), after two mech reels M3a and M3b spin forward and the remaining three mech reels M3c, M3d, and M3e spin reversely for a predetermined time, two mech reels M3a and M3b stop and the remaining three mech reels M3c, M3d, and M3e keep spinning.

In α two simultaneous stops 8 (↑↑↑↑↑), after the five mech reels M3a to M3e spin reversely for a predetermined time, two mech reels M3a and M3b stop and the remaining three mech reels M3c, M3d, and M3e keep spinning.

In α two simultaneous stops 9 (↓↑↑↑↓), after two mech reels M3a and M3e spin forward and the remaining three mech reels M3b, M3c, and M3d spin reversely for a predetermined time, two mech reels M3a and M3e stop and the remaining three mech reels M3b, M3c, and M3d keep spinning.

In α two simultaneous stops 10 (↑↑↑↑↑), after the five mech reels M3a to M3e spin reversely for a predetermined time, two mech reels M3a and M3e stop and the remaining three mech reels M3b, M3c, and M3d keep spinning.

In α two simultaneous stops 11 (↑↓↑↓↑), after two mech reels M3b and M3d spin forward and the remaining three mech reels M3a, M3c, and M3e spin reversely for a predetermined time, two mech reels M3b and M3d stop and the remaining three mech reels M3a, M3c, and M3e keep spinning.

In α two simultaneous stops 12 (↑↑↑↑↑), after the five mech reels M3a to M3e spin reversely for a predetermined time, two mech reels M3b and M3d stop and the remaining three mech reels M3a, M3c, and M3e keep spinning.

The eight kinds of predictive effects β three simultaneous stops 1 to β three simultaneous stops 8 provide motion that three of the five mech reels M3a to M3e stop simultaneously.

Accordingly, the remaining two mech reels M3 keep spinning.

In β three simultaneous stops 1 (↓↓↓↓↓), after the five mech reels M3a to M3e spin forward for a predetermined time, three mech reels M3b, M3c, and M3d stop and the remaining two mech reels M3a and M3e keep spinning.

In β three simultaneous stops 2 (↓↓↑↓↓), after four mech reels M3a, M3b, M3d, and M3e spin forward and the remaining one mech reel M3c spins reversely for a predetermined time, three mech reels M3b, M3c, and M3d stop and the remaining two mech reels M3a and M3e keep spinning.

In β three simultaneous stops 3 (↓↑↓↑↓), after three mech reels M3a, M3c, and M3e spin forward and the remaining two mech reels M3b and M3d spin reversely for a predetermined time, three mech reels M3b, M3c, and M3d stop and the remaining two mech reels M3a and M3e keep spinning.

In β three simultaneous stops 4 (θ↑↑↑↓), after two mech reels M3a and M3e spin forward and the remaining three mech reels M3b, M3c, and M3d spin reversely for a predetermined time, three mech reels M3b, M3c, and M3d stop and the remaining two mech reels M3a and M3e keep spinning.

In β three simultaneous stops 5 (↑↓↓↓↑), after three mech reels M3b, M3c, and M3d spin forward and the remaining two mech reels M3a and M3e spin reversely for a predetermined time, three mech reels M3b, M3c, and M3d stop and the remaining two mech reels M3a and M3e keep spinning.

In β three simultaneous stops 6 (↑↓↑↓↑), after two mech reels M3b and M3d spin forward and the remaining three mech reels M3a, M3c, and M3e spin reversely for a predetermined time, three mech reels M3b, M3c, and M3d stop and the remaining two mech reels M3a and M3e keep spinning.

In β three simultaneous stops 7 (↑↑↓↑↑), after one mech reel M3c spins forward and the remaining four mech reels M3a, M3b, M3d, and M3e spin reversely for a predetermined time, three mech reels M3b, M3c, and M3d stop and the remaining two mech reels M3a and M3e keep spinning.

In β three simultaneous stops 8 (↑↑↑↑↑), after the five mech reels M3a to M3e spin reversely for a predetermined time, three mech reels M3b, M3c, and M3d stop and the remaining two mech reels M3a and M3e keep spinning.

The eight kinds of predictive effects γ four simultaneous stops 1 to γ four simultaneous stops 8 provide motion that four of the five mech reels M3a to M3e stop simultaneously. Accordingly, the remaining one mech reel M3 keeps spinning.

In γ four simultaneous stops 1 (↓↓↓↓↓) after the five mech reels M3a to M3e spin forward for a predetermined time, four mech reels M3a, M3b, M3d, and M3e stop and the remaining one mech reel M3c keeps spinning.

In γ four simultaneous stops 2 (↓↑↓↑↓), after three mech reels M3a, M3c, and M3e spin forward and the remaining two mech reels M3b and M3d spin reversely for a predetermined time, four mech reels M3a, M3b, M3d, and M3e stop and the remaining one mech reel M3c keeps spinning.

In γ four simultaneous stops 3 (↑↓↓↓↑), after three mech reels M3b, M3c, and M3d spin forward and the remaining two mech reels M3a and M3e spin reversely for a predetermined time, four mech reels M3a, M3b, M3d, and M3e stop and the remaining one mech reel M3c keeps spinning.

In γ four simultaneous stops 4 (↑↑↓↑↑), after one mech reel M3c spins forward and the remaining four mech reels M3a, M3b, M3d, and M3e spin reversely for a predetermined time, four mech reels M3a, M3b, M3d, and M3e stop and the remaining one mech reel M3c keeps spinning.

In γ four simultaneous stops 5 (↓↓↑↓↓), after four mech reels M3a, M3b, M3d, and M3e spin forward and the remaining one mech reel M3c spins reversely for a predetermined time, four mech reels M3a, M3b, M3d, and M3e stop and the remaining one mech reel M3c keeps spinning.

In γ four simultaneous stops 6 (↓↑↑↑↓), after two mech reels M3a and M3e spin forward and the remaining three mech reels M3b, M3c, and M3d spin reversely for a predetermined time, four mech reels M3a, M3b, M3d, and M3e stop and the remaining one mech reel M3c keeps spinning.

In γ four simultaneous stops 7 (↑↓↑↓↑), after two mech reels M3b and M3d spin forward and the remaining three mech reels M3a, M3c, and M3e spin reversely for a predetermined time, four mech reels M3a, M3b, M3d, and M3e stop and the remaining one mech reel M3c keeps spinning.

In γ four simultaneous stops 8 (↑↑↑↑↑), after the five mech reels M3a to M3e spin reversely for a predetermined time, four mech reels M3a, M3b, M3d, and M3e stop and the remaining one mech reel M3c keeps spinning.

### <Li-Zhi Effects>

Specific examples of the li-zhi effects (α, β, γ and δ) are described hereinafter. Selecting and performing the following kinds of li-zhi effects allow diverse reel motion variations based on the to-be stopped symbol matrix and predictive effects.

The α frame-by-frame forwarding 1 (in rotation from the leftmost li-zhi reel) is effects of a series of actions of stopping all the remaining three spinning reels temporarily, forwarding the first reel by one frame, forwarding the second reel by one frame, forwarding the third reel by one frame, repeating the forwarding in the same order among the remaining three reels, and rearranging the to-be stopped symbols to form a final symbol matrix.

The α frame-by-frame forwarding 2 (all li-zhi reels together) is effects of a series of actions of stopping all the remaining three spinning reels temporarily, forwarding these reels frame by frame together, and rearranging the to-be stopped symbols to form a final symbol matrix.

The α frame-by-frame forwarding 3 (repeated back and forth) is effects of a series of actions of stopping all the remaining three spinning reels temporarily, slightly moving the reels back and forth repeatedly, forwarding the reels frame by frame, and rearranging the to-be stopped symbols to form a final symbol matrix.

The α slow and fast together is effects of a series of actions as follows. First, the remaining three spinning reels are all stopped temporarily and then spun forward at high speed all together. During the spin, the spinning speed of these three reels is changed to low speed when BONUSes are coming in the symbol display area 141d, and is returned to the high speed when the BONUSes have gone from the symbol display area 141d. After a predetermined time, to-be stopped symbols are rearranged to form a final symbol matrix.

Such actions make the player expect that BONUSes will stop. Not only BONUSes but also symbols having a special feature, such as 7s, can be selected for the symbols to be shown on the slowly spinning reel.

The α high-speed simultaneous stop is effects of a series of actions of spinning all the remaining three spinning reels at high speed and rearranging the to-be stopped symbols by simultaneously stopping the reels to form a final symbol matrix.

The α high to super-high speed is effects of a series of actions of spinning all the remaining three spinning reels at high speed, further spinning the reels faster than the high speed, and rearranging the to-be stopped symbols by simultaneously stopping the reels to form a final symbol matrix.

The α low to super-low speed random stop is effects of a series of actions of spinning all the remaining three spinning reels at low speed, further spinning the reels slower than the low speed, and rearranging the to-be stopped symbols by randomly stopping the reels to form a final symbol matrix.

The α low-speed repeated back and forth is effects of a series of actions of spinning all the remaining three spinning reels back and forth repeatedly at low speed and rearranging the to-be stopped symbols to form a final symbol matrix.

The α low-speed spin together is effects of a series of actions of spinning all the remaining three spinning reels at low speed and rearranging the to-be stopped symbols to form a final symbol matrix.

The α high and low speed at random is effects of a series of actions of spinning one or more reels randomly selected from the remaining three spinning reels at high speed and spinning the remaining spinning reels at low speed and then rearranging the to-be stopped symbols to form a final symbol matrix.

The β frame-by-frame forwarding 4 (in alternate between left and right li-zhi reels) is effects of a series of actions of stopping the remaining two spinning reels temporarily, forwarding the first reel by one frame, forwarding the second reel by one frame, repeating the forwarding in the same order, and rearranging the to-be stopped symbols to form a final symbol matrix.

The β frame-by-frame forwarding 5 (all li-zhi reels together) is effects of a series of actions of stopping both the remaining two spinning reels temporarily, forwarding these reels frame by frame together, and rearranging the to-be stopped symbols to form a final symbol matrix.

The β frame-by-frame forwarding 6 (repeated back and forth) is effects of a series of actions of stopping both the remaining two spinning reels temporarily, slightly moving the reels back and forth repeatedly, forwarding the reels frame by frame, and rearranging the to-be stopped symbols to form a final symbol matrix.

The β slow and fast together is effects of a series of actions as follows. First, the remaining two spinning reels are both stopped temporarily and these two reels are spun forward at high speed together. During the spin, the spinning speed of these two reels is changed to low speed when BONUSes are coming in the symbol display area 141d, and is returned to the high speed when the BONUSes have gone from the symbol display area 141d. After a predetermined time, to-be stopped symbols are rearranged to form a final symbol matrix.

The β high-speed simultaneous stop is effects of a series of actions of spinning both the remaining two spinning reels at high speed and rearranging the to-be stopped symbols by simultaneously stopping the reels to form a final symbol matrix.

The β high to super-high speed is effects of a series of actions of spinning both of the remaining two spinning reels at high speed, further spinning the reels faster than the high speed, and rearranging the to-be stopped symbols by simultaneously stopping the reels to form a final symbol matrix.

The β low to super-low speed random stop is effects of a series of actions of spinning both of the remaining two spinning reels at low speed, further spinning the reels slower than the low speed, and rearranging the to-be stopped symbols by randomly stopping the reels to form a final symbol matrix.

The β low-speed repeated back and forth is effects of a series of actions of spinning both the remaining two spinning reels back and forth repeatedly at low speed and rearranging the to-be stopped symbols to form a final symbol matrix.

The β low-speed spin together is effects of a series of actions of spinning both the remaining two spinning reels at low speed and rearranging the to-be stopped symbols to form a final symbol matrix.

The β high and low speed at random is effects of a series of actions of spinning one reel randomly selected from the remaining two spinning at high speed and spinning the other spinning reel at low speed and then rearranging the to-be stopped symbols to form a final symbol matrix.

The γ frame-by-frame forwarding 7 (one by one) is effects of a series of actions of stopping the remaining one spinning reel temporarily, forwarding the reel frame by frame, and rearranging the to-be stopped symbol to form a final symbol matrix.

The γ frame-by-frame forwarding 8 (repeated back and forth) is effects of a series of actions of stopping the remaining one spinning reel temporarily, slightly moving the reel back and forth repeatedly, forwarding the reel frame by frame, and rearranging the to-be stopped symbol to form a final symbol matrix.

The γ slow and fast is effects of a series of actions as follows. First, the remaining one spinning reel is stopped temporarily and the reel is spun forward at high speed. During the spin, the spinning speed of the reel is changed to low speed when the BONUS is coming in the symbol display area 141d, and is returned to the high speed when the BONUS has gone from the symbol display area 141d. After a predetermined time, the to-be stopped symbol is rearranged to form a final symbol matrix.

The γ high to super-high speed is effects of a series of actions of spinning the remaining one spinning reel at high speed, further spinning the reel faster than the high speed, and rearranging the to-be stopped symbol to form a final symbol matrix.

The γ low to super-low speed is effects of a series of actions of spinning the remaining one spinning reel at low speed, further spinning the reel slower than the low speed, and rearranging the to-be stopped symbol to form a final symbol matrix.

The γ low-speed repeated back and forth is effects of a series of actions of spinning the remaining one spinning reel back and forth repeatedly at low speed and rearranging the to-be stopped symbol to form a final symbol matrix.

The γ high to super-high speed into super-low, low, middle, high to super high speed is effects of a series of actions of spinning the remaining one spinning reel at high speed, further spinning the reel faster than the high speed, thereafter spinning the reel while changing the spinning speed to super-low speed, low speed, middle speed, high speed, and then super-high speed, and rearranging the to-be stopped symbol to form a final symbol matrix.

The γ high and low speed at random is effects of a series of actions of spinning the remaining spinning reel at randomly selected high speed or low speed and then rearranging the to-be stopped symbols to form a final symbol matrix.

The δ high-speed spin together is effects of a series of actions of spinning all the remaining spinning reels at high speed and rearranging the to-be stopped symbols to form a final symbol matrix.

The δ super-low speed random stop is effects of a series of actions of randomly selecting one or more reels to be spun at super-low speed, spinning the selected reels at super-low speed, and rearranging the to-be stopped symbols to form a final symbol matrix.

The δ low-speed spin together is effects of a series of actions of spinning all the remaining spinning reels at low speed and rearranging the to-be stopped symbols to form a final symbol matrix.

The δ high-speed simultaneous stop is effects of a series of actions of spinning all the remaining spinning reels at high speed and rearranging the to-be stopped symbols by simultaneously stopping the reels to form a final symbol matrix.

The δ frame-by-frame forwarding 9 (current frame-by-frame forwarding) is effects of a series of actions of forwarding all the remaining spinning reels frame by frame and rearranging the to-be stopped symbols to form a final symbol matrix.

The δ slow and fast is effects of a series of actions as follows. First, all the remaining spinning reels are stopped temporarily and are spun forward at high speed all together. During the spin, the spinning speed of all the reels is changed to low speed when BONUSes are coming in the symbol display area 141d, and is returned to the high speed when the BONUSes have gone from the symbol display area 141d. After a predetermined time, to-be stopped symbols are rearranged to form a final symbol matrix.

The δ high to super-high speed is effects of a series of actions of spinning all the remaining spinning reels at high speed, further spinning the reels faster than the high speed, and rearranging the to-be stopped symbols by simultaneously stopping the reels to form a final symbol matrix.

The δ low to super-low speed stop is effects of a series of actions of spinning all the remaining spinning reels at low speed, further spinning the reels slower than the low speed, and rearranging the to-be stopped symbols by simultaneously stopping the reels to form a final symbol matrix.

The δ high and low speed at random is effects of a series of actions of spinning one or more reels randomly selected from the remaining spinning reels at high speed and spinning the remaining spinning reels at low speed and then rearranging the to-be stopped symbols to form a final symbol matrix.

### Other Embodiments

The foregoing embodiment has provided a method that performs color table determination processing first to determine one color table out of a plurality of color tables and subsequently performs symbol lottery processing to determine to-be stopped symbols. Determining a color table first enables presentation effects of emitting light using the determined color table so that the player can predict the determined color table.

The order of processing may be reversed by performing the symbol lottery processing first to determine to-be stopped symbols and subsequently performing the color table determination processing to determine one color table out of a plurality of color tables.

What is claimed is:

1. A gaming machine controlled to determine a color for a symbol or a color for a background of the symbol at random from two or more colors and to determine an amount of payout differently depending on the determined color, the gaming machine comprising:
a symbol display device for rearranging a plurality of symbols;
a memory holding a plurality of color determination tables among which probabilities of determining the two or more colors for the symbol or the background of the symbol are different; and
a controller for determining a color for the symbol or a color for the background of the symbol at random using one of the plurality of color determination tables held in the memory.

2. The gaming machine according to claim 1, wherein the plurality of color determination tables held in the memory include a color determination table in which the probabilities of determining the two or more colors are specified to select a specific color and a color determination table in which the probabilities of determining the two or more colors are specified to select any of the two or more colors.

3. The gaming machine according to claim 2,
wherein the memory further holds a table for determining a color determination table, which is for determining one of the plurality of color determination tables at random,
wherein the table for determining a color determination table specifies a probability of drawing the color determination table specified to select any of the two or more colors as higher than a probability of drawing the color determination table specified to select the specific color, and
wherein the controller determines a color determination table to be used at random based on the table for determining a color determination table.

4. The gaming machine according to claim 2,
wherein the plurality of color determination tables include the color determination table specified to select the specific color, at least one color determination table specified to select a color different from the specific color, and color determination tables specified to select any of the two or more colors,
wherein, among the color determination table specified to select the specific color, the at least one color determination table specified to select a color different from the specific color, and the color determination tables specified to select any of the two or more colors, the color determination tables specified to select any of the two or more colors are more than the other tables, and
wherein, among the color determination tables specified to select any of the two or more colors, probabilities of selecting different colors are specified to be different.

5. A gaming machine comprising:
a symbol display device for displaying a game result by rearranging a plurality of symbols;
a memory holding a color determination table for determining colors for symbols or colors for backgrounds of the symbols and a winning pattern identification table for identifying a winning pattern based on the colors of the symbols or the colors of the background of the symbols; and
a controller programmed to perform the following processing of (5-1) to (5-3):
(5-1) determining colors for a specific kind of symbols of the plurality of symbols or colors for backgrounds of the specific kind of symbols by lottery processing with reference to the color determination table held in the memory;
(5-2) individually setting the colors determined in the processing of (5-1) to the specific kind of symbols or the backgrounds of the specific kind of symbols; and
(5-3) identifying a winning pattern with reference to the winning pattern identification table based on the specific kind of symbols to which or to the background of which the colors are set individually in the processing of (5-2).

6. The gaming machine according to claim 5, wherein the controller is programmed to perform the processing of (5-1) before performing the lottery processing to rearrange the plurality of symbols.

7. A gaming machine comprising:
a symbol display device including a display area in which a game result is displayed, the game result being obtained by rearranging a plurality of symbols disposed on a plurality of reels driven by motors;
a light device for illuminating symbols or backgrounds of the symbols with light in specified colors;
a memory holding a color determination table for determining colors for the light to illuminate the symbols or the backgrounds of the symbols and a winning pattern identification table for identifying a winning pattern based on the colors of the light to illuminate the symbols or the backgrounds of the symbols; and
a controller programmed to perform the following processing of (7-1) to (7-3):
(7-1) determining colors for light to illuminate a specific kind of symbols of the plurality of symbols or backgrounds of the specific kind of symbols by lottery processing with reference to the color determination table held in the memory;
(7-2) setting the colors determined in the processing of (7-1) to individually illuminate the specific kind of symbols or the backgrounds of the specific kind of symbols; and
(7-3) identifying a winning pattern with reference to the winning pattern identification table based on the specific kind of symbols which are individually illuminated or the backgrounds of which are individually illuminated with light in the colors set in the processing of (7-2).

8. The gaming machine according to claim 7,
wherein the memory holds a plurality of color determination tables for determining colors to be specified from a plurality of colors and a table for determining a color determination table from the plurality of color determination tables,
wherein each of the plurality of color determination tables specifies probabilities of drawing the plurality of colors,
wherein the table for determining a color determination table specifies probabilities of drawing the plurality of color determination tables,
wherein the processing of (7-1) includes the following processing of (8-1) and (8-2):
(8-1) determining a color determination table from the plurality of color determination tables by lottery processing with reference to the table for determining a color determination table when the specific kind of symbols appear in the display area; and
(8-2) determining colors to be specified from the plurality of colors by lottery processing with reference to the color determination table determined by the processing of (8-1).

9. A gaming machine comprising:
a symbol display device having a display area in which a game result is displayed, the game result being obtained by rearranging a plurality of symbols disposed on a plurality of reels driven by motors;
a backlight for illuminating symbols from behind the symbols;
a front light for illuminating the plurality of reels from front of the reels;
a memory holding a plurality of illumination color determination tables for determining illumination colors for the symbols and a table for determining an illumination color determination table from the plurality of illumination color determination tables; and
a controller programmed to perform the following processing of (9-1) and (9-2):
(9-1) determining an illumination color determination table from the plurality of illumination color determination tables by lottery processing with reference to the table for determining an illumination color determination table in a case where a predetermined number or more of a specific kind of symbols are to appear in the display area; and
(9-2) controlling the front light to emit light in a pure color upon start of spinning of the plurality of reels in a case where the illumination color determination table determined in the processing of (9-1) specifies the pure color.

10. The gaming machine according to claim 9, wherein the controller is programmed to further perform the following processing of (10-1):
(10-1) controlling the backlight to illuminate the specific kind of symbols by emitting light in the pure color synchronously with spinning motion of the specific kind of symbols caused by spinning of the plurality of reels.
